(19) United States
(12) Patent Application Publication
(10) Pub. No.: US 2016/0223413 A1
(43) Pub. Date: Aug. 4, 2016

(54) STRESS SENSOR AND FABRICATION METHOD FOR THE SAME

(71) Applicant: ROHM CO., LTD., Kyoto-shi (JP)

(72) Inventors: Masashi KUBOTA, Kyoto-shi (JP); Masashi KAWASAKI, Wako-shi (JP); Yoshinori TOKURA, Wako-shi (JP)

(21) Appl. No.: 14/984,696

(22) Filed: Dec. 30, 2015

Related U.S. Application Data
(63) Continuation of application No. PCT/JP2014/067984, filed on Jul. 4, 2014.

(30) Foreign Application Priority Data
Jul. 4, 2013 (JP) 2013-140307

(51) Int. Cl. G01L 1/12

(52) U.S. Cl. CPC G01L 1/122

(57) ABSTRACT

The stress sensor includes: a magnetic material; a stress applied portion on the magnetic material; a magnet disposed so as to be adjacent to by a magnetic material; a magnetic sensor disposed via the magnetic material so as to be opposed to the stress applied portion, wherein the magnetic sensor detects a magnetic flux emitted from a magnetic domain generated in the magnetic material by a local stress applied to the stress applied portion. The local stress or stress distribution can be detected with a convenience structure, and can obtain a high spatial resolution by using a stress response phenomenon of a single magnetic domain.

### CROSS REFERENCE TO RELATED APPLICATIONS

This is a continuation application (CA) of PCT Application No. PCT/JP2014/067984, filed on Jul. 4, 2014, which claims priority to Japan Patent Application No. P2013-140307 filed on Jul. 4, 2013 and is based upon and claims the benefit of priority from prior Japanese Patent Applications P2013-140307 filed on Jul. 4, 2013 and PCT Application No. PCT/JP2014/067984, filed on Jul. 4, 2014, the entire contents of each of which are incorporated herein by reference.

### FIELD

The embodiment described herein relates to a stress sensor and a fabrication method for the stress sensor.

### BACKGROUND

There have been developed sensors provided with various functions as detection devices having excellent performance which is alternative to or exceeds human's five senses. Such sensors detect natural phenomena, e.g. motion, optics, and temperatures, a mechanical, electromagnetical, thermal, and acoustical characteristics of artifacts, or space information or time information indicated by such characteristics, in order to control equipment. Thereby, more precise and accurate motions, and simpler and more easy-to-use operation methods can also be realized, and therefore higher effects to reduce power requirements can also be produced. Novel efforts using such sensors in various fields, e.g. factories, medical care/health care, transport facilities, construction industries, agricultural facilities, and environmental management, etc. have already been started.

It is expected that a variety of detection objects will be increased so as to support to various scenes, in addition to achievement of further improved performance for already-existing sensors, as a requirement in the sensors, in the future.

For example, there are listed variously-used sensors, e.g., acceleration sensors gyroscope sensors, touch sensors, Hall sensors, tilt sensors, grip sensors, pulse wave sensors, etc., and are also listed variously-used sensors, e.g., image sensors, pressure sensors, illuminance sensors, proximity sensors, pyroelectric sensors, humidity sensors, UV sensors, Infrared Data Association (IrDA), X ray sensors, odor sensors, etc., as examples of sensors for the purpose of detecting environments.

As conventional technologies associated with detection of mechanical forces, stress sensors, strain sensors, pressure sensors, etc. are listed, and are classified as follows: Thus, piezoresistive effect elements using metallic detect strain by converting an increase and decrease in an electric resistance due to metallic expansion and contraction into voltage. Since the piezoresistive effect element formed using metal uses the expansion and contraction phenomenon, a spatial resolution thereof is lower and an operational temperature range thereof is smaller. On the other hand, a detection principle of piezoresistive effect elements using a semiconductor is the same as that of the metaled piezoresistive effect elements. In the piezoresistive effect elements using the semiconductor, a silicon is processed into diaphragm structure, and thereby can sensitively detect a strain due to a pressure of a portion of which the layer thickness is thinner. Similarly, since the piezoresistive effect element using the semiconductor uses the expansion and contraction phenomenon, a spatial resolution thereof is lower and an operational temperature range thereof is smaller. Moreover, the piezoresistive effect elements using the semiconductor is mechanically weak. Since piezoelectric effect elements using dielectrics uses a piezoelectric effect, such piezoelectric effect elements using dielectrics can detect a dynamic stress (acceleration, vibration, etc.), but are not suitable for detection of static stress.

On the other hand, magnetostrictive stress sensors using an inverse magnetostrictive effect has a principle of detecting strain from a relationship between magnetization and stress characteristics as the whole ferromagnetic material, and uses a phenomenon in which the magnetization changes due to strain applied to the ferromagnetic material. However, a spatial resolution of the magnetostrictive stress sensor using the inverse magnetostrictive effect is lower.

It is difficult to detect a local stress using a high spatial resolution in each above-mentioned method.

For example, garnet has been known as insulator materials showing ferromagnetic materials at a room temperature. If garnet is fabricated by using a liquid phase epitaxy, growth-induced magnetic anisotropy which is a phenomenon peculiar to the fabricating method appears. It has been known that the magnetic anisotropy will occur since ordering of a rare earth element spontaneously occurs during crystal growth by the growth-induced magnetic anisotropy, and thereby a vertical magnetization film can be obtained. Moreover, it has been known that such a growth-induced magnetic anisotropy can be reduced by an anneal process.

### SUMMARY

In the embodiment, a magnetic material is used as a host material of the stress sensor.

The embodiment provides: a stress sensor which can detect a local stress or stress distribution with a convenience structure, and can obtain a high spatial resolution by using a stress response phenomenon of a single magnetic domain; and a fabrication method for such a stress sensor.

According to one aspect of the embodiment, there is provided a stress sensor comprising: a magnetic material; a stress applied portion on the magnetic material; a magnet disposed so as to be adjacent to the magnetic material; and a magnetic sensor disposed via the magnetic material so as to be opposed to the stress applied portion, wherein the magnetic sensor detects a magnetic flux emitted from a magnetic domain generated in the magnetic material by a local stress applied to the stress applied portion.

According to another aspect of the embodiment, there is provided a stress sensor comprising: a magnetic material; a stress applied portion of the magnetic material; a magnet disposed so as to be adjacent to the magnetic material; and a magnetic sensor disposed via the magnetic material so as to be opposed to the stress applied portion, wherein a magnetic flux emitted from a magnetic domain is detected by the magnetic sensor, and thereby displacement of a magnetic domain due to stress distribution is detected.

According to another aspect of the embodiment, there is provided a fabrication method for a stress sensor comprising: preparing a magnetic material; disposing a magnet so as to be adjacent to the magnetic material; and disposing a magnetic sensor via the magnetic material so as to be opposed to the stress applied portion on the magnetic material, wherein the magnetic sensor is a magnetic sensor configured to detect a magnetic flux emitted from a magnetic domain generated in the magnetic material due to a local stress applied to the stress applied portion, wherein a step of fabricating the magnetic sensor comprises: forming an insulating layer on the magnetic material; pattern-forming a bismuth electrode layer on the insulating layer; pattern-forming a pad electrode on the bismuth electrode layer; forming a passivation film on the pad electrode; forming an aperture to the pad electrode in the passivation film; and connecting a bonding wire to the aperture.

According to another aspect of the embodiment, there is provided a fabrication method for a stress sensor comprising: preparing a magnetic material; disposing a magnet so as to be adjacent to the magnetic material; and disposing a magnetic sensor via the magnetic material so as to be opposed to the stress applied portion on the magnetic material, wherein the magnetic sensor is a magnetic sensor configured to detect displacement of a magnetic domain due to stress distribution by detecting a magnetic flux emitted from the magnetic domain, wherein a step of fabricating the magnetic sensor comprises: forming an insulating layer on the magnetic material;

pattern-forming a bismuth electrode layer on the insulating layer; pattern-forming a pad electrode on the bismuth electrode layer; forming a passivation film on the pad electrode; forming an aperture to the pad electrode in the passivation film; and connecting a bonding wire to the aperture.

According to the embodiment, there can be provided a stress sensor which can detect a local stress or stress distribution with a convenience structure, and can obtain a high spatial resolution by using a stress response phenomenon of a single magnetic domain; and a fabrication method for such a stress sensor.

### BRIEF DESCRIPTION OF DRAWINGS

FIG. 1A is a schematic cross-sectional structure diagram of a magnetic material having magnetization M to which an external magnetic field Hex higher than a saturation magnetic field Hs is applied, in an operational principle of a stress sensor according to an embodiment.

FIG. 1B is a schematic cross-sectional structure diagram of the magnetic material in which a stress-induced anisotropic magnetic field H_{A} is generated, and a magnetic bubble is generated by applying a local stress to the magnetic material with a tungsten needle, in the operational principle of the stress sensor according to the embodiment.

FIG. 1C is a schematic cross-sectional structure diagram of the magnetic material in a (volatility) state where a magnetizing direction due to the stress-induced anisotropic magnetic field H_{A} is not stored after the tungsten needle is released, in the operational principle of the stress sensor according to the embodiment.

FIG. 1D is a schematic diagram of a surface state of the magnetic material corresponding to FIG. 1A, in the operational principle of the stress sensor according to the embodiment.

FIG. 1E is a schematic diagram of a surface state of the magnetic material corresponding to FIG. 1B, in the operational principle of the stress sensor according to the embodiment.

FIG. 1F is a schematic diagram of a surface state of the magnetic material corresponding to FIG. 10, in the operational principle of the stress sensor according to the embodiment.

FIG. 2A is a schematic cross-sectional structure diagram of the magnetic material having magnetization M to which the external magnetic field Hex of the same degree as the saturation magnetic field Hs is applied, in the operational principle of the stress sensor according to the embodiment.

FIG. 2B is a schematic cross-sectional structure diagram of the magnetic material in which the stress-induced anisotropic magnetic field H_{A} is generated, and the magnetic bubble is generated by applying the local stress to the magnetic material with the tungsten needle, in the operational principle of the stress sensor according to the embodiment.

FIG. 2C is a schematic cross-sectional structure diagram of the magnetic material in a (nonvolatile) state where the magnetizing direction which is reversed due to the stress-induced anisotropic magnetic field H_{A} is stored after the tungsten needle is released, in the operational principle of the stress sensor according to the embodiment.

FIG. 2D is a schematic diagram of a surface state of the magnetic material corresponding to FIG. 2A, in the operational principle of the stress sensor according to the embodiment.

FIG. 2E is a schematic diagram of a surface state of the magnetic material corresponding to FIG. 2B, in the operational principle of the stress sensor according to the embodiment.

FIG. 2F is a schematic diagram of a surface state of the magnetic material corresponding to FIG. 2C, in the operational principle of the stress sensor according to the embodiment.

FIG. 3A is a surface view observed from a magnetooptical microscope image of the magnetic material in which the magnetization M is generated by applying the external magnetic field Hex which is equal to the saturation magnetic field Hs thereto (before the tungsten needle is contacted), in an experimental example of the stress sensor according to the embodiment.

FIG. 3B is a surface view observed from the magnetooptical microscope image of the magnetic material in which the stress-induced anisotropic magnetic field H_{A} is generated, and the magnetic bubble is generated by applying the local stress to the magnetic material with the tungsten needle, in the experimental example of the stress sensor according to the embodiment.

FIG. 3C is a surface view observed from the magnetooptical microscope image of the magnetic material in a (nonvolatile) state where the magnetizing direction which is reversed due to the stress-induced anisotropic magnetic field H_{A} is stored after the tungsten needle is released, in the experimental example of the stress sensor according to the embodiment.

FIG. 4A is a schematic cross-sectional structure diagram of the magnetic material having the magnetization M on which the external magnetic field Hex is applied, in an explanatory diagram of the local stress detected by the stress sensor according to the embodiment.

FIG. 4B is a schematic cross-sectional structure diagram of a configuration of the magnetic material in which the stress-induced anisotropic magnetic field H_{A} is generated by applying the local stress to the magnetic material with the tungsten needle in a state of applying the external magnetic field Hex thereto, and a magnetic sensor disposed at a back surface side of the magnetic material opposite to the surface contacted by the tungsten needle, in the explanatory diagram of the local stress detected by the stress sensor according to the embodiment.

FIG. 4C is a schematic cross-sectional structure diagram of the stress sensor on which a magnetic substance thin film and a protective film are formed at a front surface side of the magnetic material, and a magnetic sensor is disposed at a back surface side of the magnetic material, in the explanatory diagram of the local stress detected by the stress sensor according to the embodiment.

FIG. 5A is a surface view (before the tungsten needle is contacted) observed from a magnetooptical microscope image of the magnetic material in which the magnetic bubble is generated by applying a magnetic field for generating magnetic bubble as the external magnetic field Hex thereto, in the experimental example of the stress sensor according to the embodiment.

FIG. 5B is a surface view observed from the magnetooptical microscope image of the magnetic material in a state where the local stress is applied to the magnetic material with the tungsten needle (1.15 mN), in the experimental example of the stress sensor according to the embodiment.

FIG. 5C is a difference image between FIG. 5A and FIG. 5B, in the experimental example of the stress sensor according to the embodiment.

FIG. 6 is a schematic cross-sectional structure diagram showing the stress sensor according to the embodiment.

FIG. 7 is a schematic cross-sectional structure diagram showing a stress sensor according to a modified example 1 of the embodiment.

FIG. 8 is a schematic cross-sectional structure diagram showing a stress sensor according to a modified example 2 of the embodiment.

FIG. 9 is a schematic cross-sectional structure diagram showing a stress sensor according to a modified example 3 of the embodiment.

FIG. 10 is a schematic cross-sectional structure diagram showing a stress sensor according to a modified example 4 of the embodiment.

FIG. 11 is a schematic cross-sectional structure diagram showing a stress sensor according to a modified example 5 of the embodiment.

FIG. 12 is a schematic cross-sectional structure diagram showing a stress sensor according to a modified example 6 of the embodiment.

FIG. 13A is a schematic planar pattern configuration diagram showing a stress sensor according to a modified example 7 of the embodiment.

FIG. 13B is a schematic cross-sectional structure diagram taken in the line I-I of FIG. 13A.

FIG. 14A is a schematic planar pattern configuration diagram showing a stress distribution detecting apparatus to which the stress sensor according to the embodiment is applied.

FIG. 14B is a schematic cross-sectional structure diagram taken in the line II-II of FIG. 14A.

FIG. 15A shows a relationship (magnetizing curve) the external magnetic field Hex of the magnetic material applied to the stress sensor according to the embodiment, and the magnetization M [an example before an anneal process].

FIG. 15B shows a relationship (magnetizing curve) the external magnetic field Hex of the magnetic material applied to the stress sensor according to the embodiment, and the magnetization M [an example of being annealed at 1150 degrees C.].

FIG. 15C shows a relationship (magnetizing curve) the external magnetic field Hex of the magnetic material applied to the stress sensor according to the embodiment, and the magnetization M [an example of being annealed at 1200 degrees C.].

FIG. 16 shows annealing temperature dependency between the saturation magnetic field Hs and a saturation magnetic field ratio (the quotient of the saturation magnetic field Hₛ, ⊥ in an out-of-plane direction divided by the saturation magnetic field Hₛ, ∥ in an in-plane direction), in the magnetic material applied to the stress sensor according to the embodiment.

FIG. 17A is a diagram showing the magnetic field dependency observed from a magnetooptical microscope image to be corresponded with the magnetizing curve (relationship between the external magnetic field Hex and the magnetization M), in the magnetic material applied to the stress sensor according to the embodiment [an example before an anneal process].

FIG. 17B is a diagram showing the magnetic field dependency observed from a magnetooptical microscope image to be corresponded with the magnetizing curve (relationship between the external magnetic field Hex and the magnetization M), in the magnetic material applied to the stress sensor according to the embodiment [an example of being annealed at 1200 degrees C.].

FIG. 18 is a schematic configuration diagram showing a magnetooptical microscope measuring system made by combining a local stress control system, in an instrumentation system of the magnetic material applied to the stress sensor according to the embodiment.

FIG. 19A is a schematic cross-sectional structure diagram (the magnetooptical microscope image corresponds to FIG. 3A) at the time when an annealing sample at an annealing temperature of 1200 degrees C. is applied to the saturation magnetic field (Hex=Hₛ=560 (Oe)), in the magnetic material applied to the stress sensor according to the embodiment.

FIG. 19B is a schematic cross-sectional structure diagram (the magnetooptical microscope image corresponds to FIG. 3B) showing the magnetic material in which the stress-induced anisotropic magnetic field H_{A} is generated by applying the local stress to the magnetic material with the tungsten needle, in the magnetic material applied to the stress sensor according to the embodiment.

FIG. 19C is a schematic cross-sectional structure diagram (the magnetooptical microscope image corresponds to FIG. 3C) showing the magnetic material in a (nonvolatile) state where the magnetizing direction which is reversed due to the stress-induced anisotropic magnetic field H_{A} is stored after releasing the tungsten needle, in the magnetic material applied to the stress sensor according to the embodiment.

FIG. 20A is a surface view observed from a magnetooptical microscope image of the magnetic material in a state where the external magnetic field Hex is not applied thereto (Hex=0 (Oe)) (before the tungsten needle is contacted), in an experimental example of the stress sensor according to the embodiment.

FIG. 20B is a surface view observed from the magnetooptical microscope image of the magnetic material in a state where the local stress is applied to the magnetic material with the tungsten needle (7.79 mN), in the experimental example of the stress sensor according to the embodiment.

FIG. 20C shows a difference image between FIG. 20A and FIG. 20B.

FIG. 21A is a surface view observed from a magnetooptical microscope image of the magnetic material in which a magnetic bubble domain is generated by applying a magnetic field for generating magnetic bubble domain (Hex=280 (Oe)) as the external magnetic field Hex thereto (before the tungsten needle is contacted), in the experimental example of the stress sensor according to the embodiment.

FIG. 21B is a surface view observed from the magnetooptical microscope image of the magnetic material in a state where the local stress is applied to the magnetic material with the tungsten needle (1.15 mN), in the experimental example of the stress sensor according to the embodiment.

FIG. 21C shows a difference image between FIG. 21A and FIG. 21B.

FIG. 22A is a diagram showing the magnetic field dependency observed from a magnetooptical microscope image to be corresponded with the magnetizing curve (relationship between the external magnetic field Hex and the magnetization M), in the magnetic material applied to the stress sensor according to the embodiment [an example of being annealed at 1200 degrees C.] (corresponding to FIG. 17B).

FIG. 22B is a diagram showing a relationship between the external magnetic field Hex and threshold force f, in a result of examining a relationship between a magnetic domain motion and a threshold load, while changing magnetic domain structure by applying an external magnetic field Hex in perpendicular-to-plane direction thereto, in the magnetic material applied to the stress sensor according to the embodiment.

FIG. 23A is a surface view observed from the magnetooptical microscope image of the magnetic material in the case of the external magnetic field Hex=0 (Oe), before the tungsten needle is contacted thereto, in the magnetic material applied to the stress sensor according to the embodiment.

FIG. 23B is a surface view observed from the magnetooptical microscope image of the magnetic material in the case of the external magnetic field Hex=0 (Oe), when applying the threshold force f=0.00 mN, in the magnetic material applied to the stress sensor according to the embodiment.

FIG. 23C is a surface view observed from the magnetooptical microscope image of the magnetic material in the case of the external magnetic field Hex=0 (Oe), when applying the threshold force f=3.14 mN, in the magnetic material applied to the stress sensor according to the embodiment.

FIG. 23D is surface view observed from the magnetooptical microscope image of the magnetic material in the case of the external magnetic field Hex=0 (Oe), when applying the threshold force f=6.70 mN, in the magnetic material applied to the stress sensor according to the embodiment.

FIG. 23E is a surface view observed from the magnetooptical microscope image of the magnetic material in the case of the external magnetic field Hex=0 (Oe), when applying the threshold force f=7.79 mN, in the magnetic material applied to the stress sensor according to the embodiment.

FIG. 23F is a surface view observed from the magnetooptical microscope image of the magnetic material in the case of the external magnetic field Hex=0 (Oe), when applying the threshold force f=6.30 mN, in the magnetic material applied to the stress sensor according to the embodiment.

FIG. 23G is a surface view observed from the magnetooptical microscope image of the magnetic material in the case of the external magnetic field Hex=0 (Oe), when applying the threshold force f=2.86 mN, in the magnetic material applied to the stress sensor according to the embodiment.

FIG. 23H is a surface view observed from the magnetooptical microscope image of the magnetic material in the case of the external magnetic field Hex=0 (Oe), when applying the threshold force f=0.00 mN, in the magnetic material applied to the stress sensor according to the embodiment.

FIG. 23I is a diagram showing a surface view after releasing the tungsten needle.

FIG. 24A is a surface view observed from the magnetooptical microscope image of the magnetic material in the case of the external magnetic field Hex=70 (Oe), before the tungsten needle is contacted thereto, in the magnetic material applied to the stress sensor according to the embodiment.

FIG. 24B is a surface view observed from the magnetooptical microscope image of the magnetic material in the case of the external magnetic field Hex=70 (Oe), when applying the threshold force f=0.00 mN, in the magnetic material applied to the stress sensor according to the embodiment.

FIG. 24C is a surface view observed from the magnetooptical microscope image of the magnetic material in the case of the external magnetic field Hex=70 (Oe), when applying the threshold force f=2.92 mN, in the magnetic material applied to the stress sensor according to the embodiment.

FIG. 24D is a surface view observed from the magnetooptical microscope image of the magnetic material in the case of the external magnetic field Hex=70 (Oe), when applying the threshold force f=4.32 mN, in the magnetic material applied to the stress sensor according to the embodiment.

FIG. 24E is a surface view observed from the magnetooptical microscope image of the magnetic material in the case of the external magnetic field Hex=70 (Oe), when applying the threshold force f=5.60 mN, in the magnetic material applied to the stress sensor according to the embodiment.

FIG. 24F is a surface view observed from the magnetooptical microscope image of the magnetic material in the case of the external magnetic field Hex=70 (Oe), when applying the threshold force f=4.36 mN, in the magnetic material applied to the stress sensor according to the embodiment.

FIG. 24G is a surface view observed from the magnetooptical microscope image of the magnetic material in the case of the external magnetic field Hex=70 (Oe), when applying the threshold force f=2.94 mN, in the magnetic material applied to the stress sensor according to the embodiment.

FIG. 24H is a surface view observed from the magnetooptical microscope image of the magnetic material in the case of the external magnetic field Hex=70 (Oe), when applying the threshold force f=0.00 mN, in the magnetic material applied to the stress sensor according to the embodiment.

FIG. 24I is a surface view observed from the magnetooptical microscope image of the magnetic material in the case of the external magnetic field Hex=70 (Oe), after the tungsten needle is released therefrom, in the magnetic material applied to the stress sensor according to the embodiment.

FIG. 25A is a surface view observed from the magnetooptical microscope image of the magnetic material in the case of the external magnetic field Hex=130 (Oe), before the tungsten needle is contacted thereto, in the magnetic material applied to the stress sensor according to the embodiment.

FIG. 25B is a surface view observed from the magnetooptical microscope image of the magnetic material in the case of the external magnetic field Hex=130 (Oe), when applying the threshold force f=0.00 mN, in the magnetic material applied to the stress sensor according to the embodiment.

FIG. 25C is a surface view observed from the magnetooptical microscope image of the magnetic material in the case of the external magnetic field Hex=130 (Oe), when applying the threshold force f=1.36 mN, in the magnetic material applied to the stress sensor according to the embodiment.

FIG. 25D is a surface view observed from the magnetooptical microscope image of the magnetic material in the case of the external magnetic field Hex=130 (Oe), when applying the threshold force f=3.12 mN, in the magnetic material applied to the stress sensor according to the embodiment.

FIG. 25E is a surface view observed from the magnetooptical microscope image of the magnetic material in the case of the external magnetic field Hex=130 (Oe), when applying the threshold force f=4.28 mN, in the magnetic material applied to the stress sensor according to the embodiment.

FIG. 25F is a surface view observed from the magnetooptical microscope image of the magnetic material in the case of the external magnetic field Hex=130 (Oe), when applying the threshold force f=2.83 mN, in the magnetic material applied to the stress sensor according to the embodiment.

FIG. 25G is a surface view observed from the magnetooptical microscope image of the magnetic material in the case of the external magnetic field Hex=130 (Oe), when applying the threshold force f=1.41 mN, in the magnetic material applied to the stress sensor according to the embodiment.

FIG. 25H is a surface view observed from the magnetooptical microscope image of the magnetic material in the case of the external magnetic field Hex=130 (Oe), when applying the threshold force f=0.00 mN, in the magnetic material applied to the stress sensor according to the embodiment.

FIG. 25I is a surface view observed from the magnetooptical microscope image of the magnetic material in the case of the external magnetic field Hex=130 (Oe), after the tungsten needle is released therefrom, in the magnetic material applied to the stress sensor according to the embodiment.

FIG. 26A is a surface view observed from the magnetooptical microscope image of the magnetic material in the case of the external magnetic field Hex=200 (Oe), before the tungsten needle is contacted thereto, in the magnetic material applied to the stress sensor according to the embodiment.

FIG. 26B is a surface view observed from the magnetooptical microscope image of the magnetic material in the case of the external magnetic field Hex=200 (Oe), when applying the threshold force f=0.00 mN, in the magnetic material applied to the stress sensor according to the embodiment.

FIG. 26C is a surface view observed from the magnetooptical microscope image of the magnetic material in the case of the external magnetic field Hex=200 (Oe), when applying the threshold force f=2.19 mN, in the magnetic material applied to the stress sensor according to the embodiment.

FIG. 26D is a surface view observed from the magnetooptical microscope image of the magnetic material in the case of the external magnetic field Hex=200 (Oe), when applying the threshold force f=2.59 mN, in the magnetic material applied to the stress sensor according to the embodiment.

FIG. 26E is a surface view observed from the magnetooptical microscope image of the magnetic material in the case of the external magnetic field Hex=200 (Oe), when applying the threshold force f=3.43 mN, in the magnetic material applied to the stress sensor according to the embodiment.

FIG. 26F is a surface view observed from the magnetooptical microscope image of the magnetic material in the case of the external magnetic field Hex=200 (Oe), when applying the threshold force f=2.57 mN, in the magnetic material applied to the stress sensor according to the embodiment.

FIG. 26G is a surface view observed from the magnetooptical microscope image of the magnetic material in the case of the external magnetic field Hex=200 (Oe), when applying the threshold force f=1.96 mN, in the magnetic material applied to the stress sensor according to the embodiment.

FIG. 26H is a surface view observed from the magnetooptical microscope image of the magnetic material in the case of the external magnetic field Hex=200 (Oe), when applying the threshold force f=0.00 mN, in the magnetic material applied to the stress sensor according to the embodiment.

FIG. 26I is a surface view observed from the magnetooptical microscope image of the magnetic material in the case of the external magnetic field Hex=200 (Oe), after the tungsten needle is released therefrom, in the magnetic material applied to the stress sensor according to the embodiment.

FIG. 27A is a surface view observed from the magnetooptical microscope image of the magnetic material in the case of the external magnetic field Hex=280 (Oe), before the tungsten needle is contacted thereto, in the magnetic material applied to the stress sensor according to the embodiment.

FIG. 27B is a surface view observed from the magnetooptical microscope image of the magnetic material in the case of the external magnetic field Hex=280 (Oe), when applying the threshold force f=0.00 mN, in the magnetic material applied to the stress sensor according to the embodiment.

FIG. 27C is a surface view observed from the magnetooptical microscope image of the magnetic material in the case of the external magnetic field Hex=280 (Oe), when applying the threshold force f=1.15 mN, in the magnetic material applied to the stress sensor according to the embodiment.

FIG. 27D is a surface view observed from the magnetooptical microscope image of the magnetic material in the case of the external magnetic field Hex=280 (Oe), when applying the threshold force f=5.10 mN, in the magnetic material applied to the stress sensor according to the embodiment.

FIG. 27E is a surface view observed from the magnetooptical microscope image of the magnetic material in the case of the external magnetic field Hex=280 (Oe), when applying the threshold force f=9.92 mN, in the magnetic material applied to the stress sensor according to the embodiment.

FIG. 27F is a surface view diagram when applying the threshold force f=5.40 mN.

FIG. 27G is a surface view observed from the magnetooptical microscope image of the magnetic material in the case of the external magnetic field Hex=280 (Oe), when applying the threshold force f=0.34 mN, in the magnetic material applied to the stress sensor according to the embodiment.

FIG. 27H is a surface view observed from the magnetooptical microscope image of the magnetic material in the case of the external magnetic field Hex=280 (Oe), when applying the threshold force f=0.00 mN, in the magnetic material applied to the stress sensor according to the embodiment.

FIG. 27I is a surface view observed from the magnetooptical microscope image of the magnetic material in the case of the external magnetic field Hex=280 (Oe), after the tungsten needle is released therefrom, in the magnetic material applied to the stress sensor according to the embodiment.

FIG. 28A is a surface view observed from the magnetooptical microscope image of the magnetic material in the case of the external magnetic field Hex=390 (Oe), before the tungsten needle is contacted thereto, in the magnetic material applied to the stress sensor according to the embodiment.

FIG. 28B is a surface view observed from the magnetooptical microscope image of the magnetic material in the case of the external magnetic field Hex=390 (Oe), when applying the threshold force f=0.00 mN, in the magnetic material applied to the stress sensor according to the embodiment.

FIG. 28C is a surface view observed from the magnetooptical microscope image of the magnetic material in the case of the external magnetic field Hex=390 (Oe), when applying the threshold force f=1.22 mN, in the magnetic material applied to the stress sensor according to the embodiment.

FIG. 28D is a surface view observed from the magnetooptical microscope image of the magnetic material in the case of the external magnetic field Hex=390 (Oe), when applying the threshold force f=4.96 mN, in the magnetic material applied to the stress sensor according to the embodiment.

FIG. 28E is a surface view observed from the magnetooptical microscope image of the magnetic material in the case of the external magnetic field Hex=390 (Oe), when applying the threshold force f=9.90 mN, in the magnetic material applied to the stress sensor according to the embodiment.

FIG. 28F is a surface view observed from the magnetooptical microscope image of the magnetic material in the case of the external magnetic field Hex=390 (Oe), when applying the threshold force f=5.24 mN, in the magnetic material applied to the stress sensor according to the embodiment.

FIG. 28G is a surface view observed from the magnetooptical microscope image of the magnetic material in the case of the external magnetic field Hex=390 (Oe), when applying the threshold force f=1.24 mN, in the magnetic material applied to the stress sensor according to the embodiment.

FIG. 28H is a surface view observed from the magnetooptical microscope image of the magnetic material in the case of the external magnetic field Hex=390 (Oe), when applying the threshold force f=0.00 mN, in the magnetic material applied to the stress sensor according to the embodiment.

FIG. 28I is a surface view observed from the magnetooptical microscope image of the magnetic material in the case of the external magnetic field Hex=390 (Oe), after the tungsten needle is released therefrom, in the magnetic material applied to the stress sensor according to the embodiment.

FIG. 29A is a surface view observed from the magnetooptical microscope image of the magnetic material in the case of the external magnetic field Hex=500 (Oe), before the tungsten needle is contacted thereto, in the magnetic material applied to the stress sensor according to the embodiment.

FIG. 29B is a surface view observed from the magnetooptical microscope image of the magnetic material in the case of the external magnetic field Hex=500 (Oe), when applying the threshold force f=0.00 mN, in the magnetic material applied to the stress sensor according to the embodiment.

FIG. 29C is a surface view observed from the magnetooptical microscope image of the magnetic material in the case of the external magnetic field Hex=500 (Oe) when applying the threshold force f=1.18 mN, in the magnetic material applied to the stress sensor according to the embodiment.

FIG. 29D is a surface view observed from the magnetooptical microscope image of the magnetic material in the case of the external magnetic field Hex=500 (Oe), when applying the threshold force f=4.96 mN, in the magnetic material applied to the stress sensor according to the embodiment.

FIG. 29E is a surface view observed from the magnetooptical microscope image of the magnetic material in the case of the external magnetic field Hex=500 (Oe), when applying the threshold force f=2.56 mN, in the magnetic material applied to the stress sensor according to the embodiment.

FIG. 29F is a surface view observed from the magnetooptical microscope image of the magnetic material in the case of the external magnetic field Hex=500 (Oe), when applying the threshold force f=1.71 mN, in the magnetic material applied to the stress sensor according to the embodiment.

FIG. 29G is a surface view observed from the magnetooptical microscope image of the magnetic material in the case of the external magnetic field Hex=500 (Oe), when applying the threshold force f=1.13 mN, in the magnetic material applied to the stress sensor according to the embodiment.

FIG. 29H is a surface view observed from the magnetooptical microscope image of the magnetic material in the case of the external magnetic field Hex=500 (Oe), when applying the threshold force f=0.00 mN, in the magnetic material applied to the stress sensor according to the embodiment.

FIG. 29I is a surface view observed from the magnetooptical microscope image of the magnetic material in the case of the external magnetic field Hex=500 (Oe), after the tungsten needle is released therefrom, in the magnetic material applied to the stress sensor according to the embodiment.

FIG. 30A is a surface view observed from the magnetooptical microscope image of the magnetic material in the case of the external magnetic field Hex=560 (Oe), before the tungsten needle is contacted thereto, in the magnetic material applied to the stress sensor according to the embodiment.

FIG. 30B is a surface view observed from the magnetooptical microscope image of the magnetic material in the case of the external magnetic field Hex=560 (Oe), when applying the threshold force f=0.00 mN, in the magnetic material applied to the stress sensor according to the embodiment.

FIG. 30C is a surface view observed from the magnetooptical microscope image of the magnetic material in the case of the external magnetic field Hex=560 (Oe), when applying the threshold force f=1.24 mN, in the magnetic material applied to the stress sensor according to the embodiment.

FIG. 30D is a surface view observed from the magnetooptical microscope image of the magnetic material in the case of the external magnetic field Hex=560 (Oe), when applying the threshold force f=2.49 mN, in the magnetic material applied to the stress sensor according to the embodiment.

FIG. 30E is a surface view observed from the magnetooptical microscope image of the magnetic material in the case of the external magnetic field Hex=560 (Oe), when applying the threshold force f=3.75 mN, in the magnetic material applied to the stress sensor according to the embodiment.

FIG. 30F is a surface view observed from the magnetooptical microscope image of the magnetic material in the case of the external magnetic field Hex=560 (Oe), when applying the threshold force f=2.22 mN, in the magnetic material applied to the stress sensor according to the embodiment.

FIG. 30G is a surface view observed from the magnetooptical microscope image of the magnetic material in the case of the external magnetic field Hex=560 (Oe), when applying the threshold force f=1.40 mN, in the magnetic material applied to the stress sensor according to the embodiment.

FIG. 30H is a surface view observed from the magnetooptical microscope image of the magnetic material in the case of the external magnetic field Hex=560 (Oe), when applying the threshold force f=0.00 mN, in the magnetic material applied to the stress sensor according to the embodiment.

FIG. 30I is a surface view observed from the magnetooptical microscope image of the magnetic material in the case of the external magnetic field Hex=560 (Oe), after the tungsten needle is released therefrom, in the magnetic material applied to the stress sensor according to the embodiment.

FIG. 31A is a superimposed image before and after a displacement of the magnetic domain observed from the magnetooptical microscope image of the magnetic material in the case of the external magnetic field Hex=0 (Oe), before the tungsten needle is contacted thereto, in the magnetic material applied to the stress sensor according to the embodiment.

FIG. 31B is a superimposed image before and after a displacement of the magnetic domain observed from the magnetooptical microscope image of the magnetic material in the case of the external magnetic field Hex=0 (Oe), when applying the threshold force f=0.00 mN, in the magnetic material applied to the stress sensor according to the embodiment.

FIG. 31C is a superimposed image before and after a displacement of the magnetic domain observed from the magnetooptical microscope image of the magnetic material in the case of the external magnetic field Hex=0 (Oe), when applying the threshold force f=3.14 mN, in the magnetic material applied to the stress sensor according to the embodiment.

FIG. 31D is a superimposed image before and after a displacement of the magnetic domain observed from the magnetooptical microscope image of the magnetic material in the case of the external magnetic field Hex=0 (Oe), when applying the threshold force f=6.70 mN, in the magnetic material applied to the stress sensor according to the embodiment.

FIG. 31E is a superimposed image before and after a displacement of the magnetic domain observed from the magnetooptical microscope image of the magnetic material in the case of the external magnetic field Hex=0 (Oe), when applying the threshold force f=7.79 mN, in the magnetic material applied to the stress sensor according to the embodiment.

FIG. 31F is a superimposed image before and after a displacement of the magnetic domain observed from the magnetooptical microscope image of the magnetic material in the case of the external magnetic field Hex=0 (Oe), when applying the threshold force f=6.30 mN, in the magnetic material applied to the stress sensor according to the embodiment.

FIG. 31G is a superimposed image before and after a displacement of the magnetic domain observed from the magnetooptical microscope image of the magnetic material in the case of the external magnetic field Hex=0 (Oe), when applying the threshold force f=2.86 mN, in the magnetic material applied to the stress sensor according to the embodiment.

FIG. 31H is a superimposed image before and after a displacement of the magnetic domain observed from the magnetooptical microscope image of the magnetic material in the case of the external magnetic field Hex=0 (Oe), when applying the threshold force f=0.00 mN, in the magnetic material applied to the stress sensor according to the embodiment.

FIG. 31I is a superimposed image before and after a displacement of the magnetic domain observed from the magnetooptical microscope image of the magnetic material in the case of the external magnetic field Hex=0 (Oe), after the tungsten needle is released therefrom, in the magnetic material applied to the stress sensor according to the embodiment.

FIG. 32A is a superimposed image before and after a displacement of the magnetic domain observed from the magnetooptical microscope image of the magnetic material in the case of the external magnetic field Hex=70 (Oe), before the tungsten needle is contacted thereto, in the magnetic material applied to the stress sensor according to the embodiment.

FIG. 32B is a superimposed image before and after a displacement of the magnetic domain observed from the magnetooptical microscope image of the magnetic material in the case of the external magnetic field Hex=70 (Oe), when applying the threshold force f=0.00 mN, in the magnetic material applied to the stress sensor according to the embodiment.

FIG. 32C is a superimposed image before and after a displacement of the magnetic domain observed from the magnetooptical microscope image of the magnetic material in the case of the external magnetic field Hex=70 (Oe), when applying the threshold force f=2.92 mN, in the magnetic material applied to the stress sensor according to the embodiment.

FIG. 32D is a superimposed image before and after a displacement of the magnetic domain observed from the magnetooptical microscope image of the magnetic material in the case of the external magnetic field Hex=70 (Oe), when applying the threshold force f=4.32 mN, in the magnetic material applied to the stress sensor according to the embodiment.

FIG. 32E is a superimposed image before and after a displacement of the magnetic domain observed from the magnetooptical microscope image of the magnetic material in the case of the external magnetic field Hex=70 (Oe), when applying the threshold force f=5.60 mN, in the magnetic material applied to the stress sensor according to the embodiment.

FIG. 32F is a superimposed image before and after a displacement of the magnetic domain observed from the magnetooptical microscope image of the magnetic material in the case of the external magnetic field Hex=70 (Oe), when applying the threshold force f=4.36 mN, in the magnetic material applied to the stress sensor according to the embodiment.

FIG. 32G is a superimposed image before and after a displacement of the magnetic domain observed from the magnetooptical microscope image of the magnetic material in the case of the external magnetic field Hex=70 (Oe), when applying the threshold force f=2.94 mN, in the magnetic material applied to the stress sensor according to the embodiment.

FIG. 32H is a superimposed image before and after a displacement of the magnetic domain observed from the magnetooptical microscope image of the magnetic material in the case of the external magnetic field Hex=70 (Oe), when applying the threshold force f=0.00 mN, in the magnetic material applied to the stress sensor according to the embodiment.

FIG. 32I is a superimposed image before and after a displacement of the magnetic domain observed from the magnetooptical microscope image of the magnetic material in the case of the external magnetic field Hex=70 (Oe), after the tungsten needle is released therefrom, in the magnetic material applied to the stress sensor according to the embodiment.

FIG. 33A is a superimposed image before and after a displacement of the magnetic domain observed from the magnetooptical microscope image of the magnetic material in the case of the external magnetic field Hex=130 (Oe), before the tungsten needle is contacted thereto, in the magnetic material applied to the stress sensor according to the embodiment.

FIG. 33B is a superimposed image before and after a displacement of the magnetic domain observed from the magnetooptical microscope image of the magnetic material in the case of the external magnetic field Hex=130 (Oe), when applying the threshold force f=0.00 mN, in the magnetic material applied to the stress sensor according to the embodiment.

FIG. 33C is a superimposed image before and after a displacement of the magnetic domain observed from the magnetooptical microscope image of the magnetic material in the case of the external magnetic field Hex=130 (Oe), when applying the threshold force f=1.36 mN, in the magnetic material applied to the stress sensor according to the embodiment.

FIG. 33D is a superimposed image before and after a displacement of the magnetic domain observed from the magnetooptical microscope image of the magnetic material in the case of the external magnetic field Hex=130 (Oe), when applying the threshold force f=3.12 mN, in the magnetic material applied to the stress sensor according to the embodiment.

FIG. 33E is a superimposed image before and after a displacement of the magnetic domain observed from the magnetooptical microscope image of the magnetic material in the case of the external magnetic field Hex=130 (Oe), when applying the threshold force f=4.28 mN, in the magnetic material applied to the stress sensor according to the embodiment.

FIG. 33F is a superimposed image before and after a displacement of the magnetic domain observed from the magnetooptical microscope image of the magnetic material in the case of the external magnetic field Hex=130 (Oe), when applying the threshold force f=2.83 mN, in the magnetic material applied to the stress sensor according to the embodiment.

FIG. 33G is a superimposed image before and after a displacement of the magnetic domain observed from the magnetooptical microscope image of the magnetic material in the case of the external magnetic field Hex=130 (Oe), when applying the threshold force f=1.41 mN, in the magnetic material applied to the stress sensor according to the embodiment.

FIG. 33H is a superimposed image before and after a displacement of the magnetic domain observed from the magnetooptical microscope image of the magnetic material in the case of the external magnetic field Hex=130 (Oe), when applying the threshold force f=0.00 mN, in the magnetic material applied to the stress sensor according to the embodiment.

FIG. 33I is a superimposed image before and after a displacement of the magnetic domain observed from the magnetooptical microscope image of the magnetic material in the case of the external magnetic field Hex=130 (Oe), after the tungsten needle is released therefrom, in the magnetic material applied to the stress sensor according to the embodiment.

FIG. 34A is a superimposed image before and after a displacement of the magnetic domain observed from the magnetooptical microscope image of the magnetic material in the case of the external magnetic field Hex=200 (Oe), before the tungsten needle is contacted thereto, in the magnetic material applied to the stress sensor according to the embodiment.

FIG. 34B is a superimposed image before and after a displacement of the magnetic domain observed from the magnetooptical microscope image of the magnetic material in the case of the external magnetic field Hex=200 (Oe), when applying the threshold force f=0.00 mN, in the magnetic material applied to the stress sensor according to the embodiment.

FIG. 34C is a superimposed image before and after a displacement of the magnetic domain observed from the magnetooptical microscope image of the magnetic material in the case of the external magnetic field Hex=200 (Oe), when applying the threshold force f=2.19 mN, in the magnetic material applied to the stress sensor according to the embodiment.

FIG. 34D is a superimposed image before and after a displacement of the magnetic domain observed from the magnetooptical microscope image of the magnetic material in the case of the external magnetic field Hex=200 (Oe), when applying the threshold force f=2.59 mN, in the magnetic material applied to the stress sensor according to the embodiment.

FIG. 34E is a superimposed image before and after a displacement of the magnetic domain observed from the magnetooptical microscope image of the magnetic material in the case of the external magnetic field Hex=200 (Oe), when applying the threshold force f=3.43 mN, in the magnetic material applied to the stress sensor according to the embodiment.

FIG. 34F is a superimposed image before and after a displacement of the magnetic domain observed from the magnetooptical microscope image of the magnetic material in the case of the external magnetic field Hex=200 (Oe), when applying the threshold force f=2.57 mN, in the magnetic material applied to the stress sensor according to the embodiment.

FIG. 34G is a superimposed image before and after a displacement of the magnetic domain observed from the magnetooptical microscope image of the magnetic material in the case of the external magnetic field Hex=200 (Oe), when applying the threshold force f=1.96 mN, in the magnetic material applied to the stress sensor according to the embodiment.

FIG. 34H is a superimposed image before and after a displacement of the magnetic domain observed from the magnetooptical microscope image of the magnetic material in the case of the external magnetic field Hex=200 (Oe), when applying the threshold force f=0.00 mN, in the magnetic material applied to the stress sensor according to the embodiment.

FIG. 34I is a superimposed image before and after a displacement of the magnetic domain observed from the magnetooptical microscope image of the magnetic material in the case of the external magnetic field Hex=200 (Oe), after the tungsten needle is released therefrom, in the magnetic material applied to the stress sensor according to the embodiment.

FIG. 35A is a superimposed image before and after a displacement of the magnetic domain observed from the magnetooptical microscope image of the magnetic material in the case of the external magnetic field Hex=280 (Oe), before the tungsten needle is contacted thereto, in the magnetic material applied to the stress sensor according to the embodiment.

FIG. 35B is a superimposed image before and after a displacement of the magnetic domain observed from the magnetooptical microscope image of the magnetic material in the case of the external magnetic field Hex=280 (Oe), when applying the threshold force f=0.00 mN, in the magnetic material applied to the stress sensor according to the embodiment.

FIG. 35C is a superimposed image before and after a displacement of the magnetic domain observed from the magnetooptical microscope image of the magnetic material in the case of the external magnetic field Hex=280 (Oe), when applying the threshold force f=1.15 mN, in the magnetic material applied to the stress sensor according to the embodiment.

FIG. 35D is a superimposed image before and after a displacement of the magnetic domain observed from the magnetooptical microscope image of the magnetic material in the case of the external magnetic field Hex=280 (Oe), when applying the threshold force f=5.10 mN, in the magnetic material applied to the stress sensor according to the embodiment.

FIG. 35E is a superimposed image before and after a displacement of the magnetic domain observed from the magnetooptical microscope image of the magnetic material in the case of the external magnetic field Hex=280 (Oe), when applying the threshold force f=9.92 mN, in the magnetic material applied to the stress sensor according to the embodiment.

FIG. 35F is a superimposed image before and after a displacement of the magnetic domain observed from the magnetooptical microscope image of the magnetic material in the case of the external magnetic field Hex=280 (Oe), when applying the threshold force f=5.40 mN, in the magnetic material applied to the stress sensor according to the embodiment.

FIG. 35G is a superimposed image before and after a displacement of the magnetic domain observed from the magnetooptical microscope image of the magnetic material in the case of the external magnetic field Hex=280 (Oe), when applying the threshold force f=0.34 mN, in the magnetic material applied to the stress sensor according to the embodiment.

FIG. 35H is a superimposed image before and after a displacement of the magnetic domain observed from the magnetooptical microscope image of the magnetic material in the case of the external magnetic field Hex=280 (Oe), when applying the threshold force f=0.00 mN, in the magnetic material applied to the stress sensor according to the embodiment.

FIG. 35I is a superimposed image before and after a displacement of the magnetic domain observed from the magnetooptical microscope image of the magnetic material in the case of the external magnetic field Hex=280 (Oe), after the tungsten needle is released therefrom, in the magnetic material applied to the stress sensor according to the embodiment.

FIG. 36A is a superimposed image before and after a displacement of the magnetic domain observed from the magnetooptical microscope image of the magnetic material in the case of the external magnetic field Hex=390 (Oe), before the tungsten needle is contacted thereto, in the magnetic material applied to the stress sensor according to the embodiment.

FIG. 36B is a superimposed image before and after a displacement of the magnetic domain observed from the magnetooptical microscope image of the magnetic material in the case of the external magnetic field Hex=390 (Oe), when applying the threshold force f=0.00 mN, in the magnetic material applied to the stress sensor according to the embodiment.

FIG. 36C is a superimposed image before and after a displacement of the magnetic domain observed from the magnetooptical microscope image of the magnetic material in the case of the external magnetic field Hex=390 (Oe), when applying the threshold force f=1.22 mN, in the magnetic material applied to the stress sensor according to the embodiment.

FIG. 36D is a superimposed image before and after a displacement of the magnetic domain observed from the magnetooptical microscope image of the magnetic material in the case of the external magnetic field Hex=390 (Oe), when applying the threshold force f=4.96 mN, in the magnetic material applied to the stress sensor according to the embodiment.

FIG. 36E is a superimposed image before and after a displacement of the magnetic domain observed from the magnetooptical microscope image of the magnetic material in the case of the external magnetic field Hex=390 (Oe), when applying the threshold force f=9.90 mN, in the magnetic material applied to the stress sensor according to the embodiment.

FIG. 36F is a superimposed image before and after a displacement of the magnetic domain observed from the magnetooptical microscope image of the magnetic material in the case of the external magnetic field Hex=390 (Oe), when applying the threshold force f=5.24 mN, in the magnetic material applied to the stress sensor according to the embodiment.

FIG. 36G is a superimposed image before and after a displacement of the magnetic domain observed from the magnetooptical microscope image of the magnetic material in the case of the external magnetic field Hex=390 (Oe), when applying the threshold force f=1.24 mN, in the magnetic material applied to the stress sensor according to the embodiment.

FIG. 36H is a superimposed image before and after a displacement of the magnetic domain observed from the magnetooptical microscope image of the magnetic material in the case of the external magnetic field Hex=390 (Oe), when applying the threshold force f=0.00 mN, in the magnetic material applied to the stress sensor according to the embodiment.

FIG. 36I is a superimposed image before and after a displacement of the magnetic domain observed from the magnetooptical microscope image of the magnetic material in the case of the external magnetic field Hex=390 (Oe), after the tungsten needle is released therefrom, in the magnetic material applied to the stress sensor according to the embodiment.

FIG. 37A is a superimposed image before and after a displacement of the magnetic domain observed from the magnetooptical microscope image of the magnetic material in the case of the external magnetic field Hex=500 (Oe), before the tungsten needle is contacted thereto, in the magnetic material applied to the stress sensor according to the embodiment.

FIG. 37B is a superimposed image before and after a displacement of the magnetic domain observed from the magnetooptical microscope image of the magnetic material in the case of the external magnetic field Hex=500 (Oe), when applying the threshold force f=0.00 mN, in the magnetic material applied to the stress sensor according to the embodiment.

FIG. 37C is a superimposed image before and after a displacement of the magnetic domain observed from the magnetooptical microscope image of the magnetic material in the case of the external magnetic field Hex=500 (Oe), when applying the threshold force f=1.18 mN, in the magnetic material applied to the stress sensor according to the embodiment.

FIG. 37D is a superimposed image before and after a displacement of the magnetic domain observed from the magnetooptical microscope image of the magnetic material in the case of the external magnetic field Hex=500 (Oe), when applying the threshold force f=4.96 mN, in the magnetic material applied to the stress sensor according to the embodiment.

FIG. 37E is a superimposed image before and after a displacement of the magnetic domain observed from the magnetooptical microscope image of the magnetic material in the case of the external magnetic field Hex=500 (Oe), when applying the threshold force f=2.56 mN, in the magnetic material applied to the stress sensor according to the embodiment.

FIG. 37F is a superimposed image before and after a displacement of the magnetic domain observed from the magnetooptical microscope image of the magnetic material in the case of the external magnetic field Hex=500 (Oe), when applying the threshold force f=1.71 mN, in the magnetic material applied to the stress sensor according to the embodiment.

FIG. 37G is a superimposed image before and after a displacement of the magnetic domain observed from the magnetooptical microscope image of the magnetic material in the case of the external magnetic field Hex=500 (Oe), when applying the threshold force f=1.13 mN, in the magnetic material applied to the stress sensor according to the embodiment.

FIG. 37H is a superimposed image before and after a displacement of the magnetic domain observed from the magnetooptical microscope image of the magnetic material in the case of the external magnetic field Hex=500 (Oe), when applying the threshold force f=0.00 mN, in the magnetic material applied to the stress sensor according to the embodiment.

FIG. 37I is a superimposed image before and after a displacement of the magnetic domain observed from the magnetooptical microscope image of the magnetic material in the case of the external magnetic field Hex=500 (Oe), after the tungsten needle is released therefrom, in the magnetic material applied to the stress sensor according to the embodiment.

FIG. 38A is a superimposed image before and after a displacement of the magnetic domain observed from the magnetooptical microscope image of the magnetic material in the case of the external magnetic field Hex=560 (Oe), before the tungsten needle is contacted thereto, in the magnetic material applied to the stress sensor according to the embodiment.

FIG. 38B is a superimposed image before and after a displacement of the magnetic domain observed from the magnetooptical microscope image of the magnetic material in the case of the external magnetic field Hex=560 (Oe), when applying the threshold force f=0.00 mN, in the magnetic material applied to the stress sensor according to the embodiment.

FIG. 38C is a superimposed image before and after a displacement of the magnetic domain observed from the magnetooptical microscope image of the magnetic material in the case of the external magnetic field Hex=560 (Oe), when applying the threshold force f=1.24 mN, in the magnetic material applied to the stress sensor according to the embodiment.

FIG. 38D is a superimposed image before and after a displacement of the magnetic domain observed from the magnetooptical microscope image of the magnetic material in the case of the external magnetic field Hex=560 (Oe), when applying the threshold force f=2.49 mN, in the magnetic material applied to the stress sensor according to the embodiment.

FIG. 38E is a superimposed image before and after a displacement of the magnetic domain observed from the magnetooptical microscope image of the magnetic material in the case of the external magnetic field Hex=560 (Oe), when applying the threshold force f=3.75 mN, in the magnetic material applied to the stress sensor according to the embodiment.

FIG. 38F is a superimposed image before and after a displacement of the magnetic domain observed from the magnetooptical microscope image of the magnetic material in the case of the external magnetic field Hex=560 (Oe), when applying the threshold force f=2.22 mN, in the magnetic material applied to the stress sensor according to the embodiment.

FIG. 38G is a superimposed image before and after a displacement of the magnetic domain observed from the magnetooptical microscope image of the magnetic material in the case of the external magnetic field Hex=560 (Oe), when applying the threshold force f=1.40 mN, in the magnetic material applied to the stress sensor according to the embodiment.

FIG. 38H is a superimposed image before and after a displacement of the magnetic domain observed from the magnetooptical microscope image of the magnetic material in the case of the external magnetic field Hex=560 (Oe), when applying the threshold force f=0.00 mN, in the magnetic material applied to the stress sensor according to the embodiment.

FIG. 38I is a superimposed image before and after a displacement of the magnetic domain observed from the magnetooptical microscope image of the magnetic material in the case of the external magnetic field Hex=560 (Oe), after the tungsten needle is released therefrom, in the magnetic material applied to the stress sensor according to the embodiment.

FIG. 39A is a difference image before and after a displacement of the magnetic domain observed from the magnetooptical microscope image of the magnetic material in the case of the external magnetic field Hex=0 (Oe), before the tungsten needle is contacted thereto, in the magnetic material applied to the stress sensor according to the embodiment.

FIG. 39B is a difference image before and after a displacement of the magnetic domain observed from the magnetooptical microscope image of the magnetic material in the case of the external magnetic field Hex=0 (Oe), when applying the threshold force f=0.00 mN, in the magnetic material applied to the stress sensor according to the embodiment.

FIG. 39C is a difference image before and after a displacement of the magnetic domain observed from the magnetooptical microscope image of the magnetic material in the case of the external magnetic field Hex=0 (Oe), when applying the threshold force f=3.14 mN, in the magnetic material applied to the stress sensor according to the embodiment.

FIG. 39D is a difference image before and after a displacement of the magnetic domain observed from the magnetooptical microscope image of the magnetic material in the case of the external magnetic field Hex=0 (Oe), when applying the threshold force f=6.70 mN, in the magnetic material applied to the stress sensor according to the embodiment.

FIG. 39E is a difference image before and after a displacement of the magnetic domain observed from the magnetooptical microscope image of the magnetic material in the case of the external magnetic field Hex=0 (Oe), when applying the threshold force f=7.79 mN, in the magnetic material applied to the stress sensor according to the embodiment.

FIG. 39F is a difference image before and after a displacement of the magnetic domain observed from the magnetooptical microscope image of the magnetic material in the case of the external magnetic field Hex=0 (Oe), when applying the threshold force f=6.30 mN, in the magnetic material applied to the stress sensor according to the embodiment.

FIG. 39G is a difference image before and after a displacement of the magnetic domain observed from the magnetooptical microscope image of the magnetic material in the case of the external magnetic field Hex=0 (Oe), when applying the threshold force f=2.86 mN, in the magnetic material applied to the stress sensor according to the embodiment.

FIG. 39H is a difference image before and after a displacement of the magnetic domain observed from the magnetooptical microscope image of the magnetic material in the case of the external magnetic field Hex=0 (Oe), when applying the threshold force f=0.00 mN, in the magnetic material applied to the stress sensor according to the embodiment.

FIG. 39I is a difference image before and after a displacement of the magnetic domain observed from the magnetooptical microscope image of the magnetic material in the case of the external magnetic field Hex=0 (Oe), after the tungsten needle is released therefrom, in the magnetic material applied to the stress sensor according to the embodiment.

FIG. 40A is a difference image before and after a displacement of the magnetic domain observed from the magnetooptical microscope image of the magnetic material in the case of the external magnetic field Hex=70 (Oe), before the tungsten needle is contacted thereto, in the magnetic material applied to the stress sensor according to the embodiment.

FIG. 40B is a difference image before and after a displacement of the magnetic domain observed from the magnetooptical microscope image of the magnetic material in the case of the external magnetic field Hex=70 (Oe), when applying the threshold force f=0.00 mN, in the magnetic material applied to the stress sensor according to the embodiment.

FIG. 40C is a difference image before and after a displacement of the magnetic domain observed from the magnetooptical microscope image of the magnetic material in the case of the external magnetic field Hex=70 (Oe), when applying the threshold force f=2.92 mN, in the magnetic material applied to the stress sensor according to the embodiment.

FIG. 40D is a difference image before and after a displacement of the magnetic domain observed from the magnetooptical microscope image of the magnetic material in the case of the external magnetic field Hex=70 (Oe), when applying the threshold force f=4.32 mN, in the magnetic material applied to the stress sensor according to the embodiment.

FIG. 40E is a difference image before and after a displacement of the magnetic domain observed from the magnetooptical microscope image of the magnetic material in the case of the external magnetic field Hex=70 (Oe), when applying the threshold force f=5.60 mN, in the magnetic material applied to the stress sensor according to the embodiment.

FIG. 40F is a difference image before and after a displacement of the magnetic domain observed from the magnetooptical microscope image of the magnetic material in the case of the external magnetic field Hex=70 (Oe), when applying the threshold force f=4.36 mN, in the magnetic material applied to the stress sensor according to the embodiment.

FIG. 40G is a difference image before and after a displacement of the magnetic domain observed from the magnetooptical microscope image of the magnetic material in the case of the external magnetic field Hex=70 (Oe), when applying the threshold force f=2.94 mN, in the magnetic material applied to the stress sensor according to the embodiment.

FIG. 40H is a difference image before and after a displacement of the magnetic domain observed from the magnetooptical microscope image of the magnetic material in the case of the external magnetic field Hex=70 (Oe), when applying the threshold force f=0.00 mN, in the magnetic material applied to the stress sensor according to the embodiment.

FIG. 40I is a difference image before and after a displacement of the magnetic domain observed from the magnetooptical microscope image of the magnetic material in the case of the external magnetic field Hex=70 (Oe), after the tungsten needle is released therefrom, in the magnetic material applied to the stress sensor according to the embodiment.

FIG. 41A is a difference image before and after a displacement of the magnetic domain observed from the magnetooptical microscope image of the magnetic material in the case of the external magnetic field Hex=130 (Oe), before the tungsten needle is contacted thereto, in the magnetic material applied to the stress sensor according to the embodiment.

FIG. 41B is a difference image before and after a displacement of the magnetic domain observed from the magnetooptical microscope image of the magnetic material in the case of the external magnetic field Hex=130 (Oe), when applying the threshold force f=0.00 mN, in the magnetic material applied to the stress sensor according to the embodiment.

FIG. 41C is a difference image before and after a displacement of the magnetic domain observed from the magnetooptical microscope image of the magnetic material in the case of the external magnetic field Hex=130 (Oe), when applying the threshold force f=1.36 mN, in the magnetic material applied to the stress sensor according to the embodiment.

FIG. 41D is a difference image before and after a displacement of the magnetic domain observed from the magnetooptical microscope image of the magnetic material in the case of the external magnetic field Hex=130 (Oe), when applying the threshold force f=3.12 mN, in the magnetic material applied to the stress sensor according to the embodiment.

FIG. 41E is a difference image before and after a displacement of the magnetic domain observed from the magnetooptical microscope image of the magnetic material in the case of the external magnetic field Hex=130 (Oe), when applying the threshold force f=4.28 mN, in the magnetic material applied to the stress sensor according to the embodiment.

FIG. 41F is a difference image before and after a displacement of the magnetic domain observed from the magnetooptical microscope image of the magnetic material in the case of the external magnetic field Hex=130 (Oe), when applying the threshold force f=2.83 mN, in the magnetic material applied to the stress sensor according to the embodiment.

FIG. 41G is a difference image before and after a displacement of the magnetic domain observed from the magnetooptical microscope image of the magnetic material in the case of the external magnetic field Hex=130 (Oe), when applying the threshold force f=1.41 mN, in the magnetic material applied to the stress sensor according to the embodiment.

FIG. 41H is a difference image before and after a displacement of the magnetic domain observed from the magnetooptical microscope image of the magnetic material in the case of the external magnetic field Hex=130 (Oe), when applying the threshold force f=0.00 mN, in the magnetic material applied to the stress sensor according to the embodiment.

FIG. 41I is a difference image before and after a displacement of the magnetic domain observed from the magnetooptical microscope image of the magnetic material in the case of the external magnetic field Hex=130 (Oe), after the tungsten needle is released therefrom, in the magnetic material applied to the stress sensor according to the embodiment.

FIG. 42A is a difference image before and after a displacement of the magnetic domain observed from the magnetooptical microscope image of the magnetic material in the case of the external magnetic field Hex=200 (Oe), before the tungsten needle is contacted thereto, in the magnetic material applied to the stress sensor according to the embodiment.

FIG. 42B is a difference image before and after a displacement of the magnetic domain observed from the magnetooptical microscope image of the magnetic material in the case of the external magnetic field Hex=200 (Oe), when applying the threshold force f=0.00 mN, in the magnetic material applied to the stress sensor according to the embodiment.

FIG. 42C is a difference image before and after a displacement of the magnetic domain observed from the magnetooptical microscope image of the magnetic material in the case of the external magnetic field Hex=200 (Oe), when applying the threshold force f=2.19 mN, in the magnetic material applied to the stress sensor according to the embodiment.

FIG. 42D is a difference image before and after a displacement of the magnetic domain observed from the magnetooptical microscope image of the magnetic material in the case of the external magnetic field Hex=200 (Oe), when applying the threshold force f=2.59 mN, in the magnetic material applied to the stress sensor according to the embodiment.

FIG. 42E is a difference image before and after a displacement of the magnetic domain observed from the magnetooptical microscope image of the magnetic material in the case of the external magnetic field Hex=200 (Oe), when applying the threshold force f=3.43 mN, in the magnetic material applied to the stress sensor according to the embodiment.

FIG. 42F is a difference image before and after a displacement of the magnetic domain observed from the magnetooptical microscope image of the magnetic material in the case of the external magnetic field Hex=200 (Oe), when applying the threshold force f=2.57 mN, in the magnetic material applied to the stress sensor according to the embodiment.

FIG. 42G is a difference image before and after a displacement of the magnetic domain observed from the magnetooptical microscope image of the magnetic material in the case of the external magnetic field Hex=200 (Oe), when applying the threshold force f=1.96 mN, in the magnetic material applied to the stress sensor according to the embodiment.

FIG. 42H is a difference image before and after a displacement of the magnetic domain observed from the magnetooptical microscope image of the magnetic material in the case of the external magnetic field Hex=200 (Oe), when applying the threshold force f=0.00 mN, in the magnetic material applied to the stress sensor according to the embodiment.

FIG. 42I is a difference image before and after a displacement of the magnetic domain observed from the magnetooptical microscope image of the magnetic material in the case of the external magnetic field Hex=200 (Oe), after the tungsten needle is released therefrom, in the magnetic material applied to the stress sensor according to the embodiment.

FIG. 43A is a difference image before and after a displacement of the magnetic domain observed from the magnetooptical microscope image of the magnetic material in the case of the external magnetic field Hex=280 (Oe), before the tungsten needle is contacted thereto, in the magnetic material applied to the stress sensor according to the embodiment.

FIG. 43B is a difference image before and after a displacement of the magnetic domain observed from the magnetooptical microscope image of the magnetic material in the case of the external magnetic field Hex=280 (Oe), when applying the threshold force f=0.00 mN, in the magnetic material applied to the stress sensor according to the embodiment.

FIG. 43C is a difference image before and after a displacement of the magnetic domain observed from the magnetooptical microscope image of the magnetic material in the case of the external magnetic field Hex=280 (Oe), when applying the threshold force f=1.15 mN, in the magnetic material applied to the stress sensor according to the embodiment.

FIG. 43D is a difference image before and after a displacement of the magnetic domain observed from the magnetooptical microscope image of the magnetic material in the case of the external magnetic field Hex=280 (Oe), when applying the threshold force f=5.10 mN, in the magnetic material applied to the stress sensor according to the embodiment.

FIG. 43E is a difference image before and after a displacement of the magnetic domain observed from the magnetooptical microscope image of the magnetic material in the case of the external magnetic field Hex=280 (Oe), when applying the threshold force f=9.92 mN, in the magnetic material applied to the stress sensor according to the embodiment.

FIG. 43F is a difference image before and after a displacement of the magnetic domain observed from the magnetooptical microscope image of the magnetic material in the case of the external magnetic field Hex=280 (Oe), when applying the threshold force f=5.40 mN, in the magnetic material applied to the stress sensor according to the embodiment.

FIG. 43G is a difference image before and after a displacement of the magnetic domain observed from the magnetooptical microscope image of the magnetic material in the case of the external magnetic field Hex=280 (Oe), when applying the threshold force f=0.34 mN, in the magnetic material applied to the stress sensor according to the embodiment.

FIG. 43H is a difference image before and after a displacement of the magnetic domain observed from the magnetooptical microscope image of the magnetic material in the case of the external magnetic field Hex=280 (Oe), when applying the threshold force f=0.00 mN, in the magnetic material applied to the stress sensor according to the embodiment.

FIG. 43I is a difference image before and after a displacement of the magnetic domain observed from the magnetooptical microscope image of the magnetic material in the case of the external magnetic field Hex=280 (Oe), after the tungsten needle is released therefrom, in the magnetic material applied to the stress sensor according to the embodiment.

FIG. 44A is a difference image before and after a displacement of the magnetic domain observed from the magnetooptical microscope image of the magnetic material in the case of the external magnetic field Hex=390 (Oe), before the tungsten needle is contacted thereto, in the magnetic material applied to the stress sensor according to the embodiment.

FIG. 44B is a difference image before and after a displacement of the magnetic domain observed from the magnetooptical microscope image of the magnetic material in the case of the external magnetic field Hex=390 (Oe), when applying the threshold force f=0.00 mN, in the magnetic material applied to the stress sensor according to the embodiment.

FIG. 44C is a difference image before and after a displacement of the magnetic domain observed from the magnetooptical microscope image of the magnetic material in the case of the external magnetic field Hex=390 (Oe), when applying the threshold force f=1.22 mN, in the magnetic material applied to the stress sensor according to the embodiment.

FIG. 44D is a difference image before and after a displacement of the magnetic domain observed from the magnetooptical microscope image of the magnetic material in the case of the external magnetic field Hex=390 (Oe), when applying the threshold force f=4.96 mN, in the magnetic material applied to the stress sensor according to the embodiment.

FIG. 44E is a difference image before and after a displacement of the magnetic domain observed from the magnetooptical microscope image of the magnetic material in the case of the external magnetic field Hex=390 (Oe), when applying the threshold force f=9.90 mN, in the magnetic material applied to the stress sensor according to the embodiment.

FIG. 44F is a difference image before and after a displacement of the magnetic domain observed from the magnetooptical microscope image of the magnetic material in the case of the external magnetic field Hex=390 (Oe), when applying the threshold force f=5.24 mN, in the magnetic material applied to the stress sensor according to the embodiment.

FIG. 44G is a difference image before and after a displacement of the magnetic domain observed from the magnetooptical microscope image of the magnetic material in the case of the external magnetic field Hex=390 (Oe), when applying the threshold force f=1.24 mN, in the magnetic material applied to the stress sensor according to the embodiment.

FIG. 44H is a difference image before and after a displacement of the magnetic domain observed from the magnetooptical microscope image of the magnetic material in the case of the external magnetic field Hex=390 (Oe), when applying the threshold force f=0.00 mN, in the magnetic material applied to the stress sensor according to the embodiment.

FIG. 44I is a difference image before and after a displacement of the magnetic domain observed from the magnetooptical microscope image of the magnetic material in the case of the external magnetic field Hex=390 (Oe), after the tungsten needle is released therefrom, in the magnetic material applied to the stress sensor according to the embodiment.

FIG. 45A is a difference image before and after a displacement of the magnetic domain observed from the magnetooptical microscope image of the magnetic material in the case of the external magnetic field Hex=500 (Oe), before the tungsten needle is contacted thereto, in the magnetic material applied to the stress sensor according to the embodiment.

FIG. 45B is a difference image before and after a displacement of the magnetic domain observed from the magnetooptical microscope image of the magnetic material in the case of the external magnetic field Hex=500 (Oe), when applying the threshold force f=0.00 mN, in the magnetic material applied to the stress sensor according to the embodiment.

FIG. 45C is a difference image before and after a displacement of the magnetic domain observed from the magnetooptical microscope image of the magnetic material in the case of the external magnetic field Hex=500 (Oe), when applying the threshold force f=1.18 mN, in the magnetic material applied to the stress sensor according to the embodiment.

FIG. 45D is a difference image before and after a displacement of the magnetic domain observed from the magnetooptical microscope image of the magnetic material in the case of the external magnetic field Hex=500 (Oe), when applying the threshold force f=4.96 mN, in the magnetic material applied to the stress sensor according to the embodiment.

FIG. 45E is a difference image before and after a displacement of the magnetic domain observed from the magnetooptical microscope image of the magnetic material in the case of the external magnetic field Hex=500 (Oe), when applying the threshold force f=2.56 mN, in the magnetic material applied to the stress sensor according to the embodiment.

FIG. 45F is a difference image before and after a displacement of the magnetic domain observed from the magnetooptical microscope image of the magnetic material in the case of the external magnetic field Hex=500 (Oe), when applying the threshold force f=1.71 mN, in the magnetic material applied to the stress sensor according to the embodiment.

FIG. 45G is a difference image before and after a displacement of the magnetic domain observed from the magnetooptical microscope image of the magnetic material in the case of the external magnetic field Hex=500 (Oe), when applying the threshold force f=1.13 mN, in the magnetic material applied to the stress sensor according to the embodiment.

FIG. 45H is a difference image before and after a displacement of the magnetic domain observed from the magnetooptical microscope image of the magnetic material in the case of the external magnetic field Hex=500 (Oe), when applying the threshold force f=0.00 mN, in the magnetic material applied to the stress sensor according to the embodiment.

FIG. 45I is a difference image before and after a displacement of the magnetic domain observed from the magnetooptical microscope image of the magnetic material in the case of the external magnetic field Hex=500 (Oe), after the tungsten needle is released therefrom, in the magnetic material applied to the stress sensor according to the embodiment.

FIG. 46A is a difference image before and after a displacement of the magnetic domain observed from the magnetooptical microscope image of the magnetic material in the case of the external magnetic field Hex=560 (Oe), before the tungsten needle is contacted thereto, in the magnetic material applied to the stress sensor according to the embodiment.

FIG. 46B is a difference image before and after a displacement of the magnetic domain observed from the magnetooptical microscope image of the magnetic material in the case of the external magnetic field Hex=560 (Oe), when applying the threshold force f=0.00 mN, in the magnetic material applied to the stress sensor according to the embodiment.

FIG. 46C is a difference image before and after a displacement of the magnetic domain observed from the magnetooptical microscope image of the magnetic material in the case of the external magnetic field Hex=560 (Oe), when applying the threshold force f=1.24 mN, in the magnetic material applied to the stress sensor according to the embodiment.

FIG. 46D is a difference image before and after a displacement of the magnetic domain observed from the magnetooptical microscope image of the magnetic material in the case of the external magnetic field Hex=560 (Oe), when applying the threshold force f=2.49 mN, in the magnetic material applied to the stress sensor according to the embodiment.

FIG. 46E is a difference image before and after a displacement of the magnetic domain observed from the magnetooptical microscope image of the magnetic material in the case of the external magnetic field Hex=560 (Oe), when applying the threshold force f=3.75 mN, in the magnetic material applied to the stress sensor according to the embodiment.

FIG. 46F is a difference image before and after a displacement of the magnetic domain observed from the magnetooptical microscope image of the magnetic material in the case of the external magnetic field Hex=560 (Oe), when applying the threshold force f=2.22 mN, in the magnetic material applied to the stress sensor according to the embodiment.

FIG. 46G is a difference image before and after a displacement of the magnetic domain observed from the magnetooptical microscope image of the magnetic material in the case of the external magnetic field Hex=560 (Oe), when applying the threshold force f=1.40 mN, in the magnetic material applied to the stress sensor according to the embodiment.

FIG. 46H is a difference image before and after a displacement of the magnetic domain observed from the magnetooptical microscope image of the magnetic material in the case of the external magnetic field Hex=560 (Oe), when applying the threshold force f=0.00 mN, in the magnetic material applied to the stress sensor according to the embodiment.

FIG. 46I is a difference image before and after a displacement of the magnetic domain observed from the magnetooptical microscope image of the magnetic material in the case of the external magnetic field Hex=560 (Oe), after the tungsten needle is released therefrom, in the magnetic material applied to the stress sensor according to the embodiment.

FIG. 47A shows annealing temperature dependency (diagram corresponding to FIG. 16) of between the saturation magnetic field Hs and a saturation magnetic field ratio (the quotient of the saturation magnetic field Hₛ, ⊥ in an out-of-plane direction divided by the saturation magnetic field Hₛ, ∥ in an in-plane direction), in the magnetic material applied to the stress sensor according to the embodiment.

FIG. 47B shows annealing temperature dependency between the external magnetic field Hex (Oe) and the threshold force f (mN), showing an aspect that a threshold load of the magnetic domain motion is reduced by increasing the annealing temperature (reduction of magnetic anisotropy), in the magnetic material applied to the stress sensor according to the embodiment.

FIG. 48A is a diagram explaining magnet disposition in a local magnetic field generating apparatus, showing a configuration example that the magnet is disposed on a supporting base so as to surround the magnetic material.

FIG. 48B is a diagram explaining the magnet disposition in the local magnetic field generating apparatus, showing a configuration example that the magnet is disposed on the magnetic material.

FIG. 49 is a schematic diagram showing a relationship between a magnetic sensor output and a local stress (or stress-induced anisotropic magnetic field), in the stress sensor according to the embodiment configured to using a Hall element as the magnetic sensor.

FIG. 50A is a schematic diagram showing the magnetic sensor corresponding to the point A shown in FIG. 49, for explaining an aspect that an area of the magnetic bubble which occupies directly under an effective region of the magnetic sensor gradually increases by increasing the stress.

FIG. 50B is a schematic diagram showing a magnetic bubble BB1 corresponding to the point B shown in FIG. 49.

FIG. 50C is a schematic diagram showing a magnetic bubble BB2 corresponding to the point C shown in FIG. 49.

FIG. 50D is a schematic diagram showing a magnetic bubble BB3 corresponding to the point D shown in FIG. 49.

FIG. 51 is a schematic planar pattern configuration diagram showing a Hall element applicable to the magnetic sensor of the stress sensor according to the embodiment.

FIG. 52 is a schematic bird's-eye view configuration diagram showing the Hall element applicable to the magnetic sensor of the stress sensor according to the embodiment.

FIG. 53 shows a surface optical micrograph of one element portion of the Hall element applicable to the magnetic sensor of the stress sensor according to the embodiment.

FIG. 54 is a schematic cross-sectional structure diagram taken in the line of FIG. 53, showing the Hall element applicable to the magnetic sensor of the stress sensor according to the embodiment.

FIG. 55 is a scanning electron microscope (SEM) photograph of a surface of the center portion of hole crossbar of the Hall element and an explanatory diagram of the center portion of hole crossbar applicable to the magnetic sensor of the stress sensor according to the embodiment.

FIG. 56 is an explanatory diagram of a Hall probe operation droved by an applied magnetic field B, in the magnetic sensor to which the Hall element is applied, showing a relationship between an output hall voltage V_{H} (μV) and an output magnetic field B_{O}, and the applied magnetic field B.

FIG. 57A is a diagram showing an example of a bubble domain DM (−) of the garnet magnetic material existing directly under the center portion of hole crossbar, in the magnetic sensor to which the Hall element is applied.

FIG. 57B is a diagram showing an example of a bubble domain DM (+) of the garnet magnetic material existing directly under the center portion of hole crossbar, in the magnetic sensor to which the Hall element is applied.

FIG. 58A is a diagram showing an example of sizes of each portion of a magnetic recording medium (domain width d, and thickness t of the magnetic recording medium), in the magnetic sensor to which the Hall element is applied.

FIG. 58B shows a characteristic example showing a relationship between a vertical magnetic flux density B_{Z} (mT) and the height Z of the magnetic field emitted from the magnetic recording medium using the domain width d as a parameter, in the magnetic sensor to which the Hall element is applied.

FIG. 59A is a schematic cross-sectional structure diagram which shows forming an insulating layer after forming an alignment electrode layer on the magnetic recording medium, in an explanatory diagram of a fabrication method for the magnetic sensor to which the Hall element is applied.

FIG. 59B is a schematic cross-sectional structure diagram which shows pattern-forming a bismuth (Bi) electrode layer on the insulating layer, in the explanatory diagram of the fabrication method for the magnetic sensor to which the Hall element is applied.

FIG. 59C is a schematic cross-sectional structure diagram which shows forming a passivation film on the entire surface after pattern-forming a pad electrode in contact with the Bi electrode layer, in the explanatory diagram of the fabrication method for the magnetic sensor to which the Hall element is applied.

FIG. 59D is a schematic cross-sectional structure diagram which shows forming a contact hole into the pad electrode, in the explanatory diagram of the fabrication method for the magnetic sensor to which the Hall element is applied.

### DESCRIPTION OF EMBODIMENTS

Next, a certain embodiment will be described with reference to drawings. In the description of the following drawings, the identical or similar reference numeral is attached to the identical or similar part. However, it should be noted that the drawings are schematic and the relation between thickness and the plane size and the ratio of the thickness of each component part differs from an actual thing. Therefore, detailed thickness and size should be determined in consideration of the following explanation.

Of course, the part from which the relation and ratio of a mutual size differ also in mutually drawings is included. Moreover, the embodiment described hereinafter merely exemplifies the device and method for materializing the technical idea; and the embodiment does not specify the material, shape, structure, placement, etc. of each component part as the following. The embodiment may be changed without departing from the spirit or scope of claims.

The stress sensor according to the embodiment includes a local stress detecting apparatus and a stress distribution detecting apparatus.

The local stress detecting apparatus can detect a local stress by generating a magnetic domain by applying the local stress to the magnetic material. Moreover, the stress distribution detecting apparatus can detect stress distribution by detecting magnetic field distribution with a plurality of magnetic field detecting elements (magnetic sensors), by displacing the magnetic domain by applying stress to the magnetic material.

The stress sensor according to the embodiment can detect the local stress with a convenience structure made by combining the magnetic material and the magnetic sensor. The magnetic domain width is dependent on the magnetic materials, and therefore a spatial resolution of the local magnetic field can easily be highly improved by selection of the magnetic materials.

### (Generation of Local Magnetic Field)

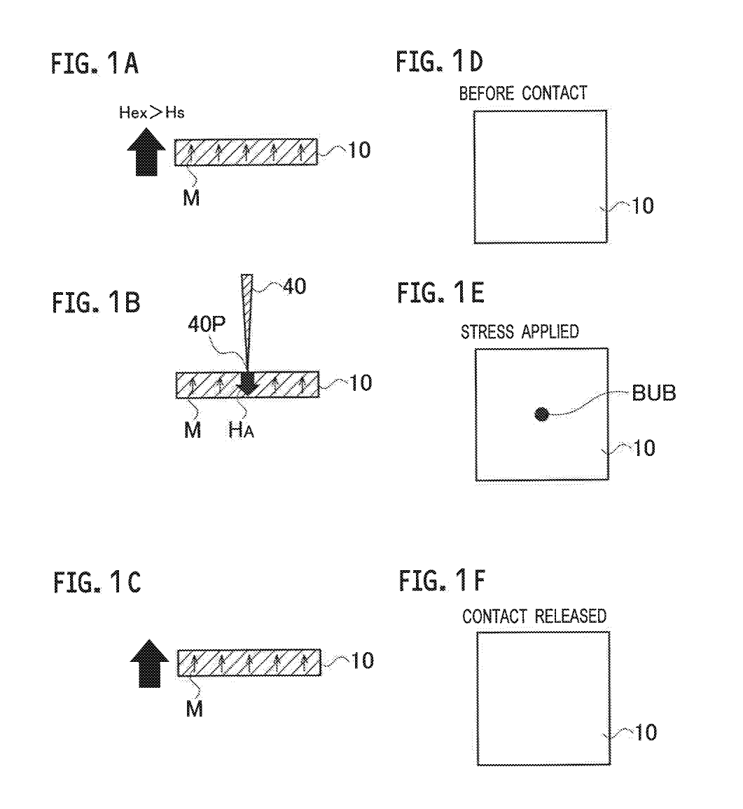

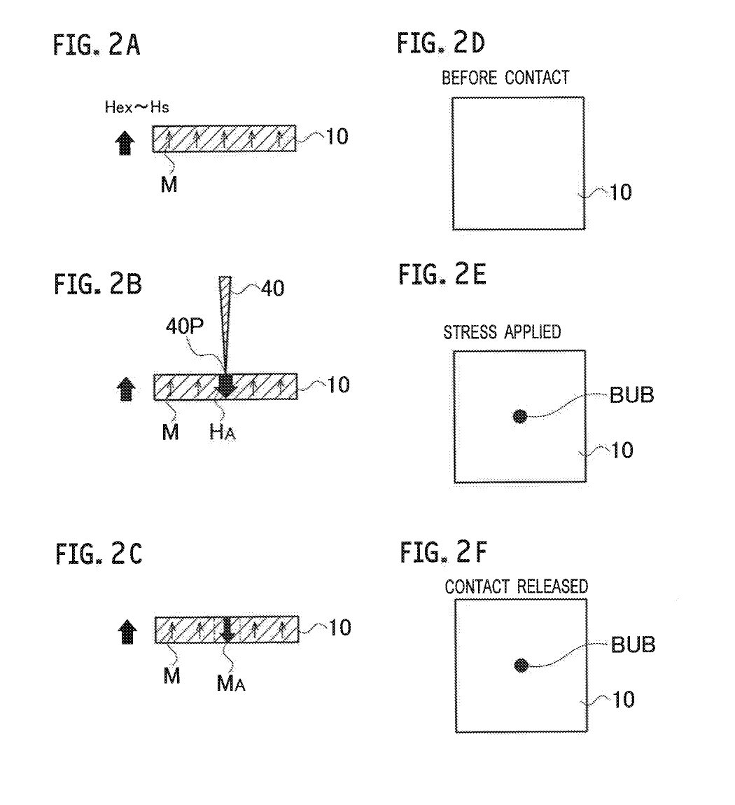

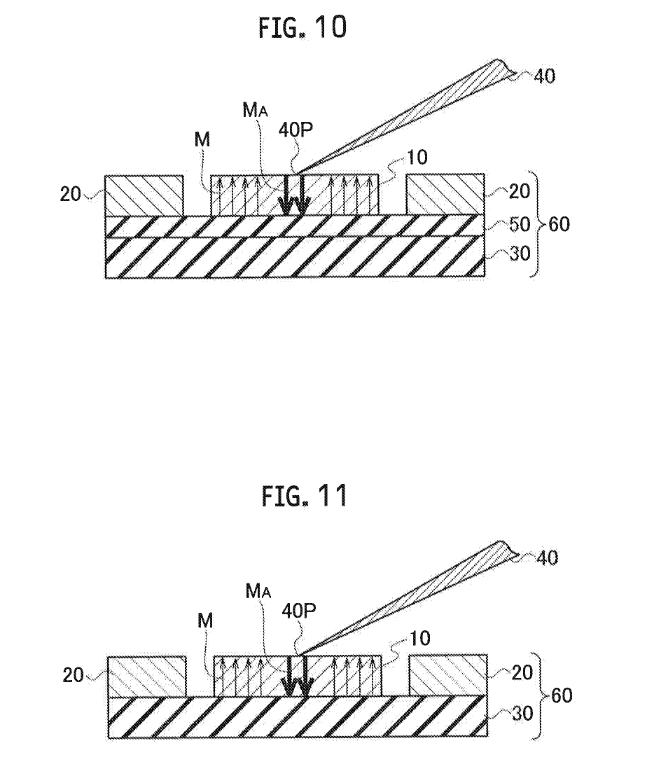

In an operational principle of a stress sensor according to the embodiment, FIG. 1A shows a schematic cross-sectional structure of a magnetic material 10 having magnetization M to which an external magnetic field Hex higher than a saturation magnetic field Hs is applied. Moreover, FIG. 2B shows a schematic cross-sectional structure of the magnetic material 10 in which the stress-induced anisotropic magnetic field H_{A} is generated, and the magnetic bubble BUB is generated by applying the local stress to the magnetic material with the tungsten needle 40. Moreover, FIG. 10 shows a schematic cross-sectional structure of the magnetic material 10 in a (volatility) state where a magnetizing direction due to the stress-induced anisotropic magnetic field H_{A} is not stored after the tungsten needle 40 is released. Furthermore, FIG. 1D is a schematic diagram of a surface state of the magnetic material 10 corresponding to FIG. 1A, FIG. 1E is a schematic diagram of a surface state of the magnetic material 10 corresponding to FIG. 1B, and FIG. 1F is a schematic diagram of a surface state of the magnetic material 10 corresponding to FIG. 10.

Moreover, in the operational principle of the stress sensor according to the embodiment, FIG. 2A shows a schematic cross-sectional structure of the magnetic material 10 having magnetization M to which the external magnetic field Hex of the same degree as the saturation magnetic field Hs is applied. Moreover, FIG. 2B shows a schematic cross-sectional structure of the magnetic material 10 in which the stress-induced anisotropic magnetic field H_{A} is generated, and the magnetic bubble BUB is generated by applying the local stress to the magnetic material 10 with the tungsten needle 40. Moreover, FIG. 2C shows a schematic cross-sectional structure of the magnetic material 10 in a (nonvolatile) state where the magnetizing direction which is reversed due to the stress-induced anisotropic magnetic field H_{A} is stored after the tungsten needle 40 is released. Furthermore, FIG. 2D is a schematic diagram of a surface state of the magnetic material 10 corresponding to FIG. 2A, FIG. 2E is a schematic diagram of a surface state of the magnetic material 10 corresponding to FIG. 2B, and FIG. 2F is a schematic diagram of a surface state of the magnetic material 10 corresponding to FIG. 2C.

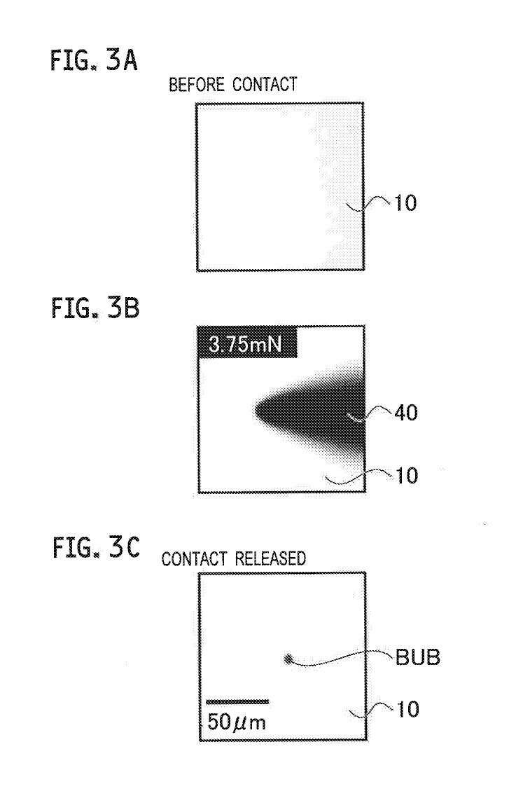

In an experimental example of the stress sensor according to the embodiment, FIG. 3A is a surface view observed from a magnetooptical microscope image of the magnetic material 10 in which the magnetization M is generated by applying the external magnetic field Hex which is equal to the saturation magnetic field Hs thereon (before the tungsten needle 40 is contacted). Moreover, FIG. 3B shows a surface view observed from a magnetooptical microscope image of the magnetic material 10 in which the stress-induced anisotropic magnetic field H_{A} is generated, and the magnetic bubble BUB is generated by applying the local stress to the magnetic material 10 with the tungsten needle 40. Moreover, FIG. 3C shows a surface view observed from a magnetooptical microscope image of the magnetic material 10 in a (nonvolatile) state where the magnetizing (M_{A}) direction which is reversed due to the stress-induced anisotropic magnetic field H_{A} is stored after the tungsten needle 40 is released.

In the stress sensor according to the embodiment, the local stress is applied to the magnetic material 10, then the stress-induced anisotropic magnetic field H_{A} is generated, and thereby the magnetic bubble BUB is generated.

In the stress sensor according to the embodiment, if the applied external magnetic field Hex is set up so as to be larger than the saturation magnetic field Hs, there can be achieved a volatile function in which the magnetizing direction is not stored therein after applying the stress, i.e., the local magnetic field can be turned on and off by turning on and off the stress. On the other hand, if the applied external magnetic field Hex is set up to the same degree as the saturation magnetic field Hs, the magnetizing direction is stored therein after applying the stress. Thus, there can be achieved a nonvolatile function in which the local magnetic field can be turned on by turning on the stress. Accordingly, the function can be changed with the external magnetic field Hex. Moreover, the diameter of the magnetic bubble, i.e., a spatial resolution of the local magnetic field, can be changed by selection of the materials of the magnetic material 10.

### (Detection of Local Stress)

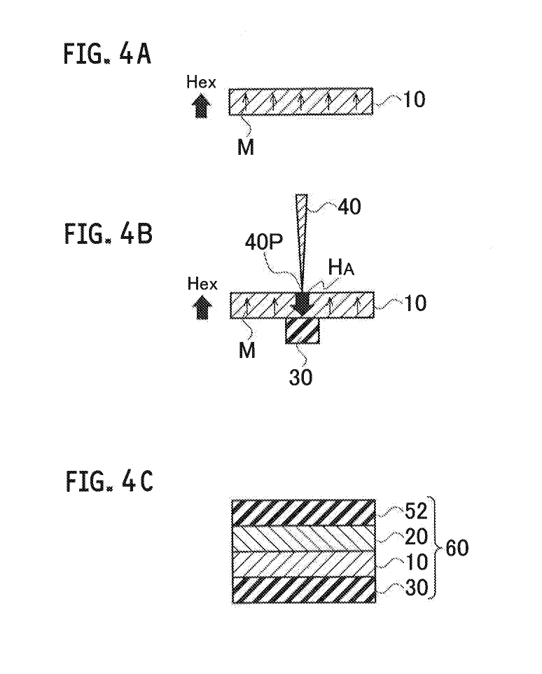

In an explanatory diagram of the local stress detected by the stress sensor according to the embodiment, FIG. 4A shows a schematic cross-sectional structure of the magnetic material 10 having the magnetization M on which the external magnetic field Hex is applied. FIG. 4B shows a schematic cross-sectional structure of a configuration of the magnetic material 30 in which the stress-induced anisotropic magnetic field H_{A} is generated by applying the local stress to the magnetic material 10 with the tungsten needle 40 in a state of applying the external magnetic field Hex thereon and magnetization is saturated, and a magnetic sensor 30 disposed at a back surface side of the magnetic material 10 opposite to the contact surface (stress applied portion 402) contacted by the tungsten needle 40. FIG. 4C is a schematic cross-sectional structure of the stress sensor 60 on which a magnet (magnetic substance thin film) 20 and a protective film 52 are formed at a front surface side of the magnetic material 10, and a magnetic sensor 30 is disposed at a back surface side of the magnetic material 10. In addition, the magnetic material 10 and the magnet (magnetic substance thin film) 20 may be insulated from each other by intervening an insulating layer therebetween.

According to the stress sensor according to the embodiment, as shown in FIGS. 4A to 4C, the magnetic bubbles are generated, by applying the local stress to the magnetic material 10, and thereby the magnetic sensor 30 can detect the local magnetic field.

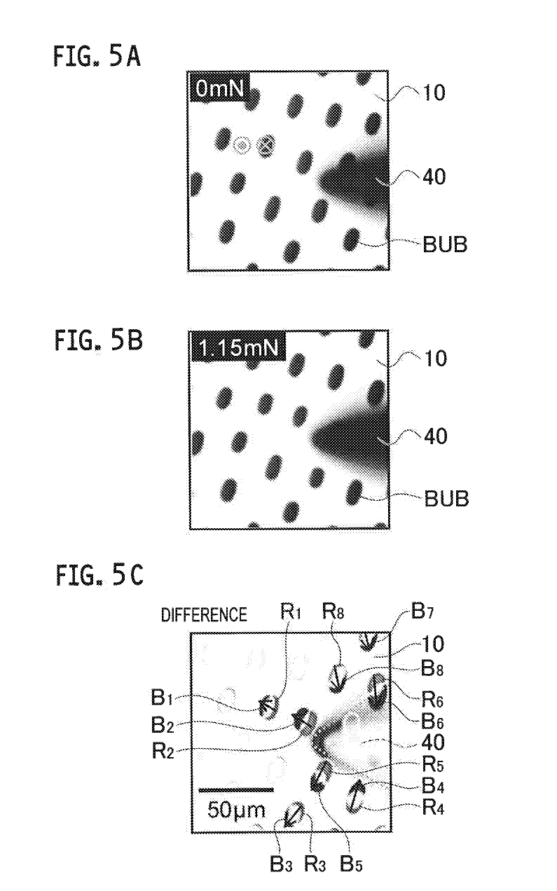

In an experimental example of the stress sensor according to the embodiment, FIG. 5A is a surface view (before the tungsten needle 40 is contacted) observed from a magnetooptical microscope image of the magnetic material 10 in which the magnetic bubbles BUS are generated by applying a magnetic field for generating magnetic bubble as the external magnetic field Hex thereon. Moreover, FIG. 5B is a surface view observed from the magnetooptical microscope image of the magnetic material 10 in a state where the local stress (1.15 mN) is applied to the magnetic material 10 with the tungsten needle 40 (1.15 mN). Moreover, FIG. 5C shows a difference image between FIG. 5A and FIG. 5B. Accordingly, displacement of the magnetic bubbles BUB: R1→B1, R2→B2, R3→B3, R4→B4, R5→B5, R6→B6, R7→B7, and R8→B8 are observed by applying the local stress (1.15 mN) to the magnetic material 10.

In the stress sensor according to the embodiment, as shown in FIGS. 5A to 5C, when the magnetic field for generating magnetic bubble is applied, displacement of the magnetic bubbles due to the stress distribution are generated, by applying the local stress to the magnetic material 10, and thereby the stress distribution can also be detected by a plurality of the magnetic sensors 30.

### (Configuration of Stress Sensor)

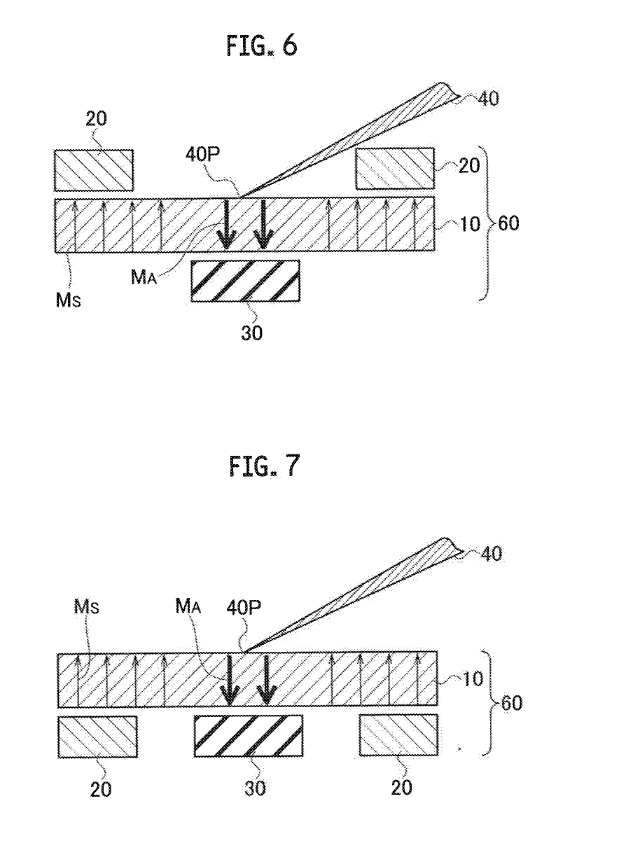

As shown in FIG. 6, the stress sensor according to the embodiment 60 includes: a magnetic material 10; a stress applied portion 40P on the magnetic material 10; a magnet 20 disposed so as to be adjacent to the magnetic material 10; and a magnetic sensor 30 disposed via the magnetic material 10 so as to be opposed to the stress applied portion 40P, wherein the magnetic sensor 30 detects a magnetic flux emitted from a magnetic domain generated in the magnetic material by a local stress applied to the stress applied portion 40P. In the stress sensor according to the embodiment 60, as an example, the tungsten needle 40 is used for applying the local stress to the stress applied portion 40P in order to quantify the local stress, but, it is not limited to the tungsten needle 40 as a method of applying the local stress. In addition, it has been confirmed that the magnetic domain can be operated also by using a wooden toothpick, as other needlelike configurations, for example. Accordingly, this phenomenon can be used also for stress sensors used for not only the local stress sensor for very micro regions but also human interface purposes.

In the stress sensor according to the embodiment 60, the magnet 20 and the magnetic sensor 30 respectively are disposed on the opposite to surfaces (i.e., the front side surface and the back side surface) of the magnetic material 10, as shown in FIG. 6.

In the stress sensor according to the embodiment 60, the saturation magnetic field is applied to the magnetic material 10 due to the magnet 20, and the external magnetic field Hex due to the magnet 20 and the stress-induced anisotropic magnetic field H_{A} in the reverse direction are applied thereto with the local stress. Accordingly, the single magnetic bubble BUB is generated in the magnetic material 10, and then the magnetic flux emitted from the magnetic bubble BUB is detected by the magnetic sensor 30, and thereby the local stress can be detected.

Moreover, in the configuration shown in FIG. 6, physical damage to the magnetic sensor 30 is avoidable by disposing the magnetic sensor 30 so as to be opposed to the stress applied portion 402 via the magnetic material 10.

### Modified Example 1

In the stress sensor 60 according to a modified example 1 of the embodiment, both of the magnet 20 and the magnetic sensor 30 are disposed on one surface (e.g., back side surface) of the magnetic material 10, as shown in FIG. 7. Other configurations are the same as those of the embodiment.

### Modified Example 2

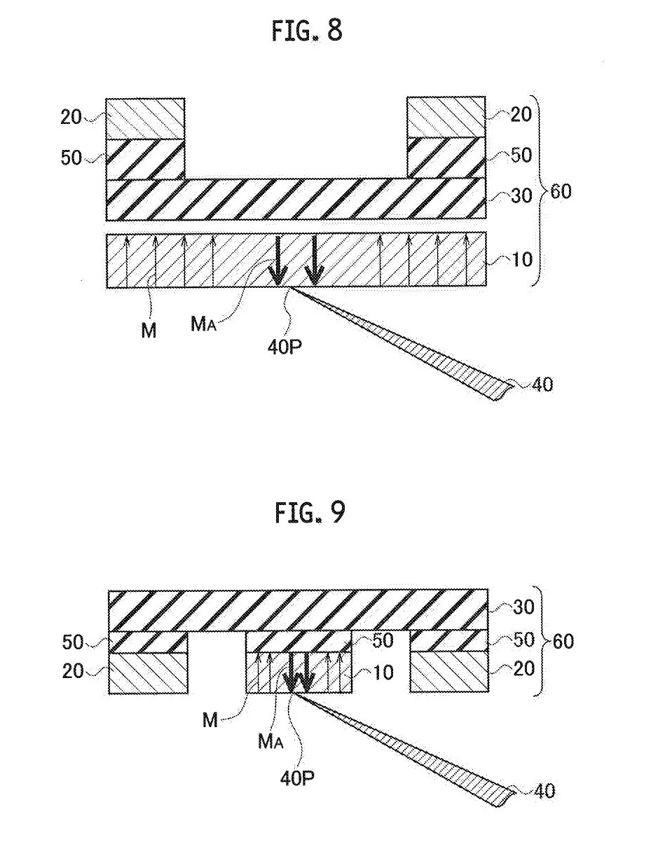

As shown in FIG. 8, a stress sensor 60 according to a modified example 2 of the embodiment includes: a magnetic material 10; a stress applied portion 40P on the magnetic material 10; a magnetic sensor 30 disposed via the magnetic material 10 so as to be opposed to the stress applied portion 40P; an insulating layer 50 disposed on the magnetic sensor 30; and a magnet 20 disposed on the insulating layer 50.

In the stress sensor 60 according to the modified example 2 of the embodiment, both of the magnet 20 and the magnetic sensor 30 are disposed on one surface (e.g., front side surface) side of the magnetic material 10, as shown in FIG. 8. The magnet 20 may be formed of a magnetic substance thin film etc. Other configurations are the same as those of the embodiment.

### Modified Example 3

As shown in FIG. 9, a stress sensor 60 according to a modified example 3 of the embodiment includes: a magnetic material 10; a stress applied portion 40P on the magnetic material 10; a magnetic sensor 30 disposed via the magnetic material 10 so as to be opposed to the stress applied portion 40P; an insulating layer 50 disposed on the magnetic sensor 30; and a magnet 20 disposed on the insulating layer 50.

In the stress sensor 60 according to the modified example 3 of the embodiment, as shown in FIG. 9, the magnet 20 and the magnetic material 10 respectively are disposed via the pattern-formed insulating layers 50 on one surface (e.g., back side surface) of the magnetic sensor 30. The magnet 20 may be formed of a magnetic substance thin film etc. The magnetic material 10, the magnet 20, and the magnetic sensor 30 are integrated into one another by forming the magnet 20 with the magnetic substance thin film etc., and therefore it is preferred in view of applicability of device. Other configurations are the same as those of the embodiment.

### Modified Example 4

As shown in FIG. 10, a stress sensor 60 according to a modified example 4 of the embodiment includes: a magnetic material 10; a stress applied portion 40P on the magnetic material 10; a magnetic sensor 30 disposed via the magnetic material 10 so as to be opposed to the stress applied portion 40P; an insulating layer 50 disposed on the magnetic sensor 30; and a magnet 20 disposed on the insulating layer 50.

In the stress sensor 60 according to the modified example 4 of the embodiment, both of the magnet 20 and the magnetic material 10 are disposed on the insulating layer 50 formed on one surface (e.g., front side surface) of the magnetic sensor 30, as shown in FIG. 10. The magnet 20 may be formed of a magnetic substance thin film etc. The magnetic material 10, the magnet 20, and the magnetic sensor 30 are integrated into one another by forming the magnet 20 with the magnetic substance thin film etc., and therefore it is preferred in view of applicability of device. Other configurations are the same as those of the embodiment.

### Modified Example 5

As shown in FIG. 11, a stress sensor 60 according to a modified example 5 of the embodiment includes: a magnetic material 10; a stress applied portion 40P on the magnetic material 10; a magnetic sensor 30 disposed via the magnetic material 10 so as to be opposed to the stress applied portion 40P; and a magnet 20 disposed on the magnetic sensor 30.

In the stress sensor 60 according to the modified example 5 of the embodiment, both of the magnet 20 and the magnetic material 10 are disposed on one surface (e.g., front side surface) of the magnetic sensor 30, as shown in FIG. 11. The magnet 20 may be formed of a magnetic substance thin film etc. The magnetic material 10, the magnet 20, and the magnetic sensor 30 are integrated into one another by forming the magnet 20 with the magnetic substance thin film etc., and therefore it is preferred in view of applicability of device. Other configurations are the same as those of the embodiment.

### Modified Example 6

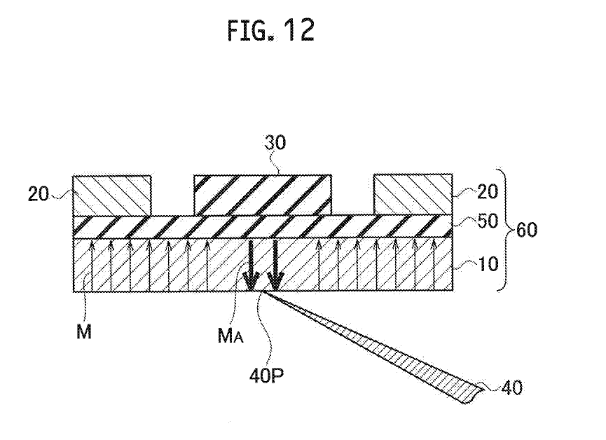

As shown in FIG. 12, a stress sensor 60 according to a modified example 6 of the embodiment includes: a magnetic material 10; a stress applied portion 402 on the magnetic material 10; a magnetic sensor 30 disposed via the magnetic material 10 so as to be opposed to the stress applied portion 402; and a magnet 20 disposed on the magnetic material 10 so as to surround the magnetic sensor 30.

In the stress sensor 60 according to the modified example 6 of the embodiment, both of the magnet 20 and the magnetic sensor 30 are disposed on one surface (e.g., front side surface) of the magnetic material 10, as shown in FIG. 12 via the insulating layer 50. The magnet 20 may be formed of a magnetic substance thin film etc. Other configurations are the same as those of the embodiment.

### Modified Example 7

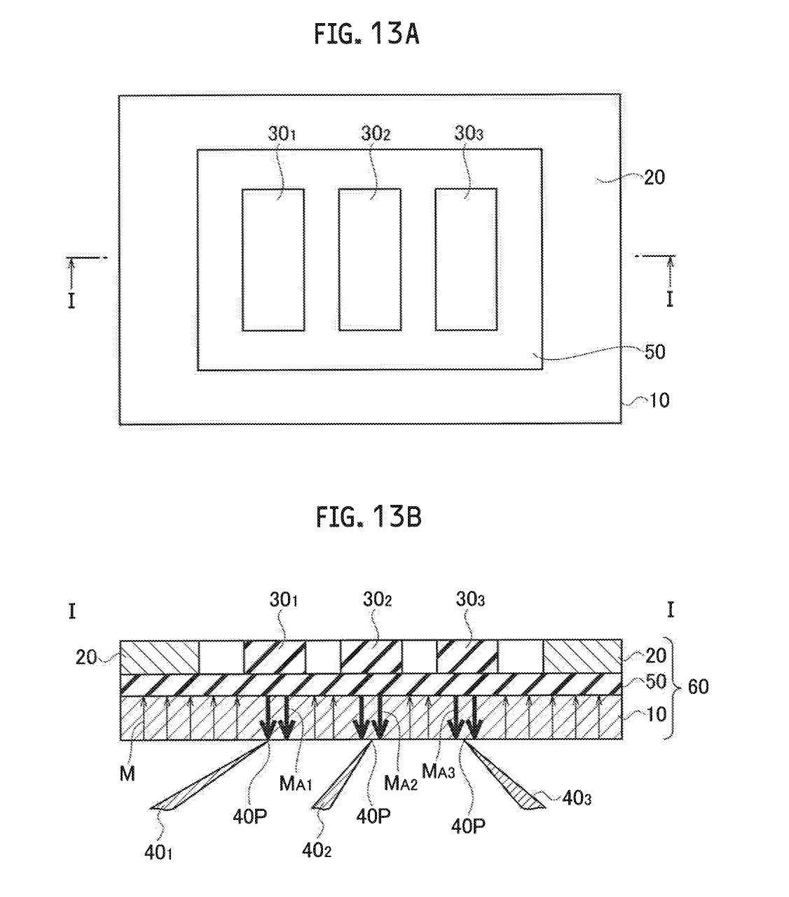

FIG. 13A shows a schematic planar pattern configuration of a stress sensor 60 according to a modified example 7 of the embodiment, and FIG. 13B shows a schematic cross-sectional structure taken in the line I-I of FIG. 13A.

As shown in FIGS. 13A and 13B, a stress sensor 60 according to a modified example 7 of the embodiment includes: a magnetic material 10; a plurality of stress applied portions 402 on the magnetic material 10;

a magnet 20 disposed so as to be adjacent to the magnetic material 10; and a plurality of magnetic sensors 30₁, 30₂, 30₃ disposed via the magnetic material 10 so as to be opposed to the plurality of the stress applied portions 40P, wherein a magnetic flux emitted from a magnetic domain is detected by the plurality of the magnetic sensors 30₁, 30₂, 30₃, and thereby displacement of the magnetic domain due to stress distribution is detected.

In the stress sensor 60 according to the modified example 7 of the embodiment, both of the magnet 20 and the plurality of the magnetic sensors 30₁, 30₂, 30₃ are disposed on one surface (e.g., front side surface) of the magnetic material 10, as shown in FIG. 13B via the insulating layer 50. The magnet 20 may be formed of a magnetic substance thin film etc.

In the stress sensor 60 according to the modified example 7 of the embodiment, a magnetic field for generating magnetic bubble is applied to the magnetic material 10 by the magnet 20, and a stress-induced anisotropic magnetic field H_{A} is applied due to the stress distribution. Thus, displacement of the magnetic bubble is generated and then the magnetic flux emitted from the magnetic bubble is detected by the magnetic sensors 30₁, 30₂, 30₃, and thereby the stress distribution can be detected.

Moreover, in the configuration shown in FIG. 13, physical damage to the magnetic sensors 30₁, 30₂, 30₃ is avoidable by disposing the magnetic sensors 30₁, 30₂, 30₃ so as to be opposed to the stress applied portion 40P via the magnetic material 10.

### Modified Example 8

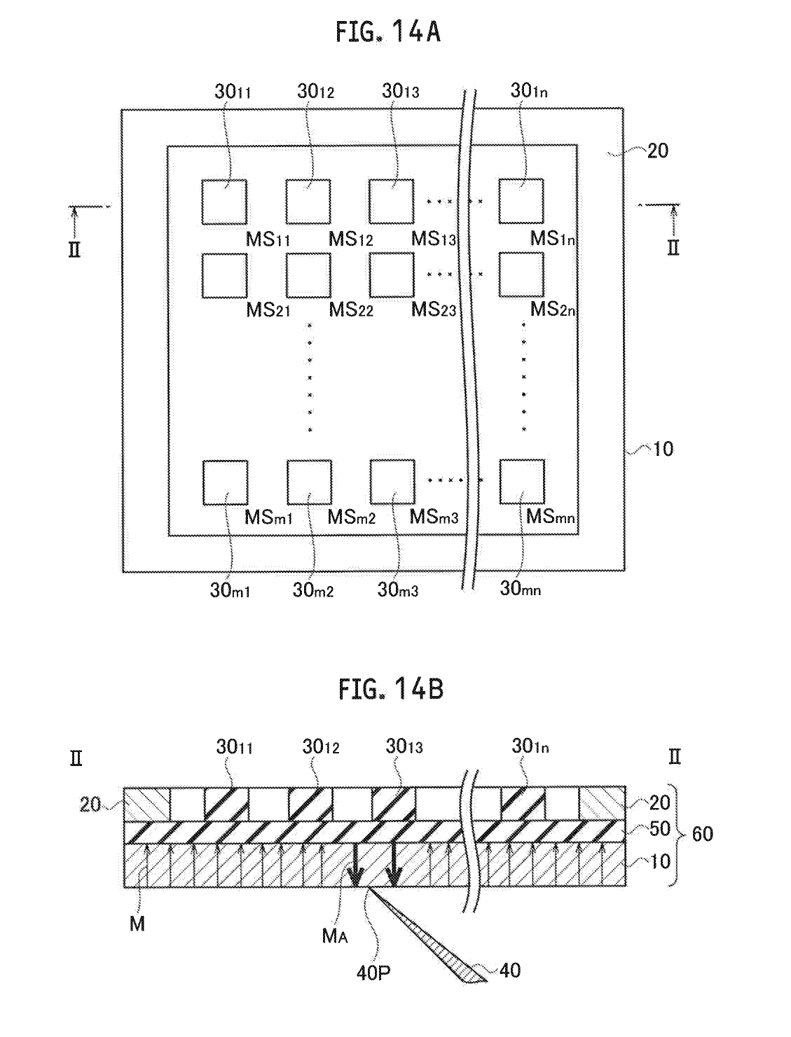

FIG. 14A shows a schematic planar pattern configuration of a stress sensor 60 according to a modified example 8 of the embodiment, and FIG. 14B shows a schematic cross-sectional structure taken in the line II-II of FIG. 14A.

As shown in FIGS. 14A and 11B, a stress sensor 60 according to a modified example 8 of the embodiment includes: a magnetic material 10; a stress applied portion 40P on the magnetic material 10; a magnet 20 disposed so as to be adjacent to the magnetic material 10; and a plurality of magnetic sensors 30₁, 30₂, 30₃, 30₁₁, 30₁₂, . . . , 30₁ₙ . . . , 30ₘ₁, 30ₘ₂, . . . , 30ₘₙ (MS₁₁, MS₁₂, . . . , MS₁ₙ, . . . , MSₘ₁, MSₘ₂ . . . , MSₘₙ) disposed via the magnetic material 10 so as to be opposed to the stress applied portion 40P, wherein a magnetic flux emitted from a magnetic domain is detected by the plurality of the magnetic sensors 30₁, 30₂, 30₃, 30₁₁, 30₁₂, . . . , 30₁ₙ . . . , 30ₘ₁, 30ₘ₂, 30ₘₙ, and thereby displacement of the magnetic domain due to stress distribution is detected.

In the stress sensor 60 according to the modified example 8 of the embodiment, both of the magnet 20 and the plurality of the magnetic sensors 30₁, 30₂, 30₃, 30₁₁, 30₁₂, . . . , 30₁ₙ . . . , 30ₘ₁, 30ₘ₂, . . . , 30ₘₙ (MS₁₁, MS₁₂, . . . , MS₁ₙ, . . . , MSₘ₁, MSₘ₂, . . . MSₘₙ) are disposed on one surface (e.g., front side surface) of the magnetic material 10, as shown in FIG. 14B via the insulating layer 50. The magnet 20 may be formed of a magnetic substance thin film etc.

In the stress sensor 60 according to the modified example 8 of the embodiment, a magnetic field for generating magnetic bubble is applied to the magnetic material 10 by the magnet 20, and a stress-induced anisotropic magnetic field HA is applied due to the stress distribution. Thus, displacement of the magnetic bubble is generated and then the magnetic flux emitted from the magnetic bubble is detected by the plurality of the magnetic sensors 30₁, 30₂, 30₃, 30₁₁, 30₁₂, . . . , 30₁ₙ . . . , 30ₘ₁, 30ₘ₂, . . . , 30ₘₙ, and thereby the stress distribution can be detected.

Moreover, in the configuration shown in FIG. 14, physical damage to the plurality of the magnetic sensors 30₁, 30₂, 30₃, 30₁₁, 30₁₂, . . . , 30₁ₙ . . . , 30ₘ₁, 30ₘ₂, . . . , 30ₘₙ is avoidable by disposing the plurality of the magnetic sensors 30₁, 30₂, 30₃, 30₁₁, 30₁₂, . . . , 30₁ₙ . . . , 30ₘ₁, 30ₘ₂, . . . , 30ₘₙ so as to be opposed to the stress applied portion 40P via the magnetic material 10.

In the stress sensor 60 according to the modified example 8 of the embodiment, a stress in arbitrary positions can be detected by disposing the plurality of the magnetic sensors.

In the stress sensor 60 according to the modified example 8 of the embodiment, the magnetic sensors 30₁, 30₂, 30₃, 30₁₁, 30₁₂, . . . , 30₁ₙ . . . , 30ₘ₁, 30ₘ₂, . . . , 30ₘₙ can be formed of a Hall element. Such a Hall element may be disposed so as to be contacted on the magnetic material 10.

Although the magnetic flux emitted from the magnetic domain is decreased in accordance with distance, it can reduce attenuation of the magnetic flux to the minimum extent by disposing such a Hall element so as to be contacted on the magnetic material 10, and thereby the magnetic flux can be efficiently detected. Accordingly, the magnetic sensor can be integrated with the stress sensor, and therefore it is preferred in the light of applicability of devices.

Moreover, the materials of the Hall element may be formed with bismuth (Bi). Bi has the maximum Hall coefficient in typical metals and can be fabricated by using vacuum evaporation etc., and thereby highly sensitive Hall elements can be fabricated not depending on underlying materials.

### (Driving of Magnetic Domain Due to Local Stress)

### (Selection of Magnetic Materials)

50-μm thick Bi-substituted garnet which is film-formed on an approximately 350-μm-thick (100) plane (CaGd)₃ (MgGaZr)₅O₁₂ substrate by using liquid phase epitaxy was used for the magnetic material 10. A saturation magnetization of the used magnetic material 10 is 343 G at a room temperature. The magnetic material 10 was subjected to an anneal process at 1000-1200 degrees C. for six hours in atmosphere.

If garnet is fabricated by using a liquid phase epitaxy, growth-induced magnetic anisotropy which is a phenomenon peculiar to the fabricating method appears. It has been known that the magnetic anisotropy will occur since ordering of a rare earth element spontaneously occurs during crystal growth by the growth-induced magnetic anisotropy, and thereby a vertical magnetization film can be obtained. Moreover, it has been known that such a growth-induced magnetic anisotropy can be reduced by an anneal process. Accordingly, the magnetic anisotropy of the magnetic material can be controlled by annealing temperature, and thereby a relationship between magnetic anisotropy and a stress response of the magnetic domain can be examined.

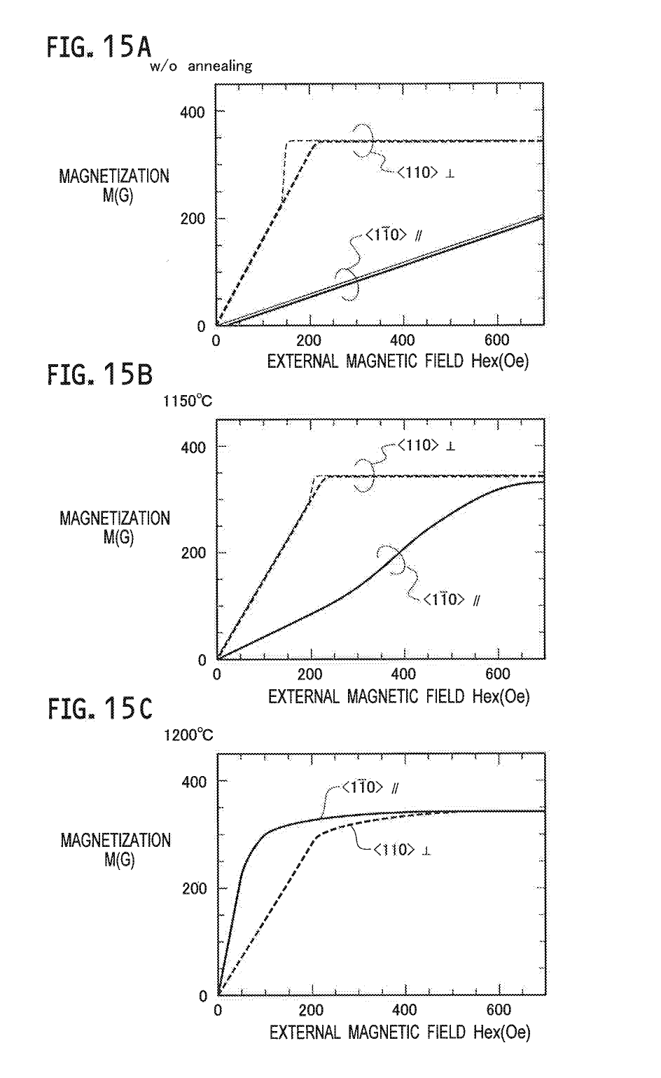

FIG. 15A shows a relationship (magnetizing curve) between the external magnetic field Hex of the magnetic material 10 applied to the stress sensor according to the embodiment, and the magnetization M [an example without an anneal process]; FIG. 15B shows an example of being annealed at 1150 degrees C.; and FIG. 15C shows an example of being annealed at 1200 degrees C.

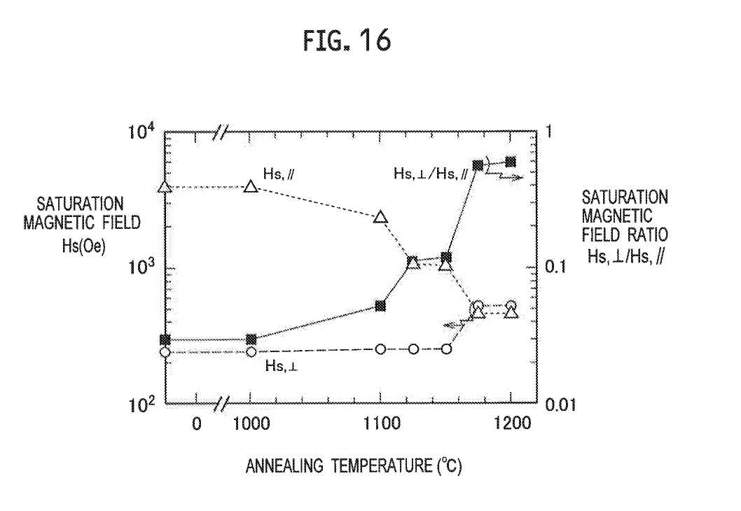

FIG. 16 shows annealing temperature dependency between the saturation magnetic field Hs and a saturation magnetic field ratio (the quotient of the saturation magnetic field Hₛ, ⊥ in an out-of-plane direction divided by the saturation magnetic field Hₛ, ∥ in an in-plane direction), in the magnetic material 10 applied to the stress sensor according to the embodiment. As shown in FIGS. 15A, 15B, and 16, it is proved that the saturation magnetic field Hₛ, ∥ in the in-plane direction with respect to the saturation magnetic field Hₛ, ⊥ in the out-of-plane direction, is increased as the annealing temperature becomes increased.

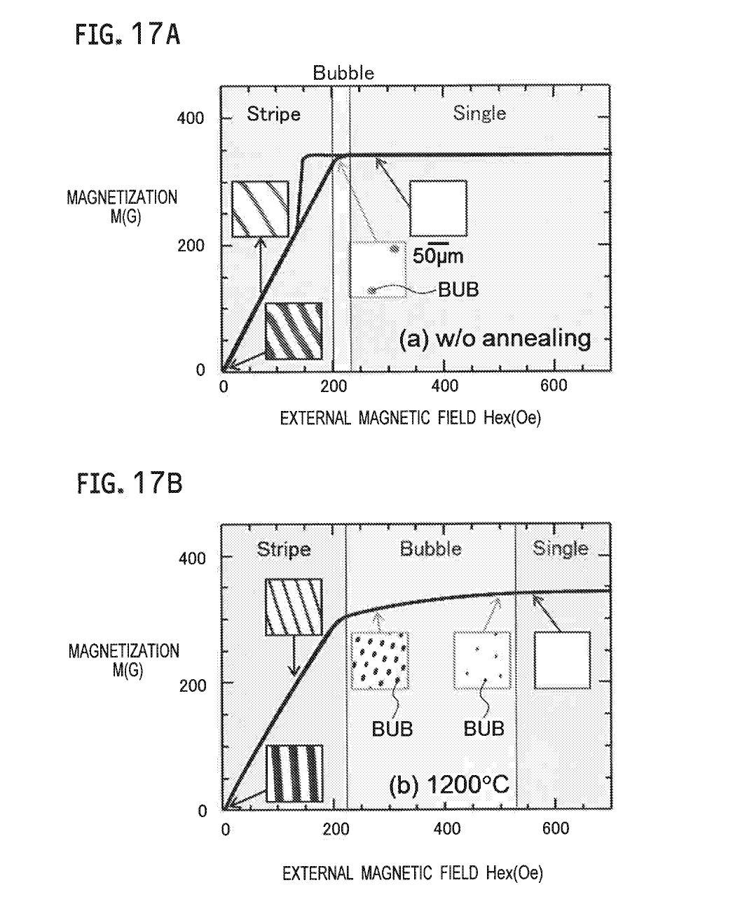

FIG. 17A shows the magnetic field dependency observed from a magnetooptical microscope image to be corresponded with the magnetizing curve (relationship between the external magnetic field Hex and the magnetization M), in the magnetic material 10 applied to the stress sensor according to the embodiment [an example before an anneal process]; and FIG. 17B shows an example of being annealed at 1200 degrees C. As shown in FIGS. 17A and 17B, it is proved that stability regions of the magnetic bubbles BUB are expanded as the magnetizing curve is changed due to the anneal process.

### (Measuring System of Magnetic Domain Motion Evaluation Due to Local Stress)

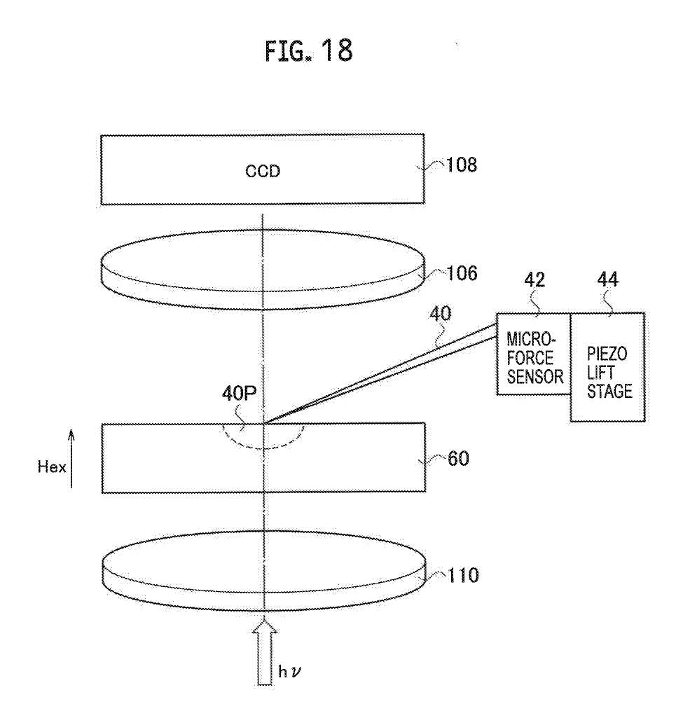

FIG. 18 shows a schematic configuration of a measuring system made by applying the Hall element 1 according to the embodiment, and combining an electromagnet 102 and a magnetooptical microscope capable of simultaneous measuring of Hall probe and imaging of magnetic domain motion.

In order to examine a magnetic domain motion phenomenon when applying the local stress, the local stress control system and the magnetooptical microscope measuring system as shown in FIG. 18 were constructed. The measuring system is composed of a halogen tungsten lamp light source (hν), a permanent magnet (not shown), a polarizer 110, a long-focus objective lens (CFI LU Plan EPI ELWD ₓ50, Nikon Instruments Inc.) (not shown), am analyzer 106, a charge coupled device (CCD) camera (C10600 ORCA-R², Hamamatsu Photonics K. K.) 108, and a local stress control system. The local stress control system includes: a tungsten needle 40; a micro-force sensor 42 connected to the tungsten needle 40; and a piezo lift stage 44 on which the tungsten needle 40 and the micro-force sensor 42 are mounted.

Linear polarization was entered into a sample (stress sensor 60) with Faraday configuration, and then CCD camera 108 detected the transmitted light from the sample through the analyzer 106. A magnetic field strength with the permanent magnet in the stage position of the same measuring system is calibrated by a commercially available GaAs Hall element. A contact load of the tungsten needle 40 (tip curvature radius is 5 μm/ESSTech Inc.) to the sample is controlled by using the micro-force sensor 42 and the piezo lift stage (load resolution 20 is μN/Nano Control Co., Ltd.), and at the same time, magnetooptical microscope images of the sample can be observed.

In the present experiment, the tungsten needle 40 was disposed so as to be inclined at a 45 degrees angle made 45 in a sample normal direction so that the image may not be covered by the tungsten needle 40. Although results of applying stresses using the tungsten needle 40 will now be shown hereafter, the aforementioned phenomenon was not caused by a magnetic interaction due to a magnetization of the needle, etc. since tungsten is a non-magnetic metal. Since the similar phenomenon occurred also when the stress is applied using a wooden toothpick, it was not caused by an electrostatic interaction due to electrification etc. Accordingly, the aforementioned phenomenon is a phenomenon which is purely caused by the stress.

### (Magnetic Bubble Domain Generated Due to Local Stress)

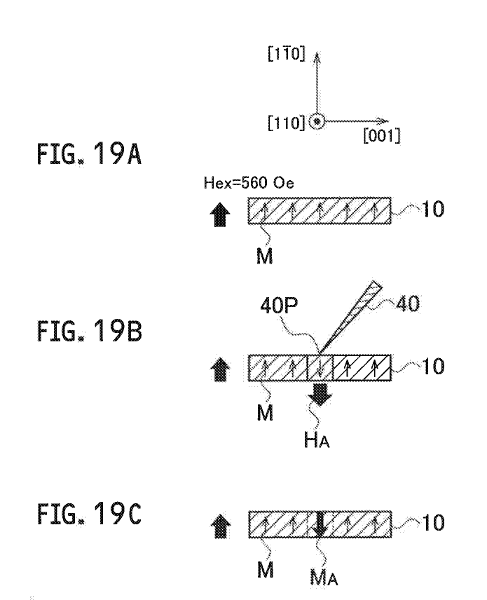

FIG. 19A shows a schematic cross-sectional structure (the magnetooptical microscope image corresponds to FIG. 3A) at the time when an annealing sample at an annealing temperature of 1200 degrees C. is applied to the saturation magnetic field (Hex=Hₛ=560 (Oe): the magnetooptical microscope image corresponding to FIG. 3 directing upward perpendicularly to the drawing sheet plane), in the magnetic material 10 applied to the stress sensor according to the embodiment. Moreover, FIG. 19B shows a schematic cross-sectional structure (magnetooptical microscope image corresponds to FIG. 3B) of the magnetooptical microscope image of the magnetic material 10 in which the stress-induced anisotropic magnetic field H_{A} is generated by applying the local stress to the magnetic material 10 with the tungsten needle 40. Moreover, FIG. 19C shows a schematic cross-sectional structure (magnetooptical microscope image corresponds to FIG. 3C) of the magnetic material 10 in a (nonvolatile) state where the magnetizing direction which is reversed due to the stress-induced anisotropic magnetic field H_{A} is stored after the tungsten needle 40 is released. As shown in FIGS. 19A to 19C, it is proved that it was in a single magnetic domain state before the tungsten needle 40 is contacted thereto, but the magnetic bubble domain is generated by applying the local stress. The aforementioned phenomenon can be explained as follows:

The local stress is generated by pushing the magnetic material 10 with the tungsten needle 40.

A compressive stress is applied in-plane direction of the magnetic material 10 of the stress sensor 60. With regard to a value of the quantitive stress, the stress and the direction can be calculabled with Hertzian contact theory or general Computer Aided Engineering (CAE) analysis.

The stress-induced anisotropic magnetic field H_{A} is generated in a perpendicular-to-plane direction of the magnetic material 10 in the stress sensor 60 (the magnetooptical microscope image corresponding to FIG. 3 directing downward perpendicularly to the drawing sheet plane).

In this case, the stress-induced anisotropic magnetic field HA is generally expressed with the following equation (1):

H_{A}∝−σλ (1)

where σ denotes an in-plane stress (positive: tensile stress, negative: compressive stress), and λ denotes magnetostrictive constant.

More specifically, the stress-induced anisotropic magnetic field HA is expressed with the following equation (2):

H_{A}=[2K₁−2σ(λ₁₀₀+λ₁₁₁)]/2M (2)

where K1 denotes cubic crystal anisotropy constant, (λ₁₀₀+λ₁₁₁) denotes magnetostrictive constant, and M denotes saturation magnetization. In the equation (2), the stress-induced anisotropic magnetic field H_{A} is negative since σ and (λ₁₀₀+λ₁₁₁) are negative. It was confirmed with the magnetostriction measurement that (λ₁₀₀+λ₁₁₁) was negative. Accordingly, the magnetic bubble domain is generated due to the negative stress-induced anisotropic magnetic field H_{A}.

Moreover, the above-mentioned phenomenon has a nonvolatile in that the magnetic bubble domain is generated at the time when the local stress is applied thereto, and the magnetic bubble domain is kept even if the tungsten needle 40 is released. Furthermore, there can also be realized a volatility in that the magnetic bubble domain can be generated only at the time when the local stress is applied thereto if the external magnetic field Hex is increased, and it will be returned to the saturation state if the tungsten needle 40 is released.

### (Cutting of Striped Magnetic Domain Due to Local Stress)

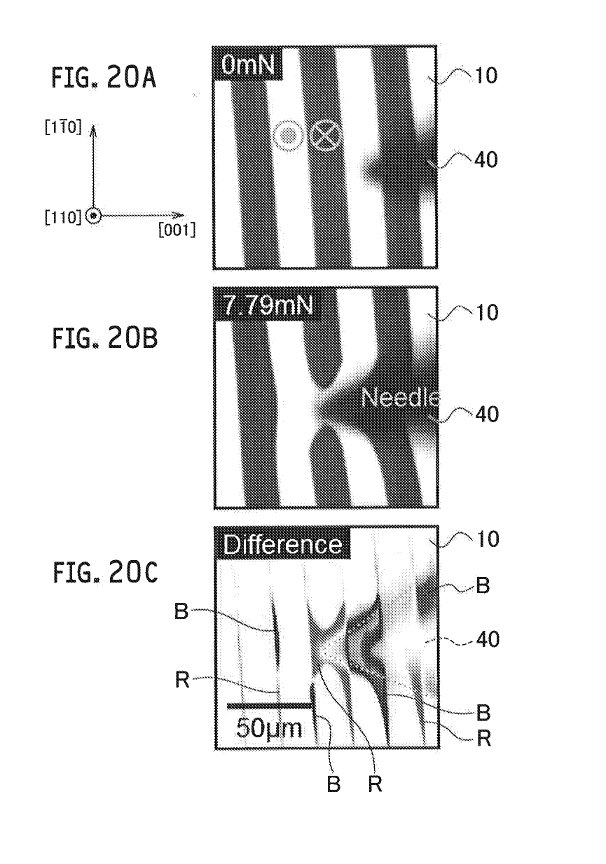

In experimental examples of the stress sensor according to the embodiment, FIG. 20A shows a magnetooptical microscope image of the magnetic material 10 in a state where the external magnetic field Hex is not applied thereto (Hex=0 (Oe)) of the annealing sample at annealing temperature of 1200 degrees C. (before the tungsten needle is contacted). Moreover, FIG. 20B shows a magnetooptical microscope image in a state where the local stress (7.79 mN) is applied to the magnetic material 10 with the tungsten needle 40, and FIG. 20C shows a difference image between FIG. 20A and FIG. 20B. In FIG. 20C, reference numeral B shows a portion of changing from the white ground (the magnetizing direction of the magnetic domain is directing upward perpendicularly to the drawing sheet plane) to the black ground (the magnetizing direction of the magnetic domain is directing downward perpendicularly to the drawing sheet plane). On the other hand, in FIG. 20C, reference numeral C shows a portion of changing from the black ground (the magnetizing direction of the magnetic domain is directing downward perpendicularly to the drawing sheet plane) to the while ground (the magnetizing direction of the magnetic domain is directing upward perpendicularly to the drawing sheet plane).

As shown in FIGS. 20A to 20C, it is proved that the striped magnetic domain is chopped by applying the local stress if the external magnetic field is not applied thereto. The aforementioned phenomenon can be explained as follows:

The local stress is generated by pushing the magnetic material 10 with the tungsten needle 40.

The compressive stress is applied in an in-plane direction of the magnetic material 10.

The stress-induced anisotropic magnetic field H_{A} is generated in a perpendicular-to-plane direction of the magnetic material 10 (the image is directing downward perpendicularly to the drawing sheet plane).

The striped magnetic domain of which the magnetizing direction is directing downward perpendicularly to the drawing sheet plane moves directly under the tungsten needle 40 at which the stress-induced anisotropic magnetic field H_{A} is generated.

The striped magnetic domains directing downward perpendicularly to the drawing sheet plane close to each other, and then the striped magnetic domain for minimizing the sum total of magnetostatic energy and domain wall energy is chopped.

### (Displacement of Magnetic Bubble Domain Due to Local Stress)

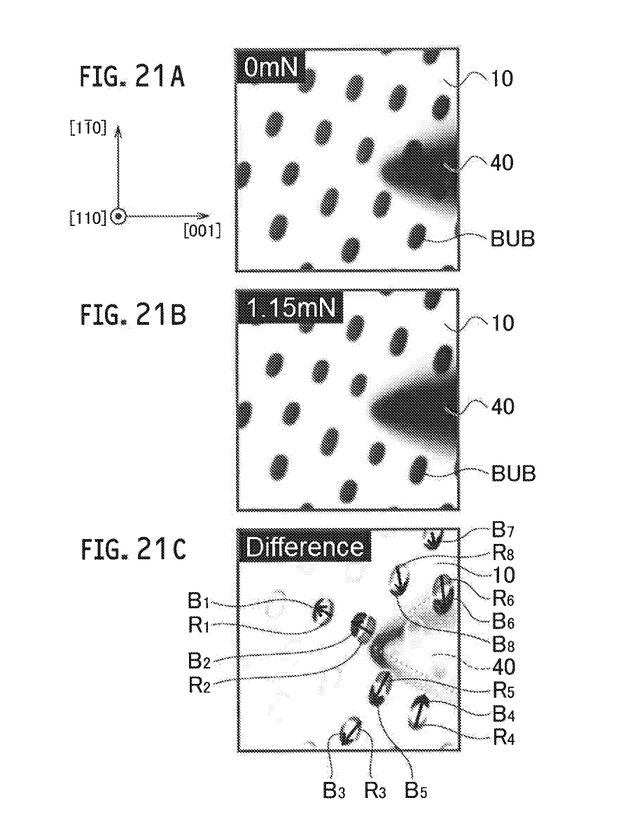

On the other hand, in the experimental examples of the stress sensor according to the embodiment, FIG. 21A shows a magnetooptical microscope image of the magnetic material 10 in which a magnetic bubble domain is generated by applying a magnetic field for generating magnetic bubble domain (Hex-280 (Oe)) as the external magnetic field Hex of the annealing sample at annealing temperature of 1200 degrees C. thereto (before the tungsten needle is contacted (corresponding to FIG. 5A)). Moreover, FIG. 21B shows a magnetooptical microscope image in a state where the local stress (1.15 mN) (corresponding to FIG. 5B) is applied to the magnetic material 10 with the tungsten needle 40, and FIG. 21C shows a difference image between FIG. 21A and FIG. 21B (corresponding to FIG. 5C). As explained in FIG. 5C, In FIG. 21C, reference numerals R, B denote displacement of the magnetic bubble BUB. Accordingly, displacement of the magnetic bubbles BUB: R1→B1, R2→B2, R3→B3, R4→B4, R5→B5, R6→B6, R7→B7, and R8→B8 are observed by applying the local stress (1.15 mN) to the magnetic material 10. By applying the magnetic field for generating magnetic bubble to the magnetic material 10, and applying the local stress thereto, the displacement of the magnetic bubble due to the stress distribution is generated, and thereby the stress distribution can also be detected by the plurality of the magnetic sensors 30.

As shown in FIG. 21A to 210, it is proved that the magnetic bubble domain is displaced by applying the local stress to the magnetic material 10. The aforementioned phenomenon can be explained as follows:

The local stress is generated by pushing the magnetic material 10 with the tungsten needle 40.

The compressive stress is applied in in-plane direction of the magnetic material 10.

The stress-induced anisotropic magnetic field H_{A} is generated in a perpendicular-to-plane direction of the magnetic material 10 (the image is directing downward perpendicularly to the drawing sheet plane).

The magnetic bubble domain moves directly under the tungsten needle 40 at which the stress-induced anisotropic magnetic field H_{A} is generated.

There are generated the in-plane distribution of the stress-induced anisotropic magnetic field H_{A} due to the stress distribution and the reconstruction of the magnetic bubble domain for minimizing the sum total of the magnetostatic energy and the domain wall energy, and thereby the magnetic bubble domain is displaced in a multibody state.

### (External Magnetic Field and Local Stress Dependency of Magnetic Domain Motion Due to Local Stress)

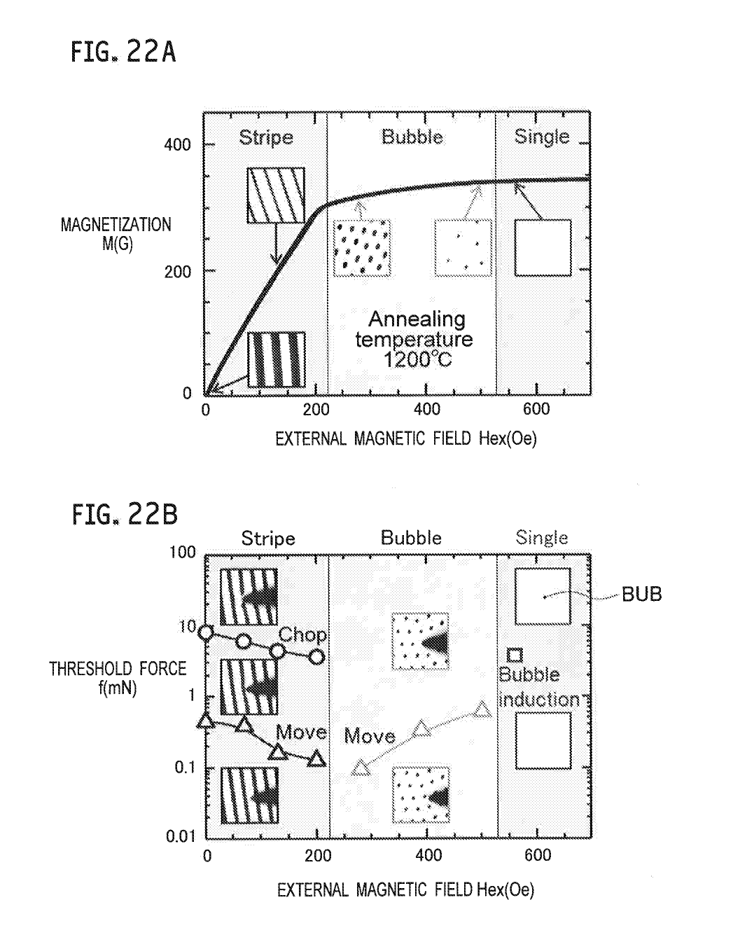

In the magnetic material applied to the stress sensor according to the embodiment, FIG. 22A shows the magnetic field dependency of the magnetooptical microscope image to be corresponded with the magnetizing curve (relationship between the external magnetic field Hex and the magnetization M) [an example of being annealed at 1200 degrees C.] (corresponding to FIG. 17B). FIG. 22B is a diagram showing a relationship between the external magnetic field Hex and threshold force, in a result of examining a relationship between a magnetic domain motion and a threshold load, while changing magnetic domain structure by applying an external magnetic field Hex in perpendicular-to-plane direction thereto. In FIG. 22B, “Move” shows threshold force f by which the stripe shaped magnetic domain or magnetic bubble domain directly under the tungsten needle 40 starts to move in a state where the external magnetic field Hex is applied. In FIG. 22B, “Chop” shows threshold force f by which the stripe shaped magnetic domain directly under the tungsten needle 40 is chopped in the state where the external magnetic field Hex is applied.

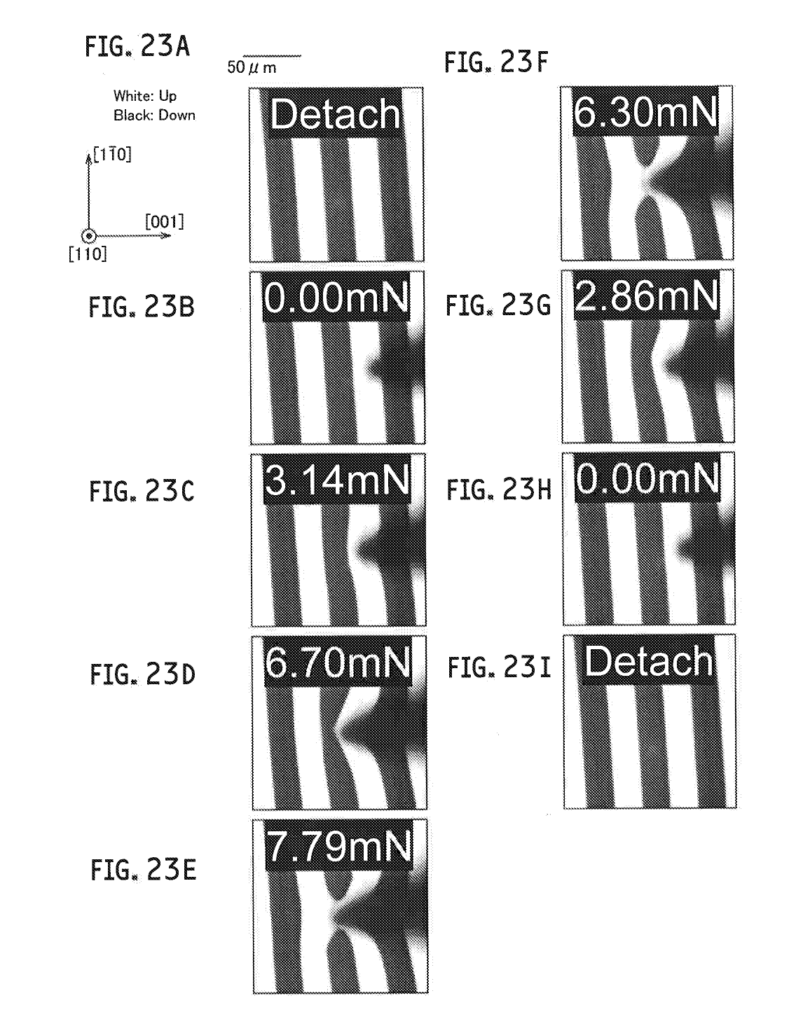

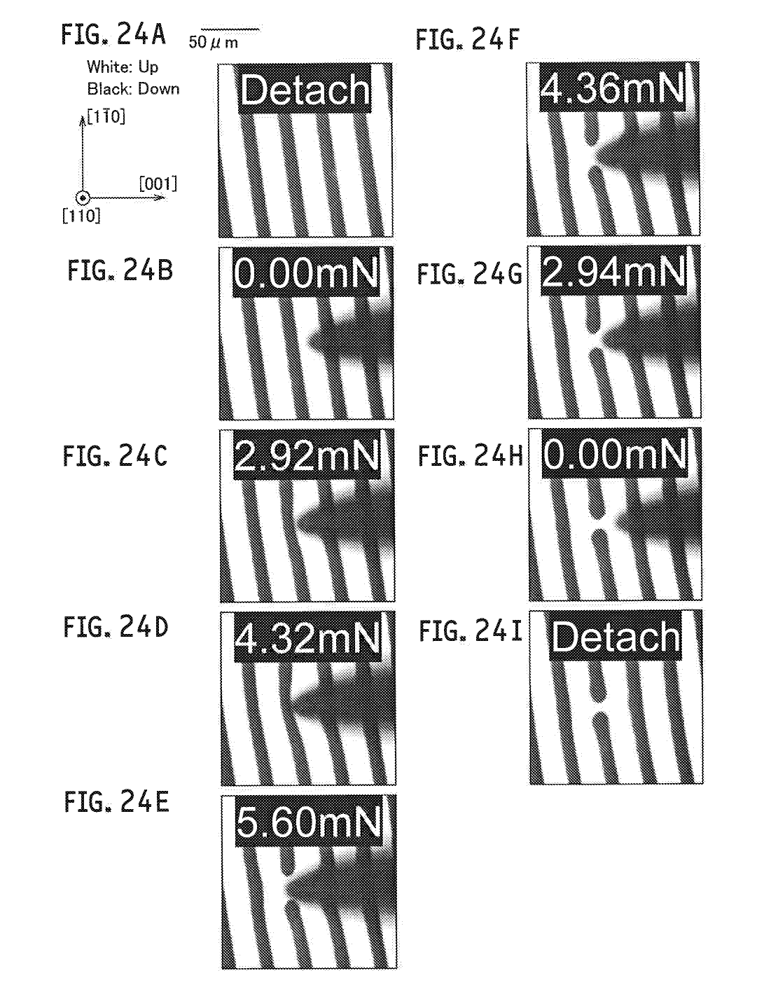

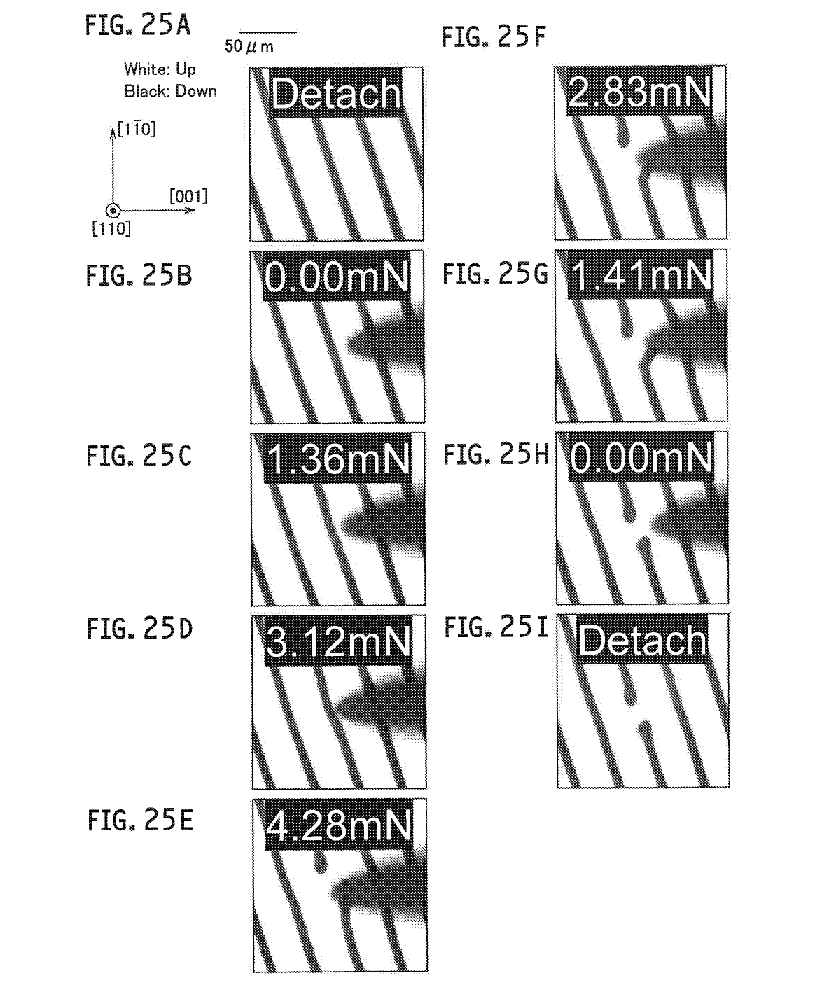

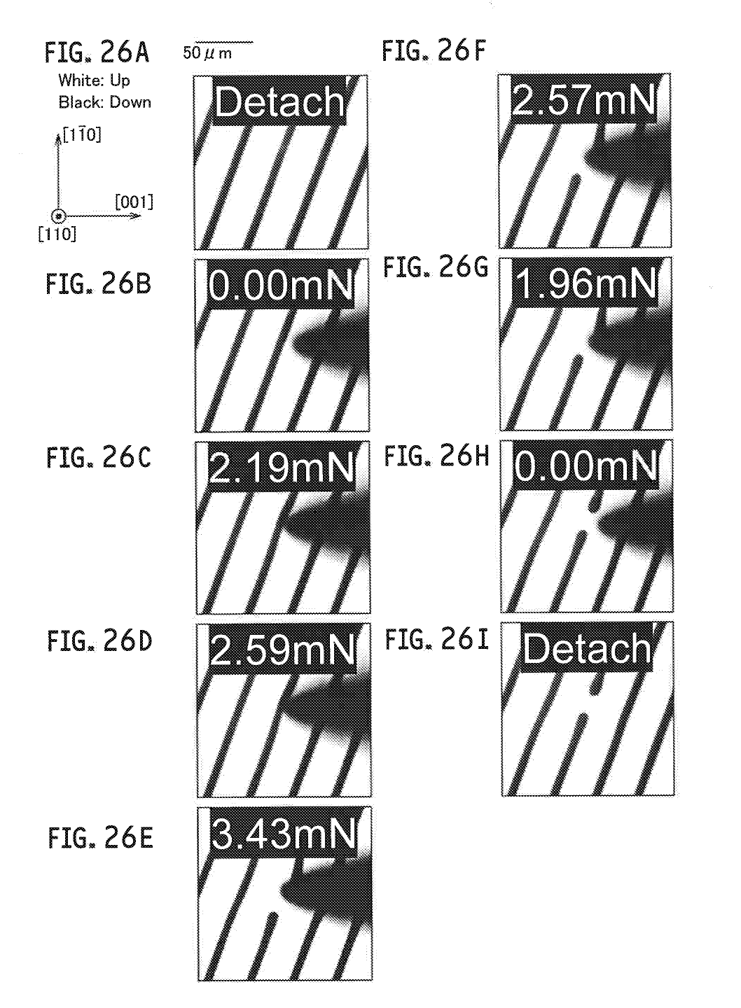

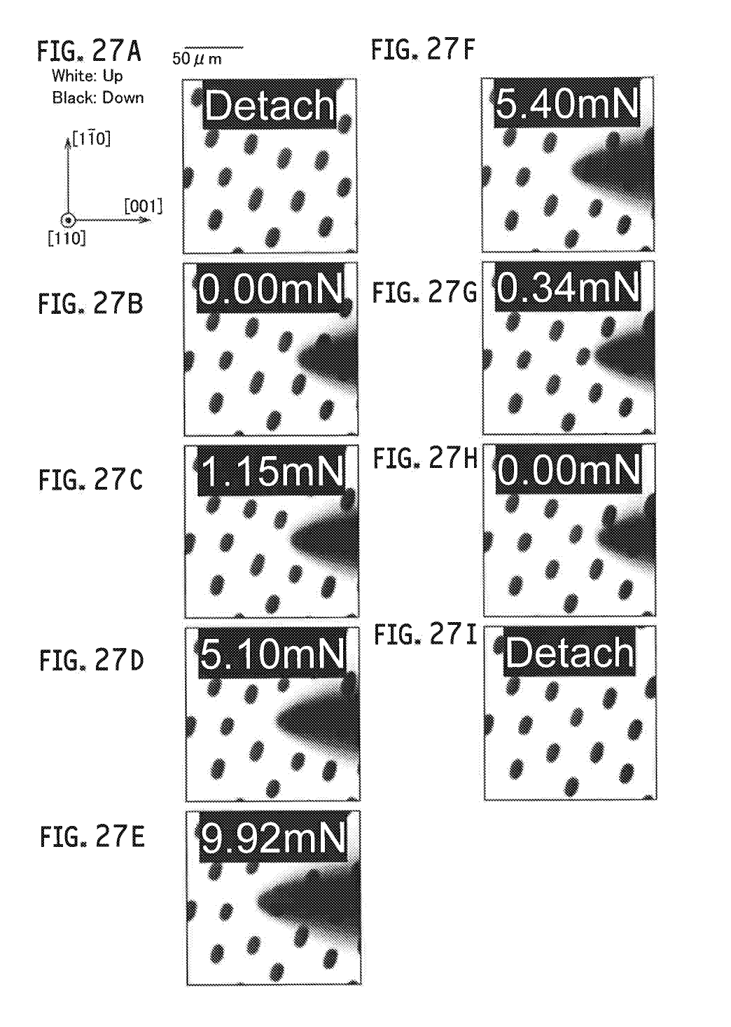

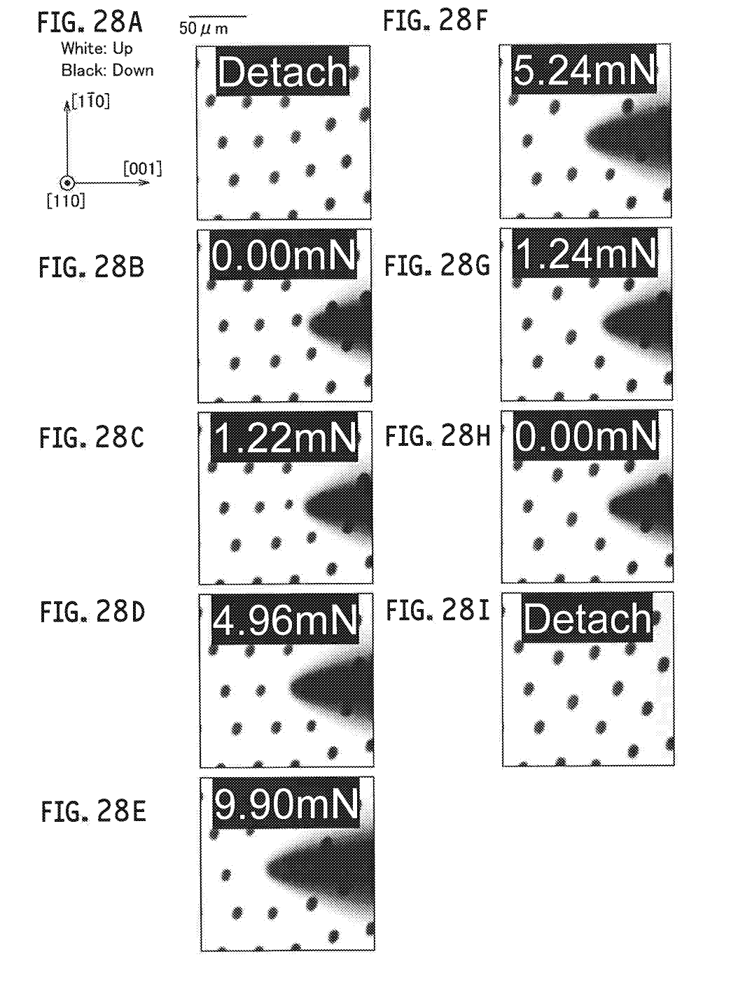

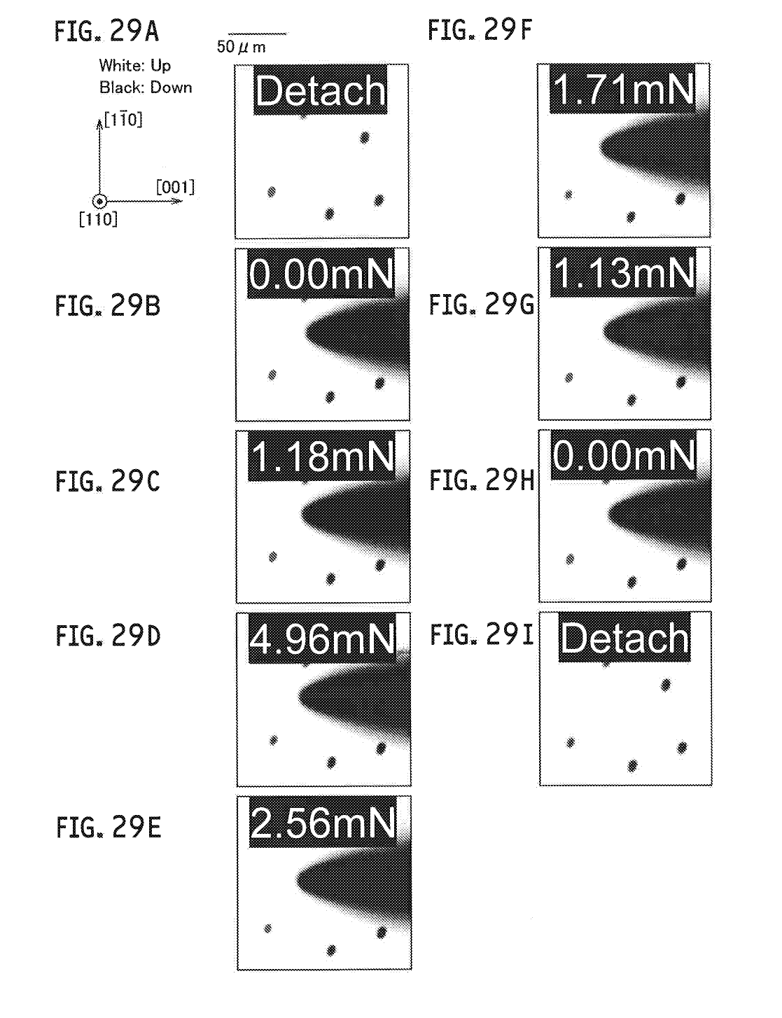

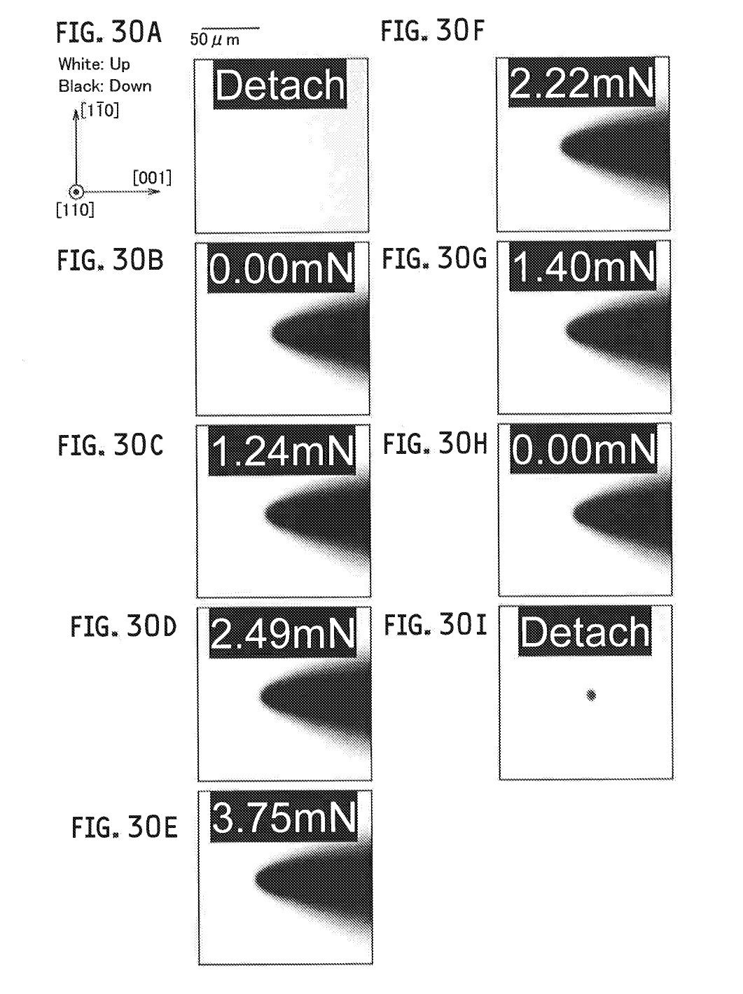

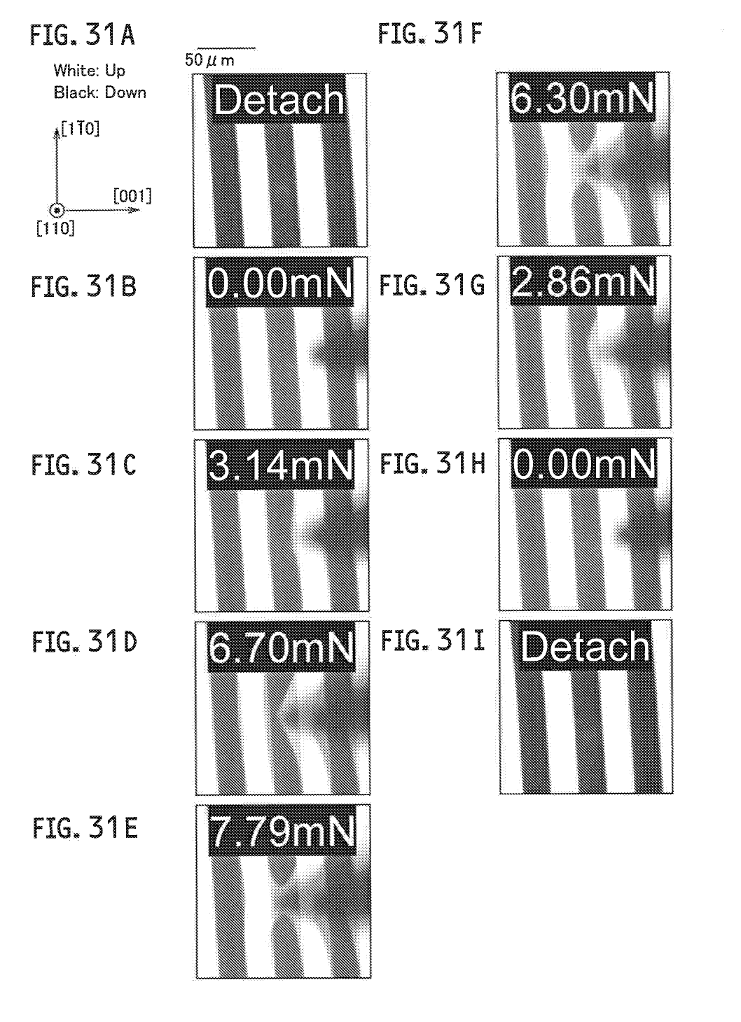

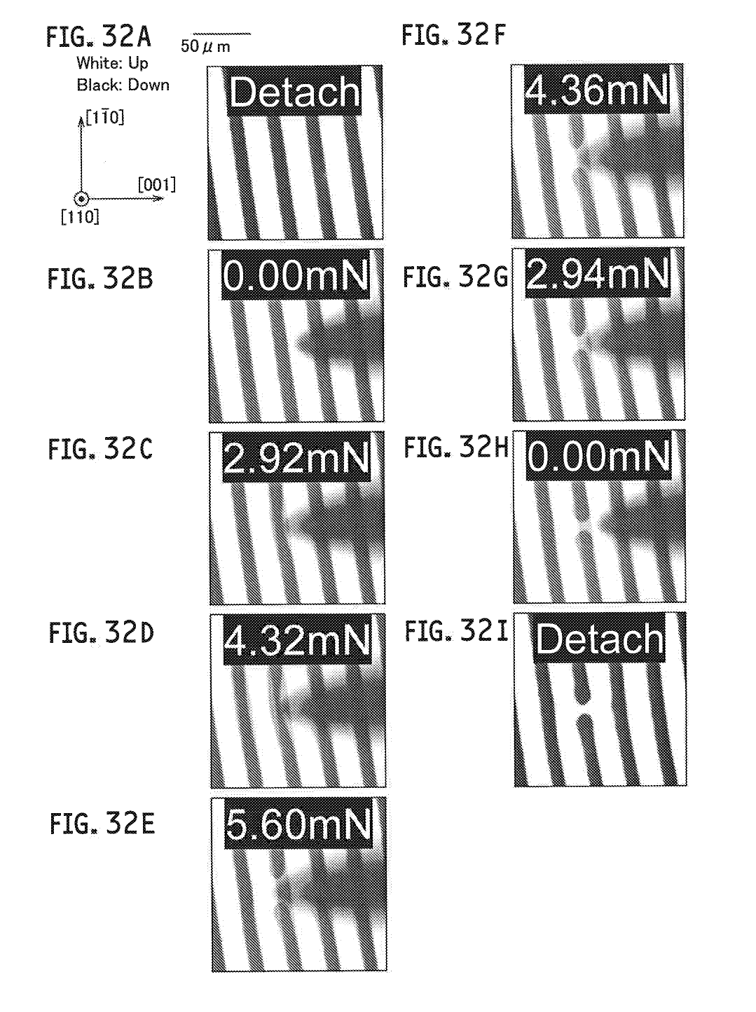

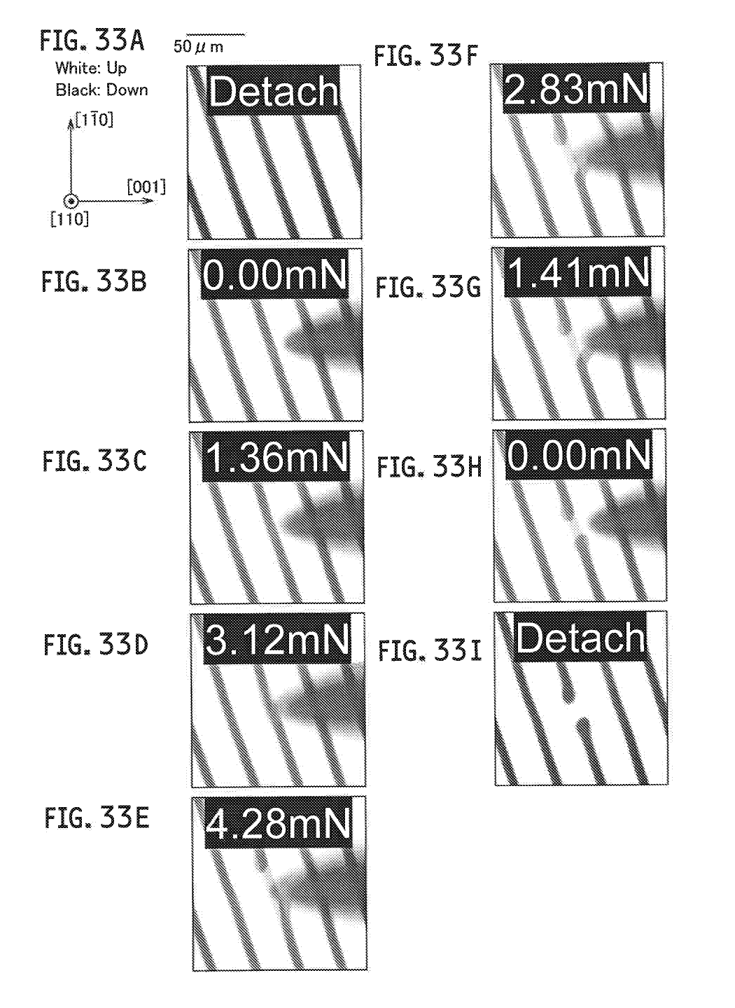

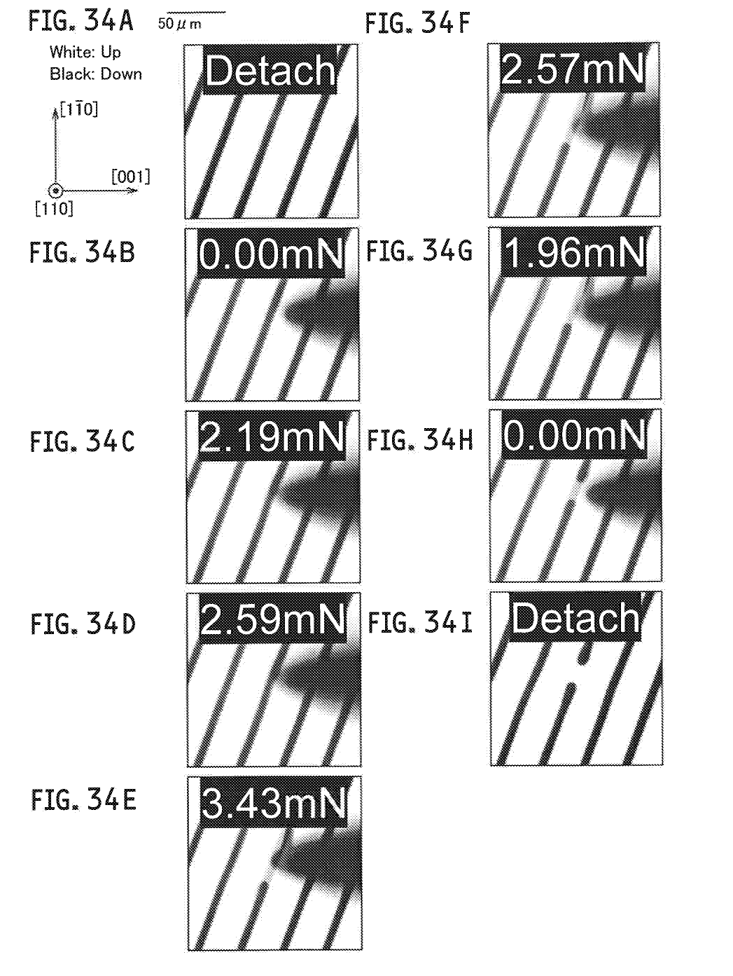

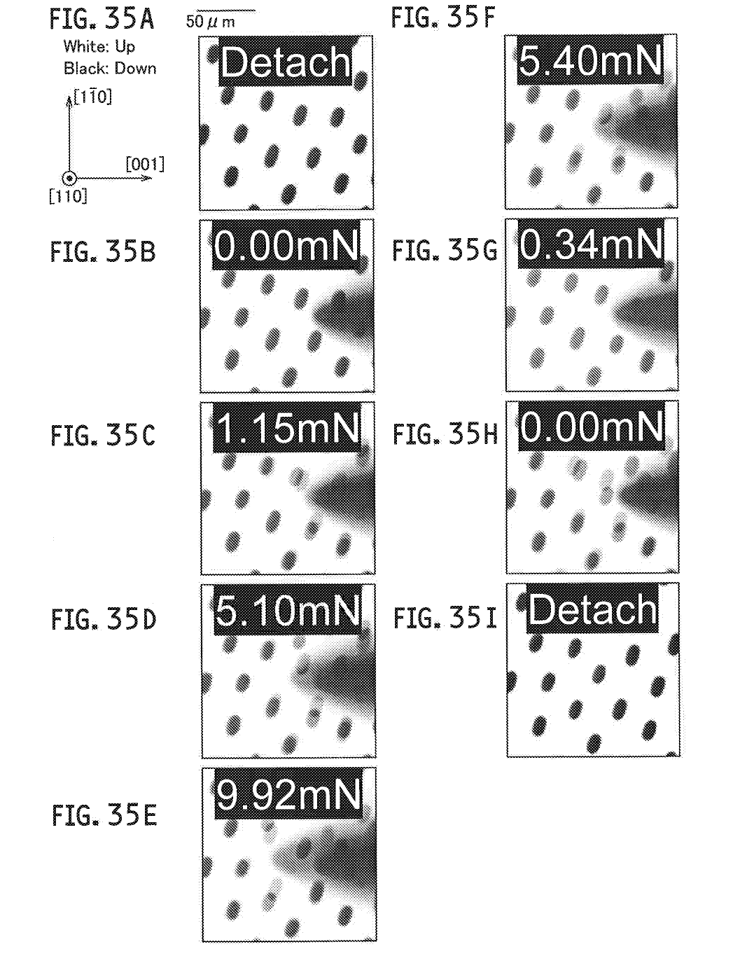

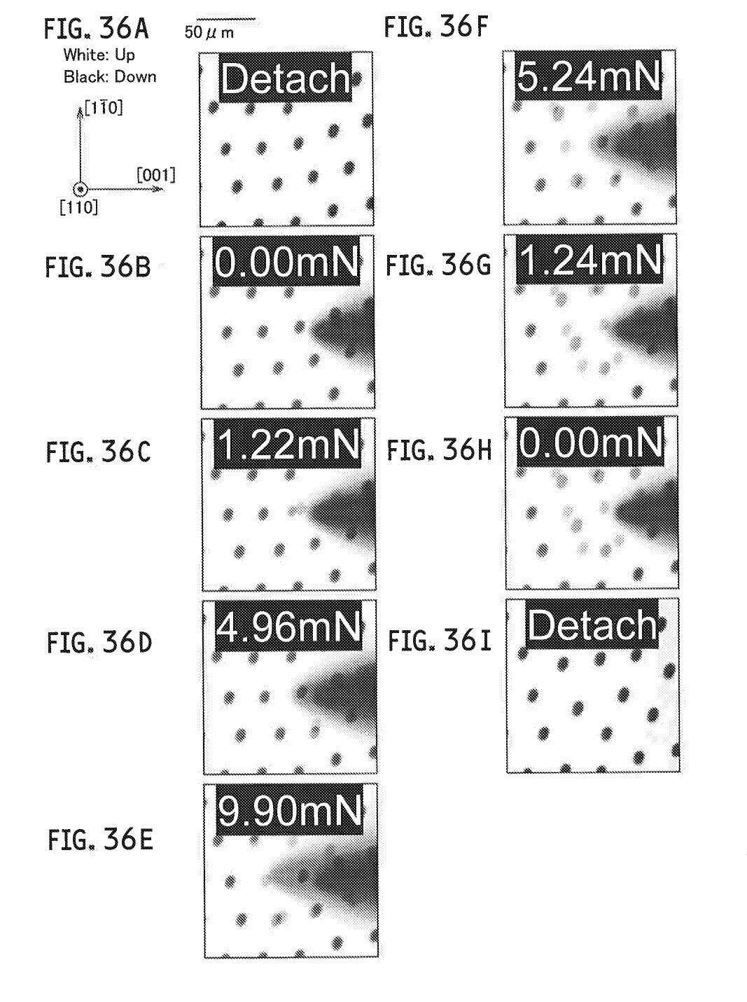

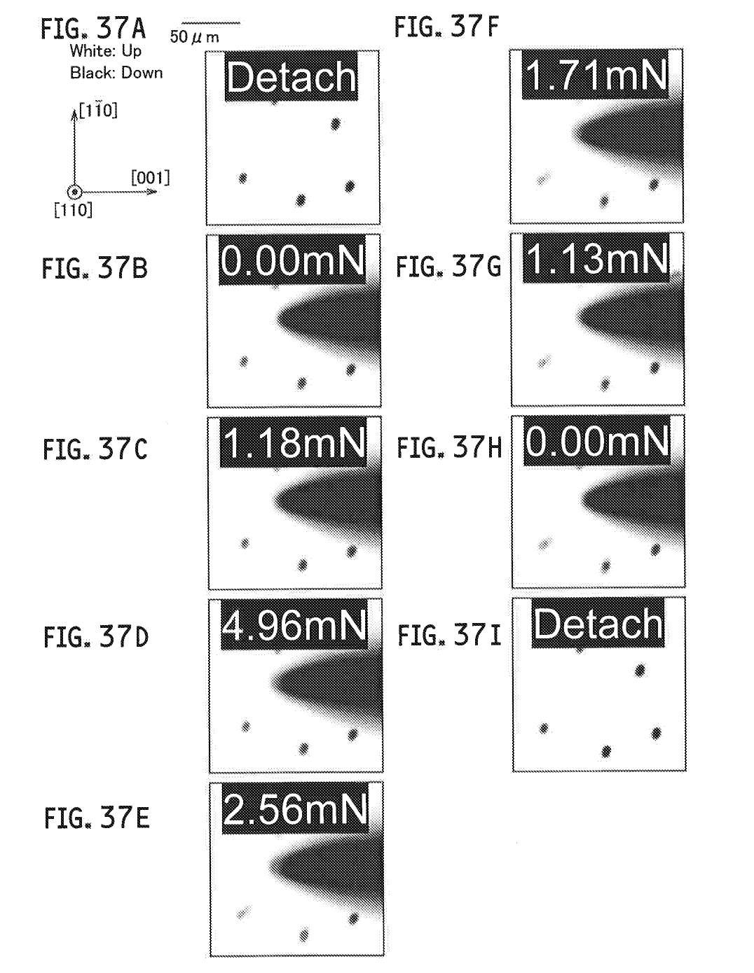

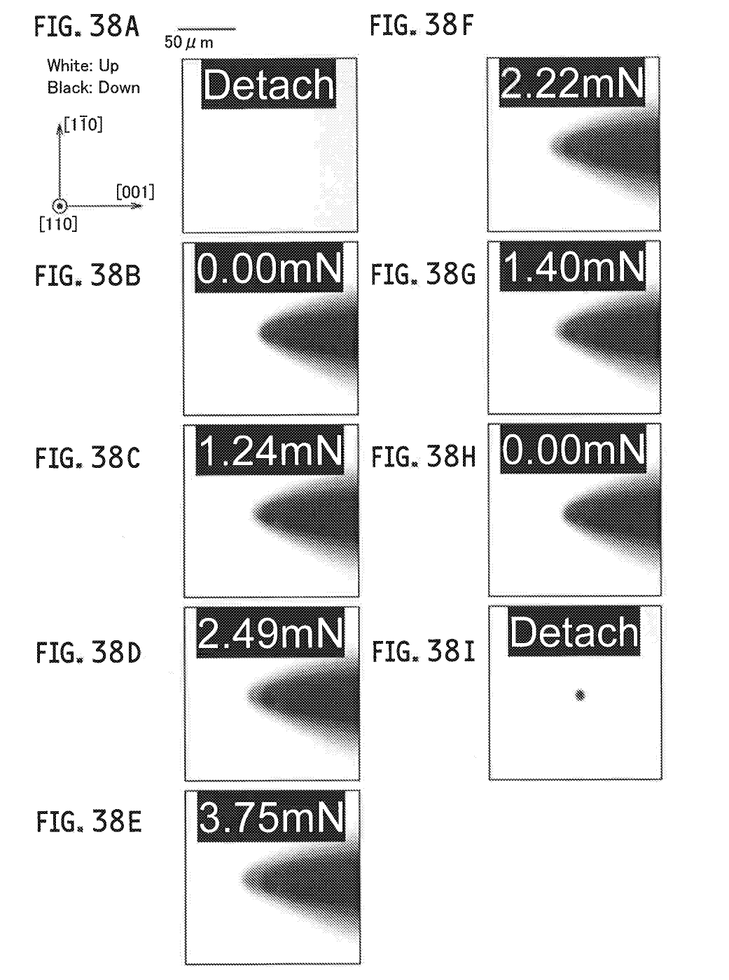

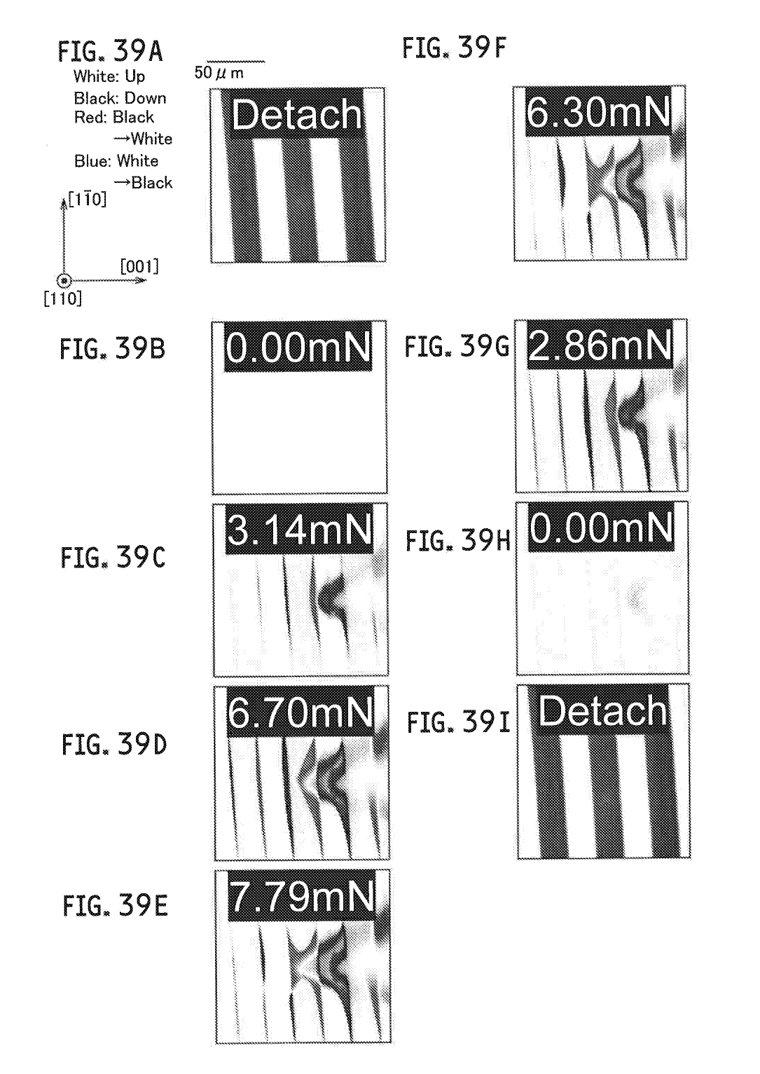

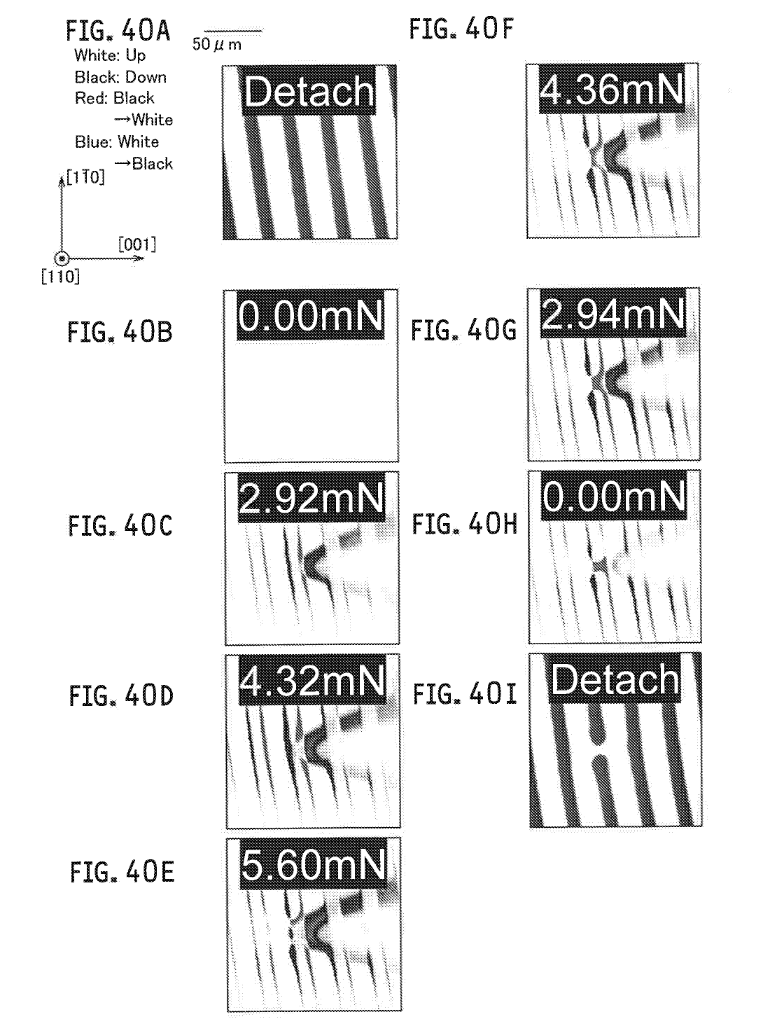

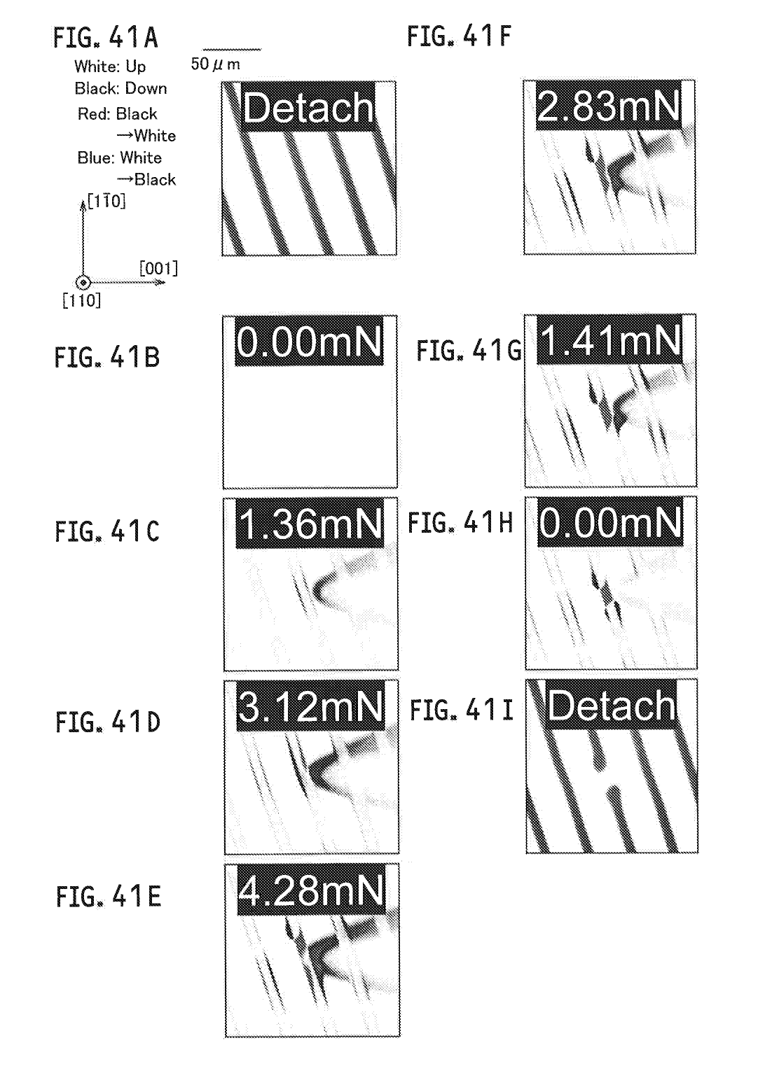

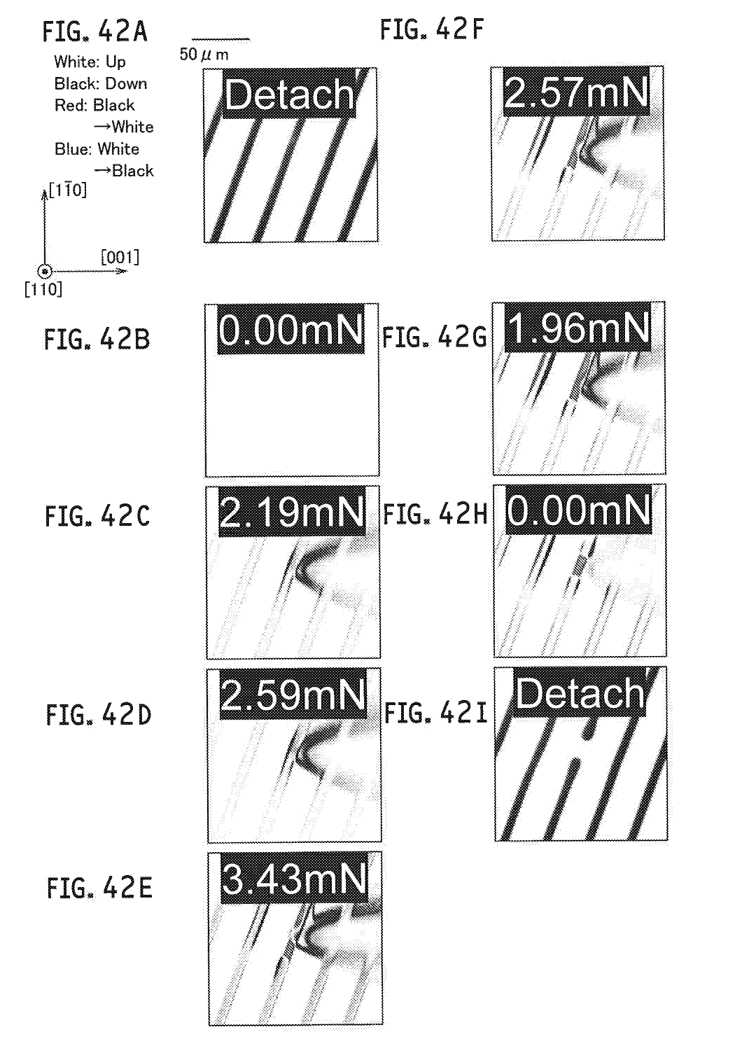

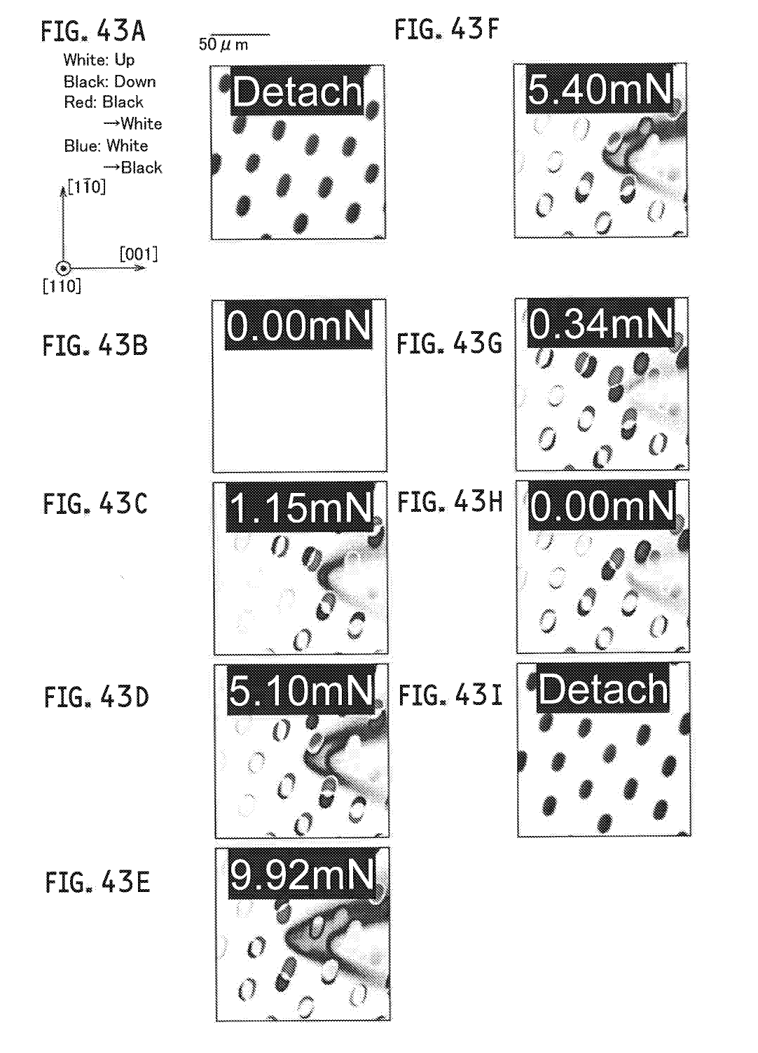

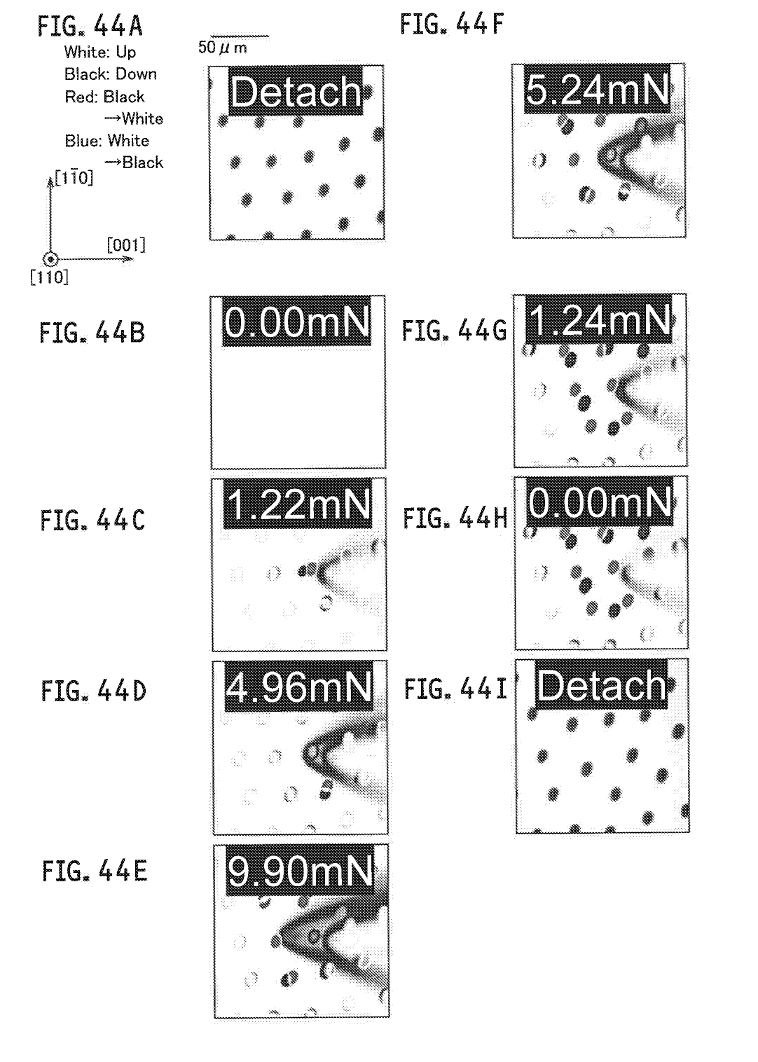

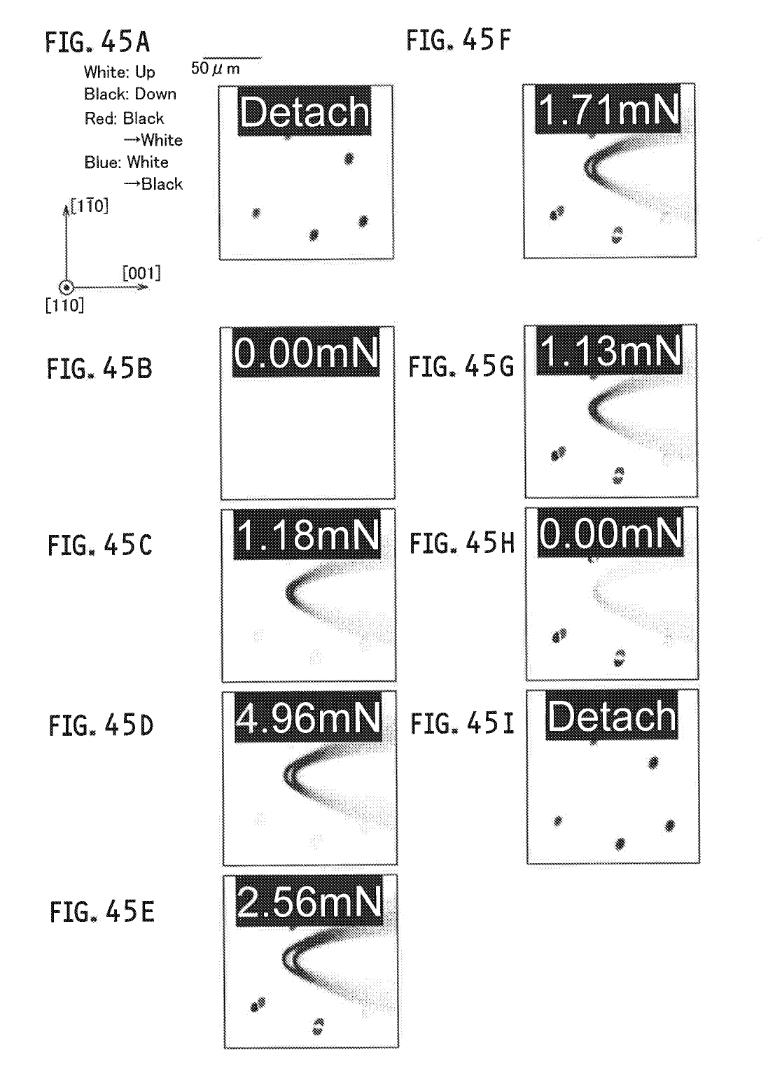

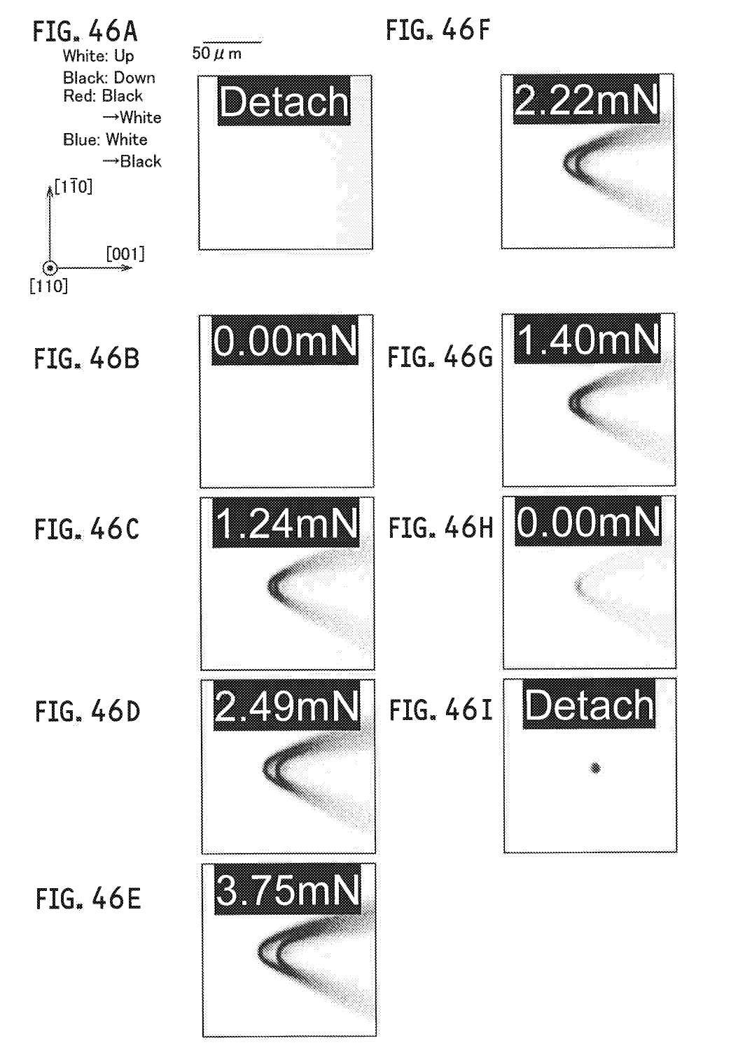

As shown in FIGS. 22A and 22B, it is proved that the phenomena, e.g. the motion and the chop of the striped magnetic domain, and the motion and the generation of the magnetic bubble domain, can be freely controlled with the external magnetic field and the local stress. Detailed experimental results are shown in FIGS. 23 to 30. In order to make aspects of the magnetic domain motion easily to understand, FIGS. 31 to 38 show superimposed images before and after the displacement of the magnetic domain. Furthermore, FIGS. 39 to 46 show difference images before and after the displacement of the magnetic domain.

As shown in FIGS. 23 to 46, the motion and the chop of the striped magnetic domain, and the motion and the generation of the magnetic bubble domain can be freely controlled with the external magnetic field Hex and the local stress.

### (External Magnetic Field and Annealing Temperature (Magnetic Anisotropy) Dependency of Magnetic Domain Motion Threshold Load Due to Local Stress)

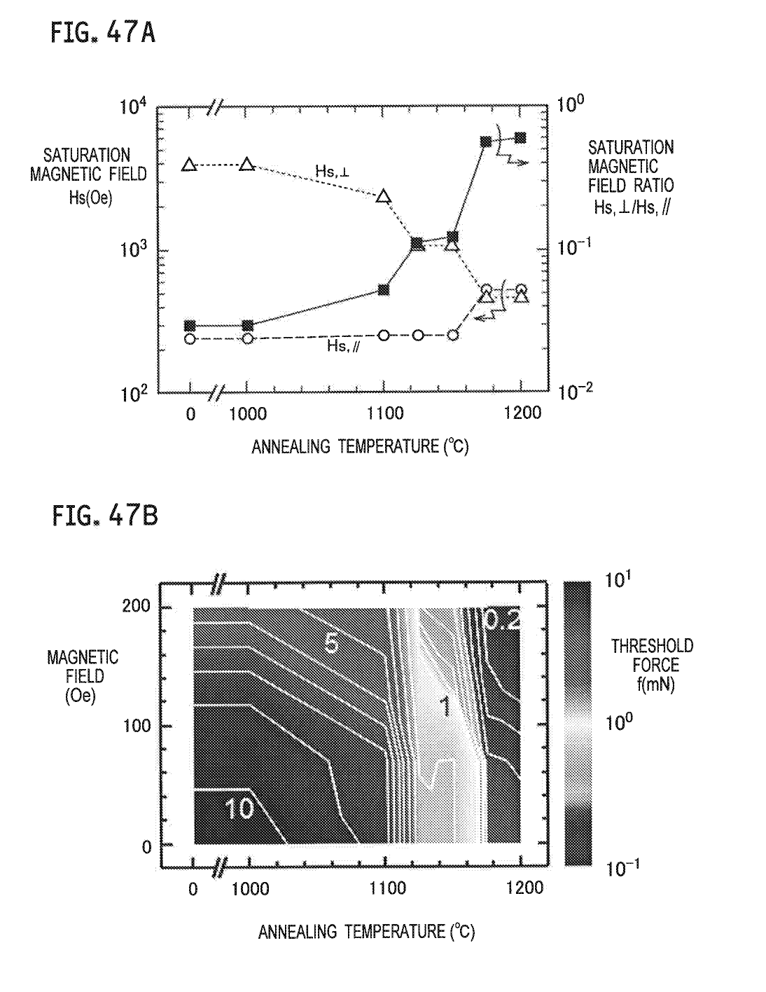

FIG. 47A shows annealing temperature dependency (diagram corresponding to FIG. 16) of between the saturation magnetic field Hs and a saturation magnetic field ratio Hₛ, ⊥/Hₛ, ∥, in the magnetic material applied to the stress sensor according to the embodiment. FIG. 47B shows annealing temperature dependency between the external magnetic field Hex (Oe) and the threshold force f (mN), showing an aspect that a threshold load of the magnetic domain motion is reduced by increasing the annealing temperature (reduction of magnetic anisotropy).

Regarding the results of the magnetic domain motion, only the magnetic materials 10 subjected to the anneal process at 1200 degrees C. has been shown until now. FIGS. 47A and 47B show the results of examining the threshold load of the magnetic domain motion with respect to the magnetic material 10 from which the annealing temperature, i.e., the magnetic anisotropy was changed by reducing the growth-induced magnetic anisotropy. As proved from FIGS. 47A and 47B, the threshold load of the magnetic domain motion is reduced by increasing the annealing temperature, i.e., by reducing the magnetic anisotropy.

The above-mentioned results prove that the magnetic domain response with respect to the local stress can be controlled by controlling the magnetic anisotropy and the external magnetic field Hex of the magnetic material 10.

### (Local Magnetic Field Generating Apparatus)

A local magnetic field generating apparatus can be fabricated by applying the driving phenomenon of stress-induced magnetic domain. A simple structure of only combining the magnetic material 10 and the magnet 20 may be sufficient.

### —Selection of Magnetic Substance Material—

As the magnetic materials 10, if the materials capable of generating the magnetic bubble, a kind of the materials do not matter. For example, the magnetic materials 10 include: garnet RFe₅O₁₂, orthoferrite RFeO₃, hexagonal crystal ferrite AFe₁₂O₁₉ (R is a rare earth element and A is Ba, Sr, Pb, etc.). etc. known as magnetic bubble materials for many years; perovskite manganese oxide RRMnO₃ known as strongly-correlated electron materials (R is rare earth element or alkaline earth metal element); and helimagnet known as skyrmion materials (MnSi, MnGe, Mn₁₋ₓFeₓGe, FeGe, Fe₁₋ₓCoₓSi, Cu₂O, SeO₃). The magnetic domain width, i.e., the spatial resolution of the local magnetic field, can be changed from several nm to several 100 μm by selecting the magnetic substance materials.

### —Selection of Magnet—

Since the magnet 20 is used for applying the bubble generating magnetic field in the out-of-plane direction, a kind of the materials do not matter if the materials capable of realizing the purpose. Permanent magnets, electromagnets, or multi-ferroic materials which can control the magnetic field direction with voltage and current may be used. It is sufficient also as laminated structure using ferromagnetic material thin films. The magnets 20 are disposed so that the homogeneous magnetic field can be applied to the stress applied portion 40P.

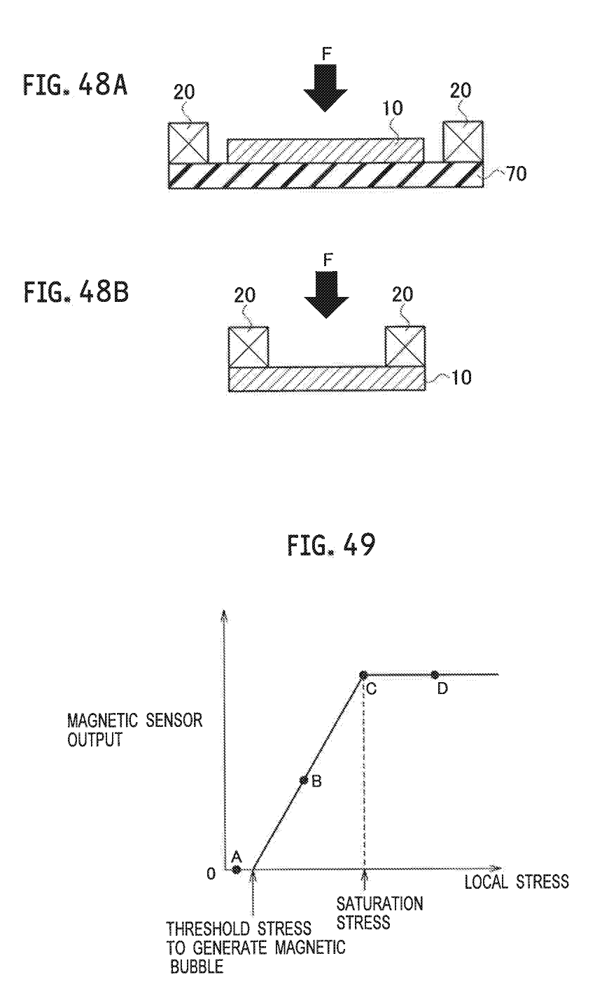

FIG. 48B is a diagram explaining disposition of the magnet 20 in the local magnetic field generating apparatus, showing a configuration example in that the magnet 20 is disposed on the supporting base 70 so as to surround the magnetic material 10. FIG. 48B shows a configuration example of disposing the magnet 20 on the magnetic material 10.

The size of the external magnetic field Hex is adjusted so as to be the same degree of that of the saturation magnetic field Hs, on the magnetic material 10. Moreover, the point that the function as the local magnetic field generating apparatus can be changed in accordance with the size of the applied external magnetic field Hex is the same as that of the stress sensor according to the embodiment (refer to FIGS. 1 to 3). If the applied external magnetic field is set so as to be larger than the saturation magnetic field, the magnetizing direction is not stored after applying the stress. That is, on and off of the local magnetic field can be controlled by turning on and off of the stress. Accordingly, the volatile function can be realized. On the other hand, if the applied external magnetic field Hex is set so as to be the same degree of that of the saturation magnetic field Hs, the magnetizing direction is stored after applying the stress, i.e., the local magnetic field can be turned on by turning on of the stress. Accordingly, the nonvolatile function can be realized.

### (Local Stress Sensor)

The local stress sensor can be fabricated by applying the driving phenomenon of stress-induced magnetic domain thereto, as the following procedures. As mentioned above, the disposition place of the magnet 20 for applying the external magnetic field Hex does not matter.

### —Film Formation of Insulating Film—

The insulating film was deposited on the magnetic material 10. If the magnetic material 10 has conductivity, for example, the magnetic material 10 and the magnetic sensor 30 can be made adjacent to each other via the insulating film, although the insulating film is not necessary if the magnetic material is an insulator.

### —Fabrication of Magnetic Sensor—

The Hall element can be used as the magnetic sensor 30. Hereinafter, although the case where the Hall element is used will now be described, it is possible to compose similarly the stress sensor even if other magnetic sensors are used, and therefore the magnetic sensor 30 is not limited to such a Hall element. For example, Tunnel Magneto-Resistance effect (TMR) elements, Giant Magneto Resistive effect (GMR) elements, etc. may be applied thereto.

It is preferable to select materials in which there is no damage to the magnetic materials 10, e.g. vacuum evaporation and sputtering, and film formation is convenient, and thereby satisfactory characteristics are obtained in polycrystal films or amorphous films, as the Hall element material applied to a magnetic sensor 30. If such materials are applied thereto, the magnetic material 10 can be formed so as to be laminated on the magnetic sensor 30. Accordingly, the magnetic flux from the magnetic domain can be efficiently detected, without the magnetic flux from the magnetic domain decaying, since the distance between the magnetic material 10 and the magnetic sensors 30 is increased. As materials which can be conveniently fabricated with vacuum evaporation, Bi which is a semimetal with a high degree of Hall coefficient is listed, for example.

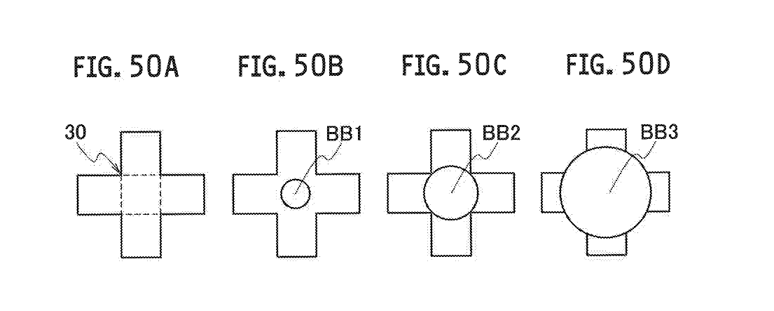

FIG. 49 shows a relationship between a magnetic sensor output and a local stress (or stress-induced anisotropic magnetic field), in the stress sensor 60 according to the embodiment configured to using a Hall element as the magnetic sensor 30. Moreover, FIG. 50A is a schematic diagram showing the magnetic sensor 30 corresponding to the point A shown in FIG. 49, for explaining an aspect that an area of the magnetic bubble which occupies directly under an effective region of the magnetic sensor gradually increases by increasing the stress. Moreover, FIG. 50B is a schematic diagram showing a magnetic bubble BB1 corresponding to the point B shown in FIG. 49, FIG. 50C is a schematic diagram showing a magnetic bubble BB2 corresponding to the point C shown in FIG. 49, and FIG. 50D is a schematic diagram showing a magnetic bubble BB3 corresponding to the point D shown in FIG. 49.

If it is concerned about a damage to the magnetic sensor 30 due to the stress, the magnetic sensor 30 may be formed on a surface opposite to a surface to which the stress is applied, for example. Hole crossbar and a pad electrode were formed on the magnetic material 10 with general photolithography method. In this case, the magnitude relationship between the hole crossbar and the magnetic domain width can add the following function. That is, when applying the local stress to the magnetic material 10, the magnetic bubble will be generated if a certain constant threshold stress is applied, but if the stress is further increased, a phenomenon in which the diameter of the magnetic bubble becomes large will be used positively.

As shown in FIGS. 49 and 50A-50D, if the magnetic bubble diameter is increased by increasing the stress, the area of the magnetic bubble occupied directly under the magnetic sensor effective region will be gradually increased. Changes of minuter stresses can be detected since the magnetic sensor output is increased corresponding thereto. It is also preferable to integrate a plurality of the magnetic sensors on the magnetic material in order to detect the local stress at arbitrary positions on the magnetic material front side surface.

### (Stress Distribution Sensor)

The stress distribution sensor can be fabricated by applying the driving phenomenon of stress-induced magnetic domain. As shown in FIGS. 20 and 21, if the stress is given in a state of applying the magnetic field for generating magnetic bubble, there will be generated the in-plane distribution of the stress-induced anisotropic magnetic field H_{A} due to the stress distribution and the reconstruction of the magnetic bubble domain for minimizing the sum total of the magnetostatic energy and the domain wall energy, and thereby the magnetic bubble domain is displaced in a multibody state. The stress distribution can be measured by detecting the displacement of the bubbles by using a plurality of the magnetic sensor integrated on the magnetic material.

In addition, stresses between materials applying the stress and the materials receiving the stress (e.g., magnetic material, in this case) are changed with a physical property value of the materials (e.g., elastic coefficient, Poisson's ratio, and friction coefficient if friction is need to be taken into consideration). For example, it becomes possible to experimentally measure the stress for two bodies with higher accuracy by performing the following processes: That is, a relationship between the applied stress and the magnetic sensor output is checked as reference data by contacting a needle provided at an edge part of the micro-force sensor to the magnetic material, while the stress is controlled using the piezo lift stage. Furthermore, in consideration of the physical property values, stress calculation with the Hertzian contact theory or general CAE analysis is executed, and then a simulation of applying the stress is performed.

### (Hall Element)

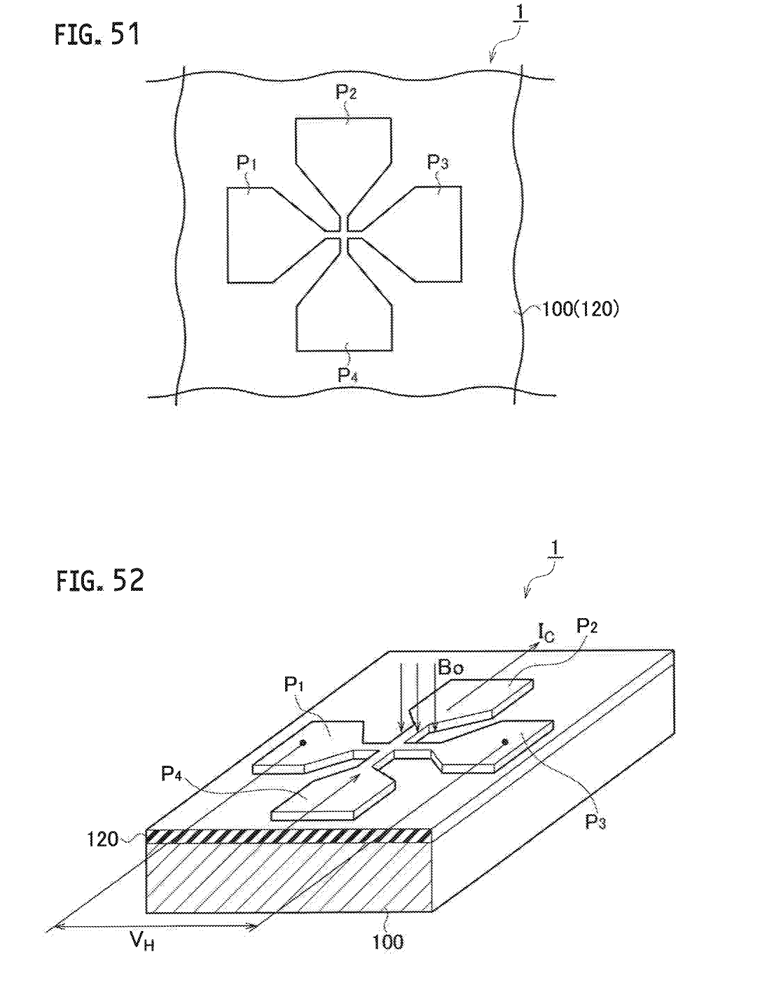

FIG. 51 shows a schematic planar pattern configuration of the Hall element 1 applicable to the magnetic sensor in the stress sensor according to the embodiment, and FIG. 52 shows a schematic bird's-eye view configuration thereof.

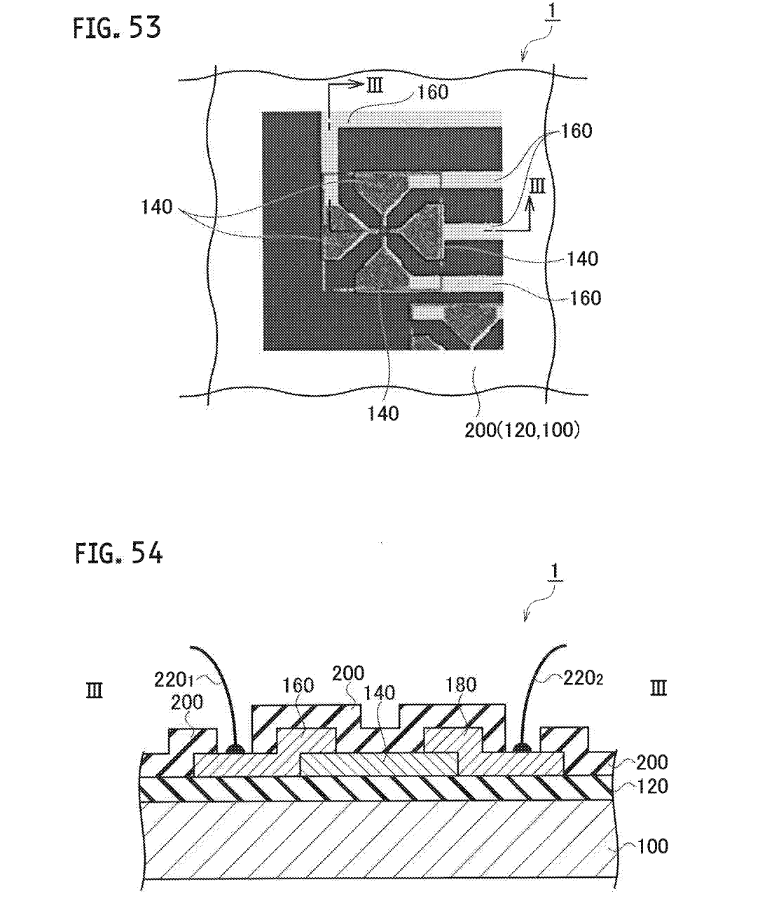

Moreover, FIG. 53 shows a surface optical micrograph of one element portion of the Hall element 1, and FIG. 54 shows a schematic cross-sectional structure taken in the line of FIG. 53.

As shown in FIGS. 51 to 54, the Hall element 1 includes: a crossbar-shaped electrode layer 140 disposed on a magnetic material 100; and pad electrodes P₁-P₄, 160, 180 connected to the crossbar portion of the electrode layer 140.

In the embodiment, the electrode layer 140 having crossbar shape is formed of an approximately 100-nm-thick Bi electrode layer. Moreover, if the underlying metal layer is disposed as an underlying layer of the bismuth electrode layer 140, an effect of Bi lift off can be improved in a Lift-off process of the bismuth electrode layer 140. An approximately 3-nm-thick Cr layer can be applied as the underlying metal layer, for example.

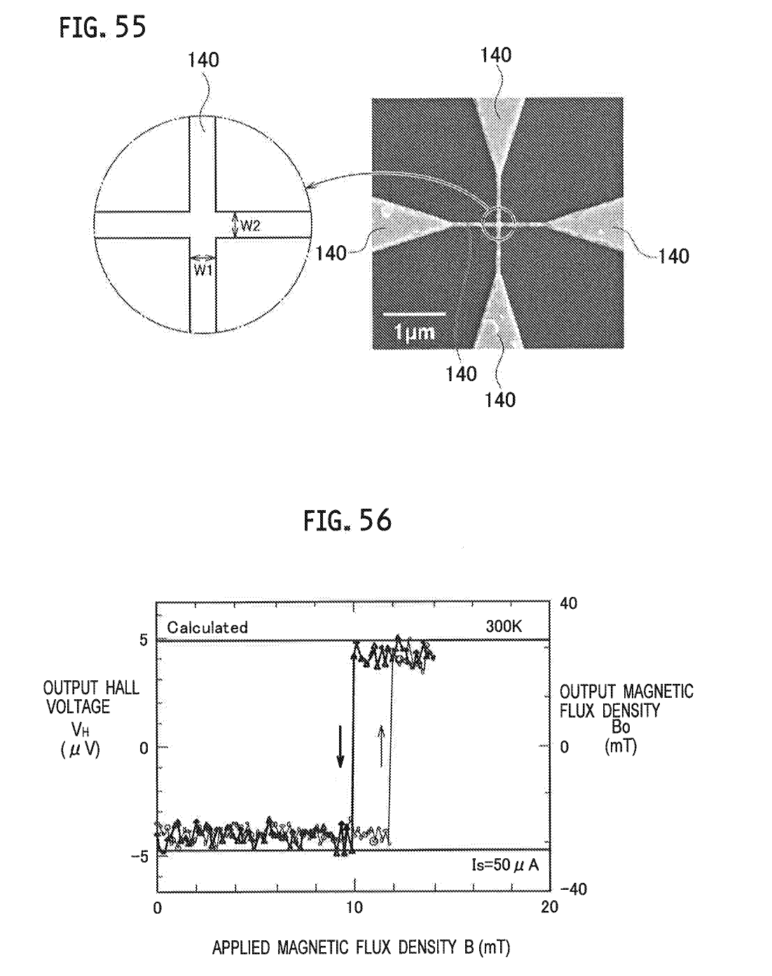

FIG. 55 shows a SEM photograph of the surface at the center portion of hole crossbar in the Hall element 1 and an explanatory diagram of the center portion of hole crossbar. The area of the crossbar portion can be formed in various sizes in the Hall element 1. The crossbar portion of the crossbar-shaped electrode layer 140 may have sizes (W₁=W₂) of several 10 nm to several 100 μm. Alternatively, the sizes may be equal to or less than 100 nm×100 nm. More specifically, as shown in FIG. 55, the crossbar portion of the crossbar-shaped electrode layer 140 may have the sizes (W₁×W₂) of equal to or less than 100 nm×100 nm, or preferably may be 50 nm×50 nm, for example.

Moreover, as shown in FIGS. 51 to 54, the Hall element 1 may include an insulating layer 120 disposed between the magnetic material 100 and the electrode layer 140. Since the Hall element 1 includes the insulating layer 120, the electrode layer 140 and the pad electrodes P₁-P₄, 160, 180 can be formed so as to be integrated with the magnetic material 100. Thus, the Hall element 1 integrated with the magnetic material 100 composes the magnetic sensor. Accordingly, such a detection device formed so as to be integrated with the magnetic material 100 can be called the magnetic sensor applicable to the stress sensor according to the embodiment in this way.

In the magnetic sensor to which the Hall element 1 is applied, the magnetic material 100 may be formed of a B1-substituted garnet, for example. An approximately 50-μm-thick Bi-substituted garnet which is film-formed on an approximately 350-μm-thick (111) plane (GaGd)₃(MgGaZr)₅O₁₂ substrate by using liquid phase epitaxy may be used for the magnetic material 100.

Moreover, the insulating layer 120 may be formed of an approximately 30-nm-thick Al₂O₃, for example, in the magnetic sensor to which the Hall element 1 is applied. In the embodiment, the Al₂O₃ can be formed by using the Atomic Layer Deposition (ALD) method, for example.

Moreover, the pad electrodes P₁-P₄, 160, 180 may include an Au layer, in the magnetic sensor to which the Hall element 1 is applied. More specifically, the pad electrodes P₁-P₄, 160, 180 may be formed of a structure formed by laminating an approximately 5-nm-thick Cr layer/an approximately 200-nm-thick Au layer/an approximately 5-nm-thick Cr layer.

Moreover, the magnetic sensor to which the Hall element 1 is applied may include a passivation film 200 configured to cover the front side surface of device, as shown in FIG. 54. In the embodiment, the passivation film 200 may be formed of an approximately 30-nm-thick Al₂O₃, for example. Similarly, the Al₂O₃ can be formed by using the ALD method, for example. Degradation due to oxidization of the bismuth electrode layer 14 having crossbar-shaped underlying can be prevented by applying the ALD-Al₂O₃ layer as the passivation film 200.

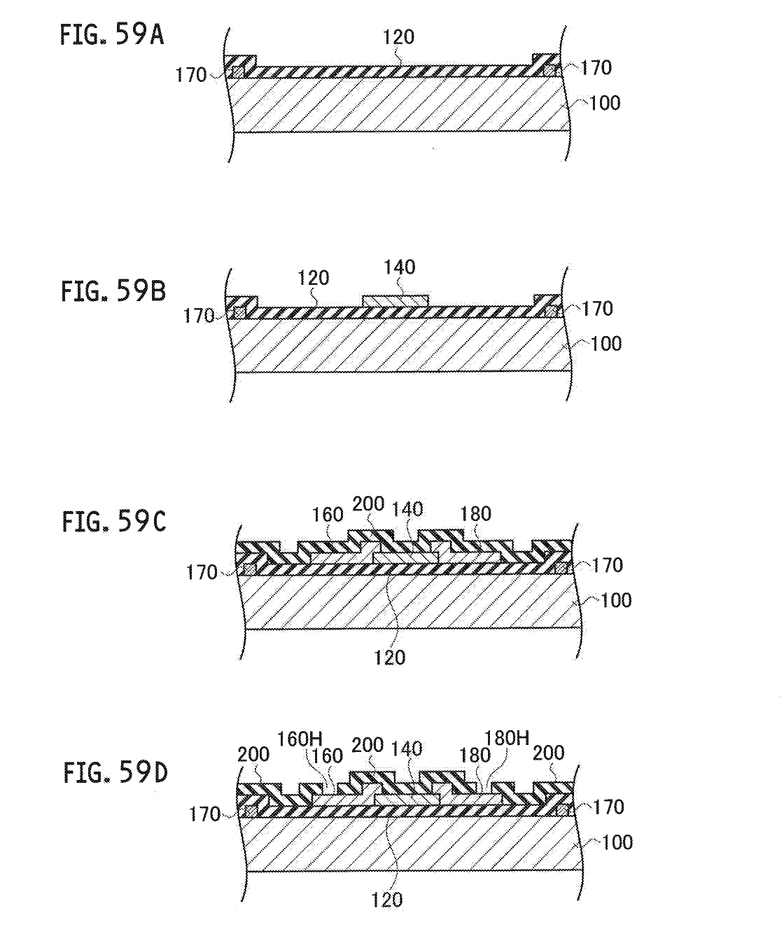

Moreover, in the magnetic sensor to which the Hall element 1 is applied, as shown in FIG. 54, apertures 160H, 180H with respect to the pad electrodes 160, 180 may be formed in the passivation film 200 (refer to FIG. 59D), and bonding wires 220₁, 220₂ may be connected to the pad electrodes 160, 180 in the apertures 160H, 180H. Note that the bonding wires 220₁, 220₂ shown in FIG. 54 are omitted in FIG. 53.

In the magnetic sensor to which the Hall element 1 is applied, current I_{O} is conducted in a P₂ direction from the pad electrode P₄ of pad electrodes P₁-P₄ formed to be integrated with the magnetic material 100, and then between the pad electrodes P₁ and P₄, an output hall voltage V_{H} (μV) expressed in the following equation is generated, where B_{O} is a magnetic field (magnetic flux density) applied from the magnetic material 100 to the crossbar portion, and K_{H} (V/(A·T)) is product sensitivity:

V_{H}=K_{H}×I_{C}×B_{O} (3)

where the product sensitivity K_{H} (V/(A·T)) is a constant determined in accordance with the materials and geometrical dimensions, for example, and is 4.4 (V/(A·T)).

The bismuth electrode layer 140 has the maximum Hall coefficient in typical metals and can be fabricated by using vacuum evaporation etc., and thereby highly sensitive Hall elements can be fabricated not depending on underlying materials, in the Hall element 1.

In the magnetic sensor to which the Hall element 1 is applied, it becomes detecting a minute magnetic domain by making the size of the Hall element 1 smaller. There is no characteristic degradation under an effect of the surface depletion due to minuteness of the element such as a semiconductor Hall element since Bi composing the electrode layer 140 is a semimetal.

The insulating layer 120 is inserted between the Hall element 1 and the magnetic material 100, and thereby the magnetic sensor to which the Hall element 1 is applied can be applied thereto not dependent on the electrical conductivity of the magnetic material 100.

FIG. 56 shows a relationship between an output hall voltage V_{H} (μV) and an output magnetic field BO, and the applied magnetic field B, in an explanatory diagram of a Hall probe operation droved by an applied magnetic field B, in the magnetic sensor to which the Hall element 1 is applied. In the embodiment, the applied magnetic field B is a magnetic field applied from external, and is supplied to the magnetic sensor to which the Hall element 1 is applied from an electromagnet by a measuring system made by combining an electromagnet and magnetooptical microscope by which the Hall probe of the magnetic domain motion and imaging can be simultaneously measured.

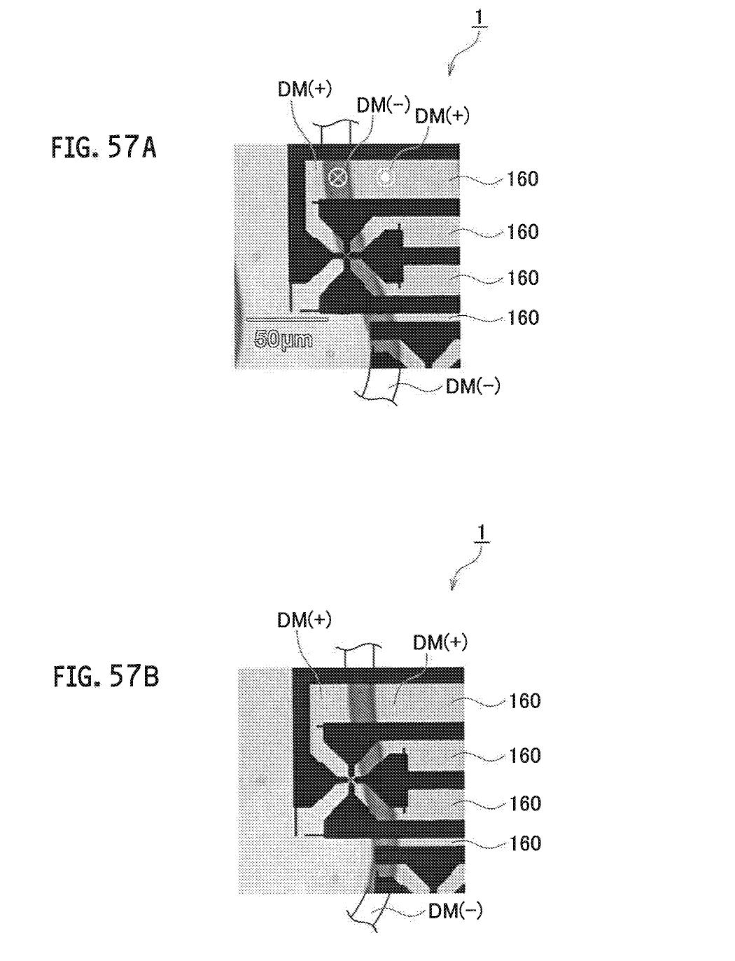

Moreover, FIG. 57A shows an example of a bubble domain DM (−) of the garnet magnetic material existing directly under the center portion of hole crossbar, in the magnetic sensor to which the Hall element 1 is applied, and FIG. 57B shows an example of a bubble domain DM (+) of the garnet magnetic material existing directly under the center portion of hole crossbar, in the magnetic sensor to which the Hall element 1 is applied. The example of the bubble domain DM (−) of the garnet magnetic material existing directly under the center portion of hole crossbar corresponds to an example of the output magnetic field B_{O} being generated in the direction from the upper surface of the drawing sheet to the back side surface, and corresponds to the thick line arrow in FIG. 56 (the output magnetic field B_{O} moves from positive direction to the negative direction). On the other hand, the example of the bubble domain DM (+) of the garnet magnetic material existing directly under the center portion of hole crossbar corresponds to an example of the output magnetic field B_{O} being generated in the direction from the back surface of the drawing sheet to the upper side surface, and corresponds to the thin line arrow in FIG. 56 (the output magnetic field B_{O} moves from negative direction to the positive direction).

As shown in FIGS. 56, 57A, and 57B, a switching operation of the output hall voltage V_{H} can be confirmed with the magnetic domain motion of the garnet magnetic material 100, in the magnetic sensor to which the Hall element 1 is applied. That is, the switching operation of the output hall voltage V_{H} due to the magnetic domain crossing directly under the Hall element 1 can be confirmed.

A quantitative evaluation of a magnetic domain motion and evaluation of an external applied magnetic field response according to the electric detection can be realized by the measuring system (refer to FIG. 18) made by combining the electromagnet and the magnetooptical microscope by which the Hall probe of the magnetic domain motion and imaging can be simultaneously measured.

As shown in FIGS. 56, 57A, and 57B, the magnetic domain motion of the garnet magnetic material 100 can be detected by driving the external magnetic field, in the magnetic sensor to which the Hall element 1 is applied.

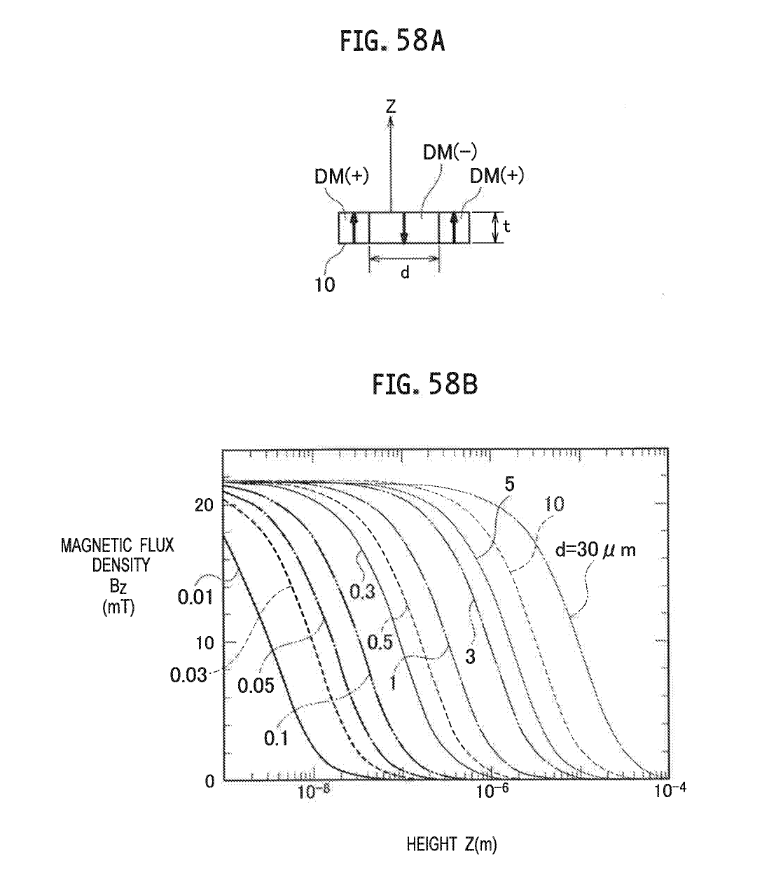

FIG. 58A shows an example of sizes of each portion of the magnetic material 100 (domain width d, and thickness t of the magnetic recording medium), in the magnetic sensor to which the Hall element 1 is applied. FIG. 58B shows a relationship between a vertical magnetic flux density B_{Z} (mT) and the height Z of the magnetic field with respect to the magnetic material 100, using the domain width d as a parameter. In FIG. 58B, the thickness t of the magnetic recording medium is set to 100 nm which is a constant value.

The vertical magnetic field B_{Z} is expressed as a function of the height Z with the following equation (W. Straus, JAP 42, 1251 (1971)):

B_{Z}=M_{Z}[(α+1)/{(α+1)²+β²}^{1/2}−(α−1)/{(α−1)²+β²}^{1/2}] (4)

where M_{Z} is saturation magnetization, α=2Z/t, and β=d/t.

In the magnetic sensor to which the Hall element 1 is applied, the magnetic fields B_{Z} will be decreased, as the height Z is increased, the domain width d is decreased, the thickness t of the magnetic material is decreased.

That is, the magnetic fields B_{Z} emitted from the magnetic domain will be decreased in accordance with the height Z being increased, and such a tendency generally becomes remarkable in accordance with reduction of the domain width d and the magnetic recording medium thickness t.

It is preferable to closely dispose Hall element 1 to the magnetic domain (domain), in the magnetic sensor to which the Hall element 1 according to the embodiment is applied.

### (Measuring System)

A schematic configuration of a measuring system made by applying the Hall element 1 according to the embodiment, and combining an electromagnet 102 and a magnetooptical microscope capable of simultaneous measuring of Hall probe and imaging of magnetic domain motion is expressed as similarly shown in FIG. 18. The measured results of imaging of the magnetic domain motion are photographs shown in FIGS. 57A and 57B, for example.

### (Fabrication Method for Magnetic Sensor)

FIG. 59A is a schematic cross-sectional structure showing forming an insulating layer 120 after forming an alignment electrode layer 170 on the magnetic material 100, in an explanatory diagram of a fabrication method for the magnetic sensor to which the Hall element 1 is applied.

FIG. 59B is a schematic cross-sectional structure showing pattern-forming a bismuth (Bi) electrode layer 140 on the insulating layer 120.

FIG. 59C shows a schematic cross-sectional structure which shows forming a passivation film 200 on the entire surface after pattern-forming a pad electrode 160, 180 in contact with the bismuth electrode layer 140.

FIG. 59D is a schematic cross-sectional structure which shows forming contact holes 160H, 180H into the pad electrode 160, 180.

The fabrication method of the magnetic sensor to which the Hall element 1 is applied includes: forming an insulating layer 120 on the magnetic material 100; pattern-forming a bismuth electrode layer 140 on the insulating layer 120; pattern-forming pad electrodes 160, 180 on the bismuth electrode layer 140; forming a passivation film 200 on the pad electrodes 160, 180; forming apertures 160H, 180H with respect to the pad electrodes 160, 180 in the passivation film 200; and respectively connecting bonding wires 220₁, 220₂ to the apertures 160H, 180H.

Moreover. the step of pattern-forming the bismuth electrode layer 140 on the insulating layer 120 may include: forming a resist layer on the magnetic material 100; forming a bismuth electrode layer 140 on the resist layer; and performing a Lift-off process of the resist layer.

Moreover, the step of forming the resist layer on the magnetic material 100 may include a plurarity of resist layers step, e.g., forming a positive resist layer (ZEP520) on PMGI, after forming PMGI on the magnetic material 100.

Hereinafter, the fabrication method for the magnetic sensor to which the Hall element 1 is applied will now be explained in details.

(a) Firstly, as shown in FIG. 59A, in accordance with a first lithography process, after pattern formation of the alignment electrode layer 170 on the magnetic material 100, the insulating layer 120 is formed.
(a-1) More specifically, the alignment electrode layer 170 composed of a laminating layer of Cr (5 nm)/Au (200 nm)/Cr (5 nm) is pattern-formed on the magnetic material 100 by using the electron beam evaporation method and the Lift-off process.
(a-2) Next, the insulating layer 120 composed of Al₂O₃ (layer thickness: approximately 30 nm, oxygen supply source: H₂O, film formation temperature: approximately 100 degrees C.) is formed by using the ALD method.
(b) Next, as shown in FIG. 59B, a hole crossbar is pattern-formed on the insulating layer 120 according to a second lithography process.
(b-1) More specifically, Cr (3 nm) layer is pattern-formed on the insulating layer 120 by using the electron beam evaporation method.
(b-2) Next, an approximately 100-nm-thick bismuth electrode layer 140 is pattern-formed by using the resistance heating vacuum evaporation method and the Lift-off process method.
(c) Next, as shown in FIG. 59C, according to a third lithography process, the pad electrodes 160, 180 are pattern-formed on the insulating layer 120 so as to be contacted with the bismuth electrode layer 140.
(c-1) More specifically, the pad electrodes 160, 180 composed of laminating layer of Cr (5 nm)/Au (200 nm)/Cr (5 nm) are pattern-formed on the insulating layer 120, by using the electron beam evaporation method and the Lift-off process, so as to be contacted with the bismuth electrode layer 140.
(c-2) Next, the passivation film 200 composed of Al₂O₃ (layer thickness: approximately 30 nm, oxygen supply source: H₂O, film formation temperature: approximately 100 degrees C.) is formed by using the ALD method.
(d) Next, as shown in FIG. 59D, the contact holes are pattern-formed with respect to the pad electrodes 160 180 according to a fourth lithography process.
(d-1) More specifically, the passivation film 200 composed of Al₂O₃ is etched with dilute phosphoric acid H₃PO₄ (phosphoric acid:pure water=1:4, approximately 60 degrees C.).
(d-2) Furthermore, the Cr layer is etched by using the Reactive Ion Etching (RIE) method (Cl₂/O₂=2/2 sccm, pressure of 0.2 Pa, power of 100 W).

As explained above, according to the embodiment, there can be provided the stress sensor which can detect the local stress with the convenience structure, and can obtain the high spatial resolution by using the stress response phenomenon of the single magnetic domain; and the fabrication method for such a stress sensor.

### OTHER EMBODIMENTS

As explained above, the embodiment has been described, as a disclosure including associated description and drawings to be construed as illustrative, not restrictive. This disclosure makes clear a variety of alternative embodiment, working examples, and operational techniques for those skilled in the art.

Such being the case, the embodiment covers a variety of embodiments, whether described or not.

### INDUSTRIAL APPLICABILITY

The stress sensor according to the embodiment can be applied to technical fields associated with detection of mechanical forces, and can be applied to strain sensors, pressure sensors, etc.

What is claimed is:

1. A stress sensor comprising:
a magnetic material;
a stress applied portion on the magnetic material;
a magnet disposed so as to be adjacent to the magnetic material; and
a magnetic sensor disposed via the magnetic material so as to be opposed to the stress applied portion, wherein
the magnetic sensor detects a magnetic flux emitted from a magnetic domain generated in the magnetic material by a local stress applied to the stress applied portion.

2. The stress sensor according to claim 1, wherein
a saturation magnetic field is applied to the magnetic material due to the magnet, and an external magnetic field due to the magnet and a stress-induced anisotropic magnetic field in a reverse direction are applied thereto with the local stress, and then a single magnetic bubble is generated in the magnetic material, and then a magnetic flux emitted from the magnetic bubble is detected by the magnetic sensor, and thereby the local stress can be detected.

3. A stress sensor comprising:
a magnetic material;
a stress applied portion of the magnetic material;
a magnet disposed so as to be adjacent to the magnetic material; and
a magnetic sensor disposed via the magnetic material so as to be opposed to the stress applied portion, wherein
a magnetic flux emitted from a magnetic domain is detected by the magnetic sensor, and thereby displacement of a magnetic domain due to stress distribution is detected.

4. The stress sensor according to claim 3, wherein
a magnetic field for generating magnetic bubble is applied to the magnetic material by the magnet, and a stress-induced anisotropic magnetic field is applied due to the stress distribution, and thereby displacement of the magnetic bubble is generated, and then a magnetic flux emitted from the magnetic bubble is detected by the magnetic sensor, and thereby the stress distribution can be detected.

5. The stress sensor according to claim 1, wherein
a plurality of the magnetic sensors are disposed thereon.

6. The stress sensor according to claim 3, wherein
a plurality of the magnetic sensors are disposed thereon.

7. The stress sensor according to claim 1, wherein
the magnetic sensor is composed of a Hall element, and the Hall element is disposed on the magnetic material so as to be contacted to the magnetic material.

8. The stress sensor according to claim 3, wherein
the magnetic sensor is composed of a Hall element, and the Hall element is disposed on the magnetic material so as to be contacted to the magnetic material.

9. The stress sensor according to claim 7, wherein
the material of the Hall element is a bismuth (Bi).

10. The stress sensor according to claim 8, wherein
the material of the Hall element is a bismuth (Bi).

11. The stress sensor according to claim 1 further comprising
an insulating layer disposed on the magnetic sensor, wherein the magnet is disposed on the insulating layer.

12. The stress sensor according to claim 3 further comprising
an insulating layer disposed on the magnetic sensor, wherein the magnet is disposed on the insulating layer.

13. The stress sensor according to claim 1, wherein
the magnet is formed of a magnetic substance thin film.

14. The stress sensor according to claim 3, wherein
the magnet is formed of a magnetic substance thin film.

15. The stress sensor according to claim 1, wherein
the magnetic sensor is disposed on one surface of the magnetic material, and the magnet is disposed on another surface of the magnetic material.

16. The stress sensor according to claim 1, wherein
the magnet and the magnetic sensor are disposed on one surface of the magnetic material.

17. The stress sensor according to claim 3, wherein
the magnet and the magnetic sensor are disposed on one surface of the magnetic material.

18. The stress sensor according to claim 16, wherein
the one surface of the magnetic material is a back side surface of the magnetic material.

19. The stress sensor according to claim 17, wherein
the one surface of the magnetic material is a back side surface of the magnetic material.

20. The stress sensor according to claim 16, wherein
the one surface of the magnetic material is a front side surface of the magnetic material.

21. The stress sensor according to claim 17, wherein
the one surface of the magnetic material is a front side surface of the magnetic material.

22. The stress sensor according to claim 1, wherein
the magnetic sensor is disposed on the magnetic material so as to be contacted to the magnetic material.

23. The stress sensor according to claim 3, wherein
the magnetic sensor is disposed on the magnetic material so as to be contacted to the magnetic material.

24. A fabrication method for a stress sensor comprising:
preparing a magnetic material;
disposing a magnet so as to be adjacent to the magnetic material; and
disposing a magnetic sensor via the magnetic material so as to be opposed to the stress applied portion on the magnetic material, wherein
the magnetic sensor is a magnetic sensor configured to detect a magnetic flux emitted from a magnetic domain generated in the magnetic material due to a local stress applied to the stress applied portion, wherein
a step of fabricating the magnetic sensor comprises:
forming an insulating layer on the magnetic material;
pattern-forming a bismuth electrode layer on the insulating layer;
pattern-forming a pad electrode on the bismuth electrode layer;
forming a passivation film on the pad electrode;
forming an aperture to the pad electrode in the passivation film; and
connecting a bonding wire to the aperture.

25. A fabrication method for a stress sensor comprising:
preparing a magnetic material;
disposing a magnet so as to be adjacent to the magnetic material; and
disposing a magnetic sensor via the magnetic material so as to be opposed to the stress applied portion on the magnetic material, wherein
the magnetic sensor is a magnetic sensor configured to detect displacement of a magnetic domain due to stress distribution by detecting a magnetic flux emitted from the magnetic domain, wherein
a step of fabricating the magnetic sensor comprises: forming an insulating layer on the magnetic material;
pattern-forming a bismuth electrode layer on the insulating layer;
pattern-forming a pad electrode on the bismuth electrode layer;
forming a passivation film on the pad electrode;
forming an aperture to the pad electrode in the passivation film; and
connecting a bonding wire to the aperture.
